(19) United States
(12) Patent Application Publication
(10) Pub. No.: US 2007/0038506 A1
(43) Pub. Date: Feb. 15, 2007

(54) Systems and methods for facilitating product and service transactions

(75) Inventors: Barclay W. Noble, Chicago, IL (US); Julie Carla Andersen, Chicago, IL (US); Jack Michael Klosterman, Chicago, IL (US)

Correspondence Address: BANNER & WITCOFF, LTD., TEN SOUTH WACKER DRIVE, SUITE 3000, CHICAGO, IL, 60606, US

(73) Assignee: Emercent Solutions, LLC, Chicago, IL (US)

(21) Appl. No.: 11/450,970

(22) Filed: Jun. 9, 2006

Related U.S. Application Data
(60) Provisional application No. 60/688,900, filed on Jun. 9, 2005.

(51) Int. Cl. G07B 15/00; G07B 15/02

(52) U.S. Cl. 705/13

(57) ABSTRACT

An online method and system permits entities to arrange for the movement of a good from a first location to a second location, particularly for a good that has physical characteristics that do not permit economical shipment by overnight mail. An example of such an item is a used and/or new vehicle that must be shipped from one location to another location.

The present application claims the benefit of U.S. Provisional Application No. 60/688,900 filed Jun. 9, 2005 (Attorney Docket No. 006836.00001), the entire disclosure of which is hereby incorporated by reference and for which priority is claimed.

### FIELD OF THE INVENTION

The present invention relates to systems and methods for enhancement of the efficiency of transactions, particularly those involving buying, selling and/or physical transfer of goods and/or the efficient delivery of services and goods associated with the transaction involved. More particularly, the technology herein includes methods and systems for arranging consolidated and efficient movement of goods, such as used and/or new vehicles, from respective pick-up locations to respective delivery locations, particularly by independent and/or discrete transporters on transportation equipment.

### BACKGROUND OF THE INVENTION

Individuals and other entities frequently need to ship items by means other than overnight mail and/or plane by a common carrier, such as the U.S. Mail, UPS®, Federal Express®, or DHL®. An example of such an item is a used and/or new vehicle that must be shipped from one location to another. For example, a car dealer who has sold a used car “free on board” to a buyer in another city will need to arrange for the transportation of the used car to the buyer. It is estimated that a substantial percentage of sale transactions of used vehicles over the Internet are transactions that require delivery of used vehicles out of state.

Another example requiring transport of a vehicle from a first location to a second location arises when a person is moving from one city to another, and is not driving their personal vehicle(s) to their destination city.

Yet another example requiring transport of a vehicle from a first location to a second location arises when a “snowbird” (i.e., a person who spends winters in a warm winter climate location and spends non-winter months in a non-warm winter climate location) needs to ship their personal vehicle(s) to and from a warm winter climate location when the seasons change.

Today, arranging for the transporting of a vehicle about 1,000 miles from one location to another location in the continental U.S. typically costs around $400-$600. Entities that need to ship a vehicle typically contact a transporter or transporters directly by phone, facsimile, and/or e-mail in an attempt to find the best available timing and terms and to arrange for the shipment of the vehicle, or they engage a broker who charges a fee to arrange with a transporter the shipment of the vehicle.

The growth of car leasing has led to an increase in the remarketing of vehicles coming off or that have come off lease. Entities that have a need to remarket such vehicles, including, but not limited to, car dealers, leasing companies, captive finance companies, and individuals, frequently have a need to transport remarketed vehicles to purchasers outside of the cities where the remarketed vehicles are physically located at the time of sale. The need to transport remarketed vehicles has increased with the proliferation of internet sales of used cars, including sales facilitated by vehicle auction web sites.

In some instances, transport companies physically travel to and attend live auction web sites to advertise their vehicle transport services. Transport companies may also have web sites that offer vehicle transportation services. Thus, in general, there is a market for transportation services such as vehicle transport, but that market is not highly organized or efficient.

### BRIEF SUMMARY OF THE INVENTION

The present invention relates to methods for enhancement of the efficiency of transactions, particularly those involving buying, selling and/or physical transfer of goods and/or the efficient delivery of services and goods associated with the transaction involved. More particularly, the technology herein relates to online methods and systems for arranging the movement of a good or discrete units of various items, particularly bulky items, from a first location to a second location by means other than by overnight mail or by plane. An example of such an item is a used and/or new vehicle that must be shipped from one location to another location by means other than by overnight mail or by plane. However, the invention and means for creating an efficient market is not limited to vehicle transport. The invention herein applies to many markets which currently do not maximize the efficient movement of physical goods, and as a consequence, the cost and movement of goods may be higher than necessary, as well as wasteful of time, energy, and other resources.

In one embodiment, the present invention provides a web based system that can be accessed by shippers and transporters for efficient transaction of vehicle transportation services wherein items are shipped from a first location to a second location, including, but not limited to, shipment over state lines. In a preferred embodiment, the method and system of the present invention provide efficient scheduling for transport of at least one transportation vehicle from at least one pick-up location to at least one delivery destination.

In another embodiment, the present invention provides for consolidation at a web site of information relating to multiple transportation vehicles requiring shipment, and for shippers and transporters to agree to terms online for shipment of the vehicles.

In another embodiment, the present invention allows a consolidator to serve as a matchmaker between shippers and transporters relating to the shipment of items that cannot be economically shipped via overnight mail or by plane.

In another embodiment, the present invention facilitates marshalling of transport information leading to efficient hub and spoke transport of items, e.g., where one shipper handles a first leg of transport of an item, and a second shipper handles a second leg of transport of the item.

In another embodiment, an integrated system is provided that allows for an entity managing a portfolio of leased assets, including but not limited to a bank, a consignor, or a captive finance entity, to access historical data relating to the end of term disposal of similar assets, including historical data relating to the cost of transport of similar assets, to determine the most economical manner to dispose of those assets upon the end of term of the leases on those assets.

### BRIEF DESCRIPTION OF THE DRAWINGS

FIG. 1 is a schematic of exemplary architecture in an embodiment of the present invention.

FIGS. 2A, 2B, and 2C are flowcharts of steps in an embodiment of the present invention.

FIG. 3 is a schematic diagram of an overall exemplary illustrative transport transaction implementation.

FIG. 4 is a schematic diagram of hardware architecture in an embodiment of the present invention.

FIGS. 5 through 101 are examples of illustrative screen displays in accordance with an embodiment of the present invention.

FIGS. 102 through 148 are examples relating to an end of term embodiment of the present invention.

### DETAILED DESCRIPTION OF PREFERRED EMBODIMENTS

In accordance with the present invention, a web based consolidation system is provided that can be accessed by shippers and transporters for efficient transaction of vehicle transportation services. In a preferred embodiment, the method and system of the present invention provide efficient scheduling for transport of at least one vehicle from at least one pick-up location to at least one delivery destination. In a further preferred embodiment, the method and system provide efficient scheduling for transport of multiple vehicles from at least one pick-up location to at least one delivery destination. The method and system can also provide efficient scheduling for transport of multiple vehicles from multiple pick-up locations and the delivery of each vehicle to its scheduled delivery destination by means of one or more transporters.

The method and system of the present invention can also provide to a transporter certain transport requirements of a shipper so that the transporter can readily decide whether to accept the offer for delivery of the vehicle in accordance with the shipper's transport requirements. The method and system of the present invention can also allow a transporter to make a counteroffer to a shipper, and for subsequent counteroffers by either the shipper and/or transporter until an offer is accepted.

In accordance with one embodiment, a transport exchange system is provided for scheduling efficient transport of goods by means other than overnight mail or by plane, comprising:

(a) at least one server to store data, the server operated by an entity other than a transporter of goods;

(b) an online shipper portal connected to the server at which multiple shippers can enter a shipping request for their respective goods, each good to be shipped from a pick-up location to a delivery location, the online shipper portal electronically connected to the server;

(c) an electronic interface that automatically consolidates multiple shipping requests into a group of multiple shipping requests based on at least the type of the good, pick-up location, delivery location, time for pick-up, and time for delivery in each shipping request; and

(d) an online transporter portal at which a transporter can view the group of multiple shipping requests and can accept or provide alternative terms relating to at least one of the multiple shipping of requests of the consolidated group of multiple shipping requests in a single electronic transmission.

The transport exchange system can allow more than one transporter to view the consolidated group of multiple shipping requests.

The transporter portal can allow a transporter to electronically accept at least two shipping requests of the consolidated group of multiple shipping requests in a single electronic transmission.

The transport portal can allow a transporter to electronically accept the entire consolidated group of multiple shipping requests in a single electronic transmission when there are more than two shipping requests in the consolidated group.

The transport portal can allow a transporter to electronically transmit to at least one shipper alternative terms relating to shipment of a good.

The shipper portal can allow a shipper to electronically accept the transporter's alternative terms relating to shipment of the good.

The transport exchange system of the present invention can allow at least one shipper and a transporter can negotiate terms of shipment for a good electronically through their respective portals.

In the transport exchange system, the acceptance by the transporter of the shipping request of at least one shipper is electronically posted for viewing by the at least one shipper of the accepted shipping request.

In the transport exchange system, the acceptance by the transporter of each shipping request can be electronically posted for viewing by the shipper corresponding to each accepted shipping request.

Further, the accepted terms between a shipper and a transporter relating to shipment of a good can be electronically stored.

In the present invention, a shipper can electronically obtain a cost estimate for shipment of their respective good, goods or units of goods prior to entering a shipping request for viewing by a transporter.

In one embodiment, a shipping request for a good to be shipped comprises information selected from the group consisting of the type of the good, pick-up location, delivery location, time for pick-up, time for delivery, amount of money the shipper is willing to pay for shipment of the good, whether the good must shipped in an enclosed container, and whether a transporter must have a predetermined quality rating.

In one embodiment, a shipper and/or a transporter corresponding to the shipment of a good can check the status of the shipment of a good, and that status can include global positioning system information relating to the good.

In one embodiment, the present invention is a method for scheduling efficient transport of goods by means other than overnight mail or by plane comprising the steps of:

(a) inputting to a central server system shipping requests from multiple shippers for shipment of their respective goods, the central server system operated by an entity other than a transporter of goods;

(b) automatically consolidating multiple shipping requests into a group of multiple shipping requests based on at least the type of the good, pick-up location, delivery location, time for pick-up, and time for delivery in each shipping request;

(c) making available to a transporter the group of multiple shipping requests; and

(d) inputting to the central server system the acceptance or alternative terms of the transporter relating to at least one of the multiple shipping of requests of the consolidated group of multiple shipping requests.

In one embodiment, the method can include making the group of multiple shipping requests available to more than one transporter.

The method can include the step of accepting by a transporter at least two shipping requests of the consolidated group of shipping requests in a single electronic transmission.

The method can include the step of accepting by a transporter the entire consolidated group of multiple shipping requests in a single electronic transmission when there are more than two shipping requests in the consolidated group.

The method can include the step of transmitting to at least one shipper alternative terms of a transporter relating to shipment of a good, and the step of accepting the alternative terms.

The method can include at least one shipper and a transporter negotiating terms of shipment for a good.

The method can include the step of electronically storing accepted terms between a shipper and a transporter relating to shipment of a good.

The method can include the step of obtaining a cost estimate for shipment of a good prior to entering a shipping request for viewing by a transporter.

The method can include the step of predetermining a quality rating for each transporters based on quality related data relating to each transporter.

The method can include the step of checking the status of the shipment of a good by a shipper and/or a transporter, including global positioning system information relating to the good.

In one embodiment, the present invention provides a method for scheduling efficient transfer of multiple individual units of goods, wherein each of the individual units is collected from a pick-up location for each said unit and delivered to a destination location for each unit, at least some of said pick-up locations being discrete, said method comprising, in combination, the steps of:

inputting information into a central server system for the pick up location of each unit;

inputting information into said central server system for the destination location of each said unit;

inputting information into said central server system of the location of at least a first and a second transporter capable of carrying multiple units between the unit pick-up and destination locations;

programming said central server to analyze the input information to schedule the maximum number of units that may be carried by each transporter in the shortest period of time between the pick-up and destination locations of each of said units to effect transport of more than one unit by each transporter between the pick-up and destination locations thereof during a finite period of time.

In one embodiment, the method can further include the step of publishing a pick-up time and location schedule for each unit.

In one embodiment, each transporter uses at least a single transporter element to transport goods.

In one embodiment, custody of each unit is maintained by a single transporter from the pick-up location to the destination location and wherein custody of the unit and liability for damage to the unit is that of the transporter only during custody of the unit.

In one embodiment, each transporter element is a ground transport device.

In one embodiment, a transporter element is a ground transport device. An example of ground transport device is truck trailer that can transport up to ten automobiles.

In one embodiment, a server of the transport exchange system stores historical data relating to the cost of transport of goods, and the historical data is accessible by an entity managing a portfolio of leased goods.

In one method in accordance with the present invention, included are the steps of collecting historical data relating to the cost of transport of goods, and allowing for the historical data to be accessible to an entity managing a portfolio of leased goods.

The transport exchange system (sometimes referred herein as “TEX”) of the present invention can have the following characteristics and functionalities.

E-Haggling: Live, Automated, Multi-Dimensional, Tiered Negotiation: TEX allows the buyer to set an asking price as well as several other dimensions to the request (location of services/good, when services are performed, qualities associated with the service) and then, allows the seller of the goods or services to accept the offer on all dimensions, or in some cases, provide a counter offer. A counter offer can be made on any of the dimensions associated with the request and has an expiration date. The process is automated in that a seller can determine during the process of posting a request if they wish to allow haggling or it they want to make the offer “take it or leave it.” They can also define points in which a request would automatically move, depending on the age of the request and its urgency, into a “haggle” state if no seller accepts the request as is. Additionally, the amount of counteroffers can be limited by either party, as can who the offer is shown to. The haggling process is tiered in that thresholds can also be set to determine the type of sellers the offer is made to, based upon timing and their previous performance. High quality sellers may have the opportunity to view and respond to the offer first, and then, when a certain time period is expired, the request can then be automatically (based upon what the buyer has indicated) be posted to the next tier of performance sellers.

Single Stroke or Click Transport: Sellers can easily and quickly obtain transport by configuring their profile with their preferences, indicating their request approach and then, selecting a single check box that indicates they wish to have the solution “move” their good for them. The solution can be automatically integrated with virtual marketplaces (e.g., eBay) to dynamically integrate data, allowing users to simply select a similar check box to allow TEX to move their goods. By doing so, the system will automatically post the request, pricing it based upon the Pricelt engine below, secure transport, and execute the transaction between the buyer and seller. Also, by configuring their profile and then utilizing the TEX kiosks at physical auctions, transport can be obtained in a single “stroke” or “click”.

My Moves: Consolidated Transport Portal: A typically disparate process for shippers that work with numerous transporters can be avoided because the transport portal consolidates information from multiple transporters, making TEX a single source of transport data—regardless of vendor. Through a common transport “dashboard,” TEX allows shippers to easily and quickly manage all of their vehicle moves. TEX can include a translation engine that allows transporters to supply data in a consistent manner to shippers, and for those transporters who do not have this data electronically, TEX provides a toolset for collection of this information. Shippers on TEX simply log in and access their home page to view all moves in progress—from the point a request is made to the point a vehicle is delivered to the point a claim is resolved—in a simple, consistent format.

Five Star Transporters: Qualitative and Quantitative Metrics to gauge performance and ensure marketplace safety: The TEX rating system is based upon a scorecard that combines multi-dimensional feedback from shippers in the areas of overall experience, quality, timeliness, and service with performance metrics that are created from the data collected from TEX transactions. These performance metrics include claim history, delivery history, service history, driver history, etc. Through a weighted score card, transporters earn stars, ranging from one star to five stars. By combining qualitative feedback data with quantitative transaction data, TEX provides shippers with unique insights and the ability to work with transporters that they do not have a service history with. A heavily partnership oriented business, shippers are often limited in the number of transporters they can work with due to the lack of knowledge regarding their performance, and thus, the lack of trust. By having access to the rating tool, shippers are able to know who they are working with and gain a level of knowledge and trust that would be impossible in any other scenario.

LoadBuilder: Request Consolidation: The Transportation Consolidation engine is a sophisticated load consolidation and aggregation engine. The engine processes all transportation requests in real time and aggregates loads based on several dimensions. Additionally, the engine recommends modifications in transportation or shipping requests—within tolerable limits—to enable further consolidation. This unique consolidation engine combines requests dynamically, allowing both the shipper and transporter to benefit. As requests for transport are made, TEX processes the requests and matches those that can be placed on a single load. Algorithms based upon geographic locations, vehicle sizes and conditions, transporter capacity and routing can be used to allow this engine to consolidate in real-time. These requests are then posted together for the transporter to provide more cost-effective pricing on. Shippers, while possibly benefiting from the cost savings due to consolidation, are not limited by consolidation, meaning that they can still individually track their own vehicles through TEX. The consolidation process is completely transparent to the shipper.

Where'sMyCar?: Realtime vehicle tracking including: GPS location. Shippers are able to request status updates and identify the current estimated delivery date—based on location and calculation of duration.

Marketplace Manager: Virtual Brokering: TEX plays the intermediary between shippers and transporters. Playing the role a broker would play in transport arrangement and consolidation, TEX also plays the other critical roles that are essential to effective and successful transportation. These include validating shippers and ensuring payment and funds are available, validating transporters—including history, insurance certification, licensing, performance, safety records, etc., transferring funds between shippers and transporters, consolidating transportation requests into loads for transporters, monitoring exceptions, security and health of the market, managing claims and addressing customer service issues. These services, delivered real-time via TEX components, can be delivered cost-effectively, allowing considerable transaction savings for both shippers and transporters.

PriceIt!: Suggestive Pricing Engine: Through the combination of transporter rates and historical data, TEX is able to provide suggestive pricing to shippers, accurately and in real time. Sophisticated algorithms have been developed that allow the estimation of pricing based on a myriad of factors including pick up location, number of vehicles, size of vehicles, condition of vehicles, placement on trucks, type of carrier and transport required, additional services required, number of deliveries and distinct loading required, time in transit required, size of carrier and transporter performance history. Historical data is analyzed and the shipper is provided with a range of suggested prices that take into consideration the unique attributes of the shipment and match it with data on file.

MobileMover: TEX is a real time load builder, allowing transporters to always keep a full load. Even when in route, transporters can utilize TEX to find shipments on their routes and add these shipments, as capacity allows, at any point in time. A transporter can be notified via a hand held device or cell phone of vehicles within a date range and geographic distance range (based upon the transporters preferences) while other shipments are in process, allowing a greater profit for transporters and flexibility that is currently not available in the marketplace.

TexKIOSK: TEX has a kiosk-based component that allows shippers that are onsite at wholesale vehicle auctions or other consolidated vehicle lots to ship vehicles quickly and easily through a kiosk. Through a few simple screens, shippers can interact with the TEX system and submit their vehicles for transport. TEX then consolidates these requests and posts them for transporters.

PartnerBuilder: TEX includes a suggestive partnering engine that matches regional carriers to shipments and makes partner suggestions, allowing regional carriers to transport shipments part of the way, within their region, then hand off the shipment to another regional carrier. This allows regional carriers to compete at a national level.

In one embodiment, load parameters and other characteristics of transporters in general and/or specific characteristics of specific transporters, such as a predetermined maximum load parameter common to at least two transporters, are inputted to the transport exchange system and stored at a server or interface. The interface may be part of the server. As shippers input shipping requests for their respective goods, the interface automatically consolidates various groups of multiple shipping requests based on at least the type of the good, pick-up location, delivery location, time for pick-up, and time for delivery in each shipping request, taking into at least one predetermined load parameter common to at least two transporters that are stored on the server, as well as other characteristics of transporters in general and/or specific characteristics of specific transporters.

For example, load parameters of truck trailers for shipping vehicles, such as ten vehicles per leg of a shipment are inputted to the interface. As shippers input shipping requests for their respective goods, the interface automatically consolidates groups of multiple shipping requests into ten vehicles per load for at least one leg of a shipment route. The interface automatically consolidates ten vehicles per load for at least one leg of a shipment route based on information of the inputted shipping requests. Transporters can view multiple, consolidated groups of shipping requests and determine which of these consolidated groups of shipping requests they would like to handle. When terms of a shipping request within a consolidated group of shipping requests are agreed upon, the agreed upon shipping request is automatically removed from all “open” groups in which it has been placed. An open group is one in which the terms of each and every shipping request have not been agreed upon between a shipper and a transporter. Thus, transporters are relieved from trying to piece together themselves at least one ten vehicle leg of a shipment route. Transporters have the option to agree to transport less than ten vehicles for any and all legs of a shipment route through the transport exchange system.

In one embodiment, load parameters and other characteristics of transporters in general and/or specific characteristics of specific transporters are inputted to the transport exchange system and stored at a server or interface. As shippers input shipping requests for their respective goods, the interface automatically consolidates various groups of multiple shipping requests based on at least the type of the good, pick-up location, delivery location, time for pick-up, and time for delivery in each shipping request, taking into account the load parameters and other characteristics of transporters in general and/or specific characteristics of specific transporters.

For example, load parameters of truck trailers for shipping vehicles, such as ten vehicles per leg of a shipment are inputted to the interface. As shippers input shipping requests for their respective goods, the interface automatically consolidates groups of multiple shipping requests into ten vehicles per load for at least one leg of a shipment route. The interface automatically consolidates ten vehicles per load for at least one leg of a shipment route based on information of the inputted shipping requests. Transporters can view multiple, consolidated groups of shipping requests and determine which of these consolidated groups of shipping requests they would like to handle. When terms of a shipping request within a consolidated group of shipping requests are agreed upon, the agreed upon shipping request is automatically removed from all “open” groups in which it has been placed. An open group is one in which the terms of each and every shipping request have not been agreed upon between a shipper and a transporter. Thus, transporters are relieved from trying to piece together themselves at least one ten vehicle shipment route having at least one ten vehicle leg in the route. Transporters also have the option to agree to transport less than ten vehicles for any and all legs of a shipment route through the transport exchange system.

The following examples further describe the present invention in the context of transport of automobiles.

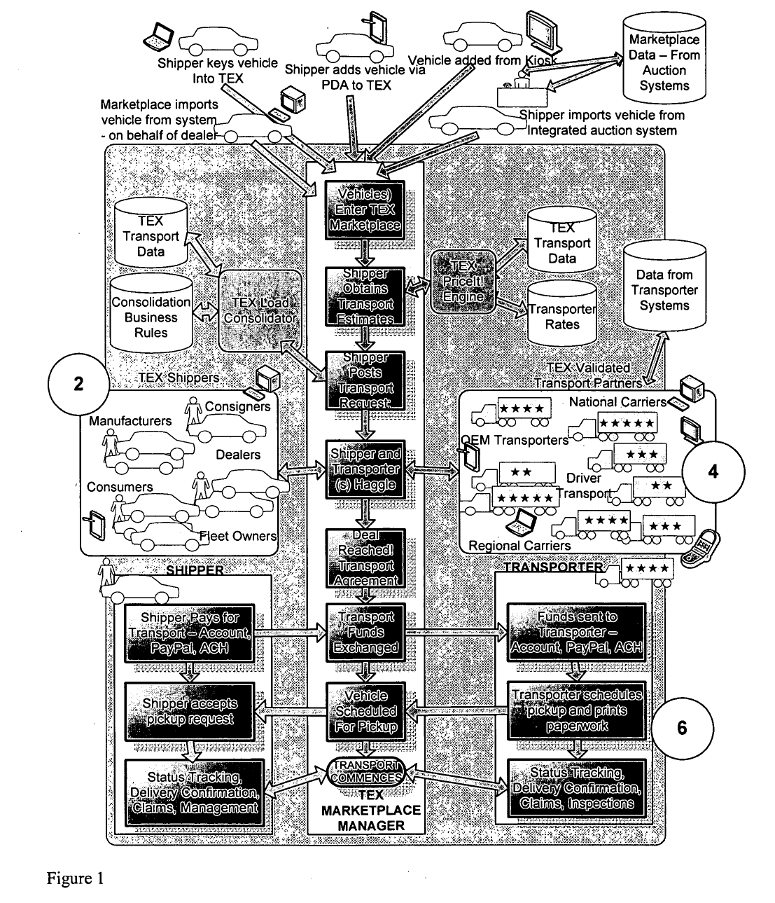

Referring to FIG. 1, a schematic is shown of exemplary architecture in an embodiment of the present invention. As shown in FIG. 1, multiple types of shippers 2 and multiple transporters 4 can communicate electronically with the “marketplace” or transport exchange system 6 of the present invention.

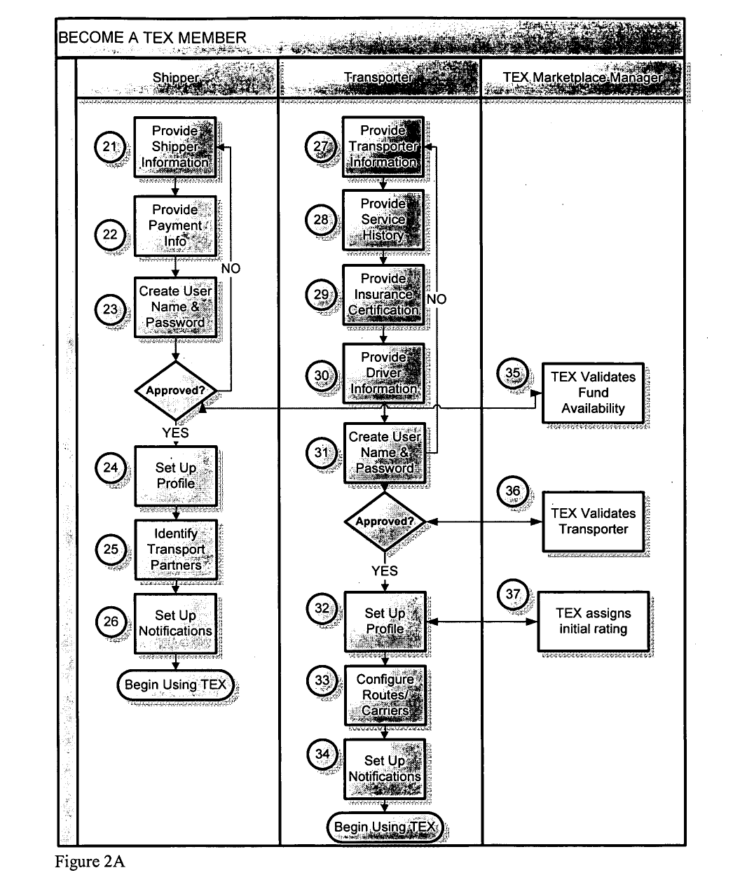

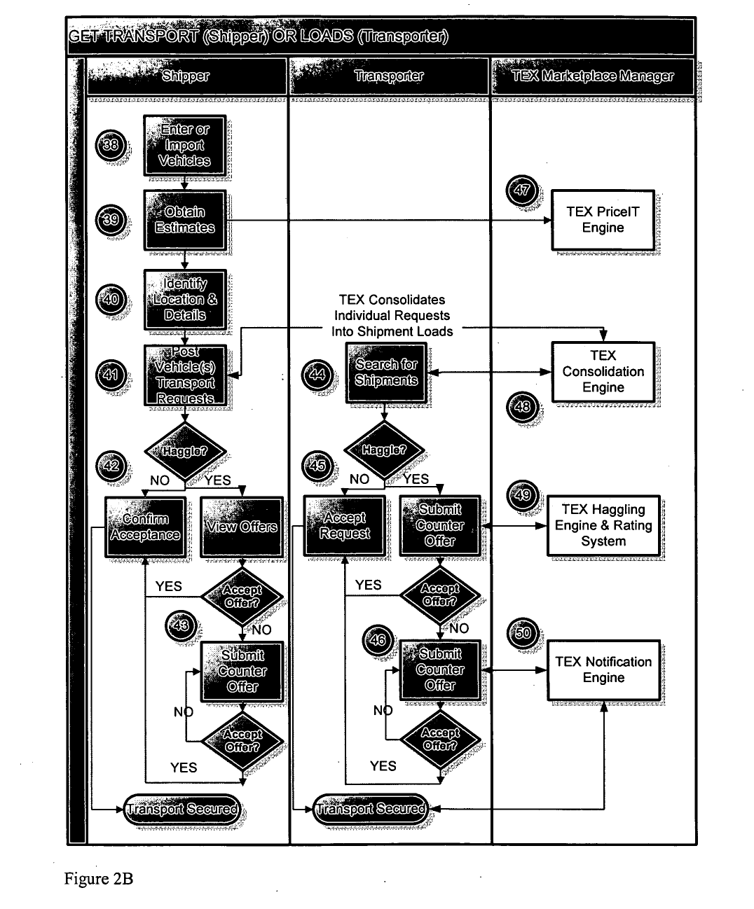

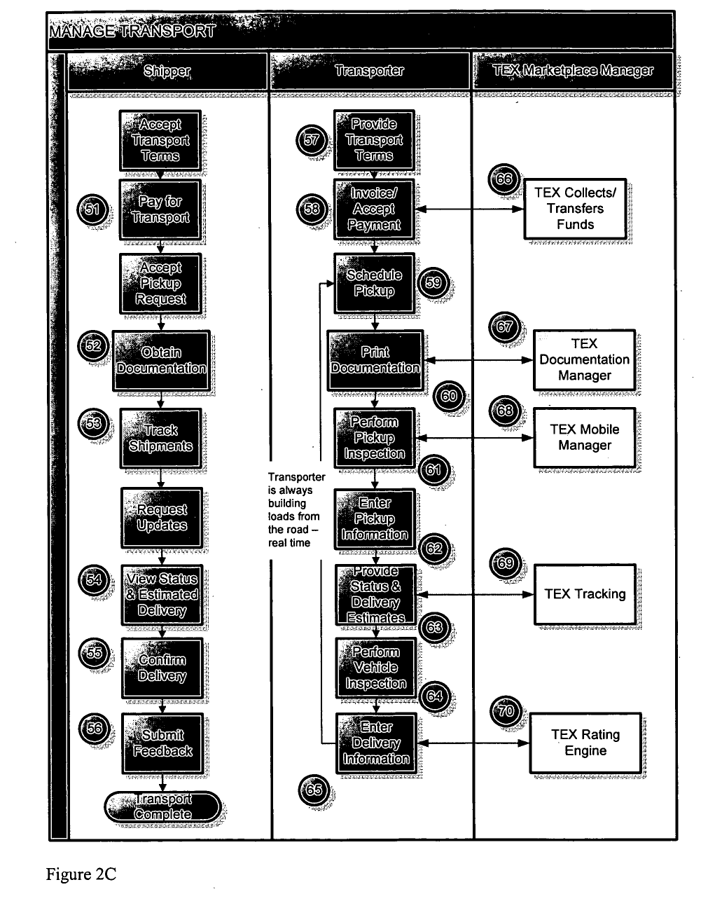

FIGS. 2A, 2B and 2C are flowcharts of steps in an embodiment of the present invention, including process steps in the virtual brokering that can be accomplished by the use of the transport exchange system of the present invention.

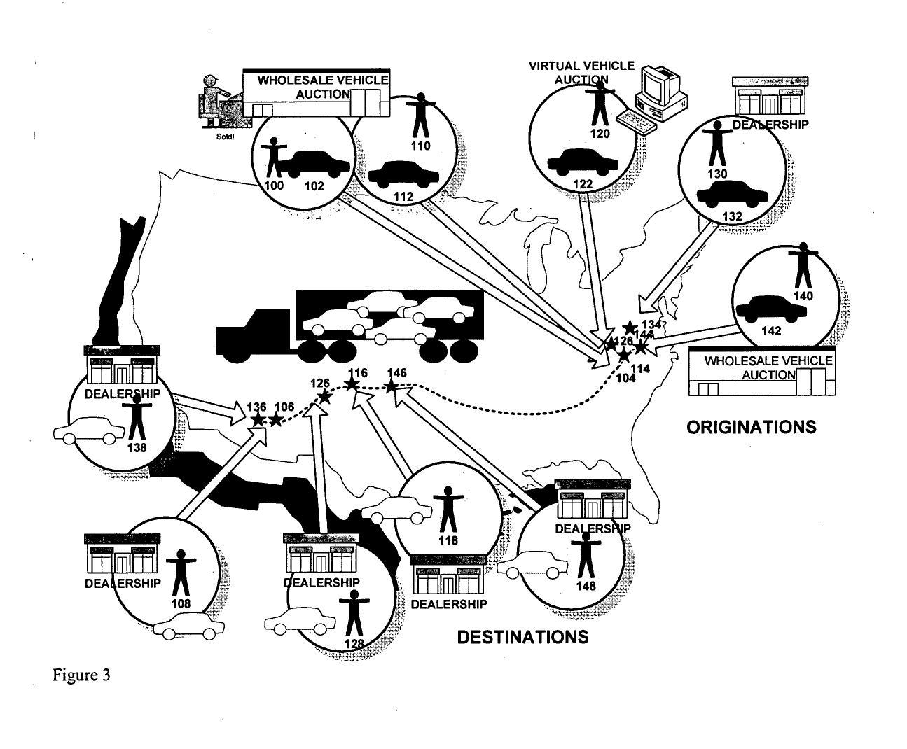

FIG. 3 is a schematic diagram of an overall exemplary illustrative transport transaction implementation of the present invention.

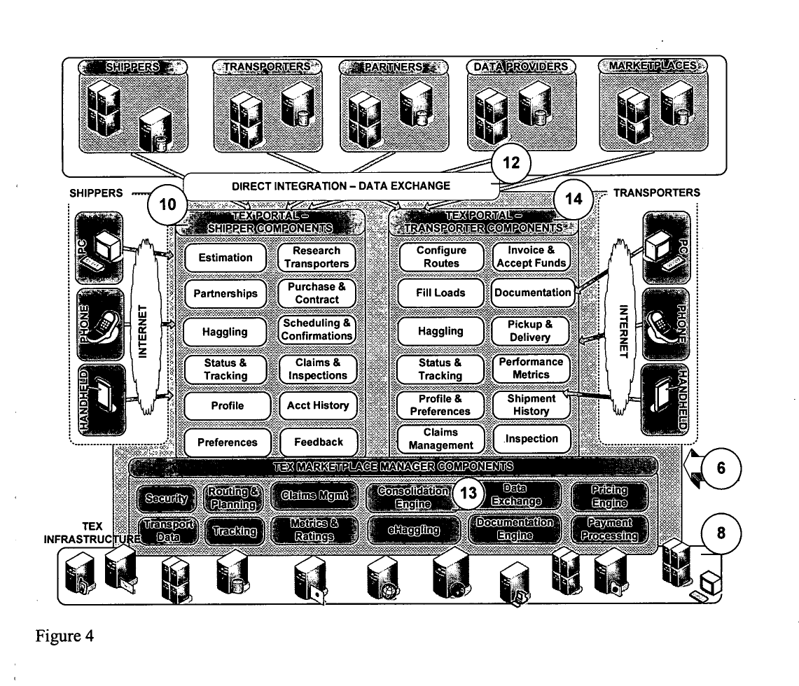

FIG. 4 is a schematic diagram of hardware architecture of the transport exchange system 6 of the present invention, including at least one server 8 to store data, an online shipper portal 10, an electronic interface 12, and in online transporter portal 14. Electronic interface 12 can include consolidation engine 13.

### EXAMPLE 1

Referring to FIGS. 3 and 4, shipper or dealer 100 has three vehicles 102 requiring shipment within 7 days from a first location 104 to a second location 106 for delivery to buyer 108. Shipper 110 has four vehicles 112 requiring shipment within 5 days from a third location 114 to a fourth location 116 for delivery to buyer 118. Shipper 120 has three vehicles 122 requiring shipment within 6 days from a fifth location 124 to a sixth location 126 for delivery to buyer 128. Based on the above information, when shippers 100, 110, and 120 enter their respective shipping requests through the shipper portal 10, including the price each is willing to pay for their respective shipments, the electronic interface 12 of the transport exchange system 6 automatically consolidates the multiple shipping requests into a group of multiple shipping requests. More specifically, the interface of the transport exchange system 6 consolidates the multiple shipping requests into a consolidated group of ten vehicle shipment load based on information in each shipping request. A transporter having a ten vehicle carrier can view the consolidated group of the multiple shipping requests via the online transport portal 14 of the transport exchange system 6. The transporter can electronically accept the group of multiple shipping requests in a single electronic transmission via the transport portal 14. Each shipper can view confirmation of the transporter's acceptance relating to each shipper's shipment via the shipper portal 10.

After each shipper pays for their respective shipments, the transporter schedules pick-up and prints shipment paperwork and transmits that paperwork to each shipper via the transport exchange system, and each shipper accepts the pick-up request corresponding to their respective shipments, and transmits their acceptance via the transport exchange system to the transporter.

### EXAMPLE 2

Referring to FIG. 3, shipper or dealer 100 has three vehicles 102 requiring shipment within 7 days from a first location 104 to a second location 106 for delivery to buyer 108. Shipper 110 has four vehicles 112 requiring shipment within 5 days from a third location 114 to a fourth location 116 for delivery to buyer 118. Shipper 120 has three vehicles 122 requiring shipment within 6 days from a fifth location 124 to a sixth location 126 for delivery to buyer 128. Shipper 130 has four vehicles 132 requiring shipment within 8 days from a seventh location 134 to an eighth location 136 for delivery to buyer 138. Shipper 140 has six vehicles 142 requiring shipment within 4 days from a ninth location 144 to a tenth location 146 for delivery to buyer 148. Based on the above information, when shippers 100, 110, 120, 130, and 140 enter their respective shipping requests through the shipper portal, including the price each is willing to pay for their respective shipments, the electronic interface of the transport exchange system automatically consolidates the multiple shipping requests into two groups of multiple shipping requests. More specifically, the interface of the transport exchange system automatically consolidates the multiple shipping requests of shippers 100, 120, and 130 into a first consolidated group of a ten vehicle shipment load, and the multiple shipping requests of shippers 110 and 140 into a second consolidated group of a ten vehicle load, and accomplishes this consolidation based on information provided in the multiple shipping requests. In addition, information is inputted into said central server system regarding the location of at least a first and a second transporter capable of carrying multiple units between the unit pick-up and destination locations. The central server is programmed to analyze the input information to schedule the maximum number of units that may be carried by each transporter in the shortest period of time between the pick-up and destination locations of each of said units to effect transport of more than one unit by each transporter between the pick-up and destination locations thereof during a finite period of time, taking into account the starting location of each transporter to travel to their first respective pick-up and confirming that the price to be paid for each shipment is a pre-accepted price of each transporter.

Each transporter having a ten vehicle carrier can view the consolidated group of the multiple shipping requests identifying them as the respective transporter having the right of first refusal via the online transport portal of the transport exchange system. Each transporter can electronically accept the group of multiple shipping requests for which they have been identified as the most appropriate transporter, and can do so in a single electronic transmission via the transport portal. Each shipper can view confirmation of the transporter's acceptance relating to each shipper's shipment via the shipper portal.

Alternatively, if the first and second transporters have already given their pre-approval with parameters that are met by the respective groups of shipping requests, then the first and second transporters are electronically notified of the particular ten vehicle shipment brokered by the transport exchange system, and the shippers 100, 110, 120, 130 and 140 are electronically notified of the name of the transporter who has been assigned to handle their respective shipment.

As in Example 1, after each shipper pays for their respective shipments, the respective transporter schedules pick-up and prints shipment paperwork and transmits that paperwork to each shipper via the transport exchange system, and each shipper accepts the pick-up request corresponding to their respective shipments, and transmits their acceptance via the transport exchange system to the transporter.

Those skilled in the art will recognize that the present invention can be used in a wide variety of instances and are not limited to the fact patterns in Examples 1 and 2.

Overview

A transport exchange system in accordance with the present invention provides online automobile transportation brokerage services. As the leases of late model automobiles expire on a regular basis, a significant quantity of the vehicles are returned by their lessees and are then sold at auctions, both physical and virtual. Physical auctions are conducted on a recurring basis, in locations throughout the country. Most, but not all vehicles sold at physical auctions must be shipped to the auction site. For both physical and virtual auctions, a significant quantity of the vehicles are not purchased locally, but are purchased by dealers in other regions of the country. For example, convertibles which are auctioned off in the South during summer months may be purchased by dealers in the Midwest, where demand may exceed local supply.

Through partnerships with both physical and virtual auctions, the transport exchange system of the present invention provides an adjunct service to dealers purchasing vehicles at auction. Rather than having to arrange for their own vehicle transportation, dealers may choose to have a consolidator operating the transport exchange system broker their shipment. The virtual and private auctions can receive a commission for every shipment brokered by the consolidator for a vehicle sold at their respective auction. The transport exchange system can generate periodic summary reports (e.g., monthly summary reports) for each member auction, summarizing the vehicles moved via the transport exchange system that originated at the auction, as well as the associated commissions payable to the auction. The transport exchange system of the present invention can have an online portal for auctions, so that each auction will have the capability of creating accounts on behalf of their purchasing dealers, and entering vehicle data into the transport exchange system, again on behalf of purchasing dealers.

The transport exchange system (sometimes referred herein as “TEX”) of the present invention provides comprehensive public-facing portals for two categories of users: 1) the dealers who purchase cars at auction, and select the consolidator operating the transport exchange system to broker their vehicle's move; and 2) vehicle transporters, who contract to move the vehicles. Both the dealers and the transporters can be assessed a per-transaction fee by the consolidator for all of the transport exchange system-brokered vehicle moves. Using information provided via the transport exchange system, the consolidator can consolidate loads of multiple vehicles, encompassing multiple sourcing auctions and/or purchasing dealers, in order to achieve lower-cost vehicle moves for member dealers. The following sections summarize, at a high level, the functionality the transport exchange system can provide to member dealers and transporters, as well as the capabilities of consolidator due to the information collected by the transport exchange system.

Dealer Portal

The dealer portal of the transport exchange system of the present invention enables dealers to request transport exchange system membership, log into the transport exchange system (once their account has been approved and activated by an operator of the transport exchange system), obtain estimates for vehicle moves, add information concerning vehicles they have purchased into the transport exchange system, track the progress of their vehicles as they are: posted to the transport exchange system, grouped by the transport exchange system into loads which are offered to member transporters, contracted with an individual member transporter, scheduled for pick-up and delivery, picked up, inspected, in transit, delivered, and inspected on delivery. Dealers will have the ability to view prior rating and feedback associated with the selected dealer, as well as long-term performance metrics for transporters, and to leave their own feedback relative to each transaction with a transporter. Moreover, dealers will have the capacity to specify a minimum threshold quality level for the transporters selected to move their vehicles, and to explicitly exclude specific transporters, if desired.

Dealers may also use TEX to message associated transporter(s) during the duration of their vehicle's move, such as to request a status update from the transporter. TEX can also provide the dealer with the capability of submitting a claim if a vehicle is damaged in-transit. In accordance with each dealer's individual profile settings, TEX can provide alerts to dealers, such as by email and SMS text messages, as significant events in the vehicle move process occur.

TEX can receive payment in full from dealers when the contract to move each vehicle is consummated with a particular transporter. TEX can receive payments from dealers via credit card, Automated Clearing House (ACH) transfer, and PayPal®. TEX can also support the ability for volume dealers with established credit to obtain a credit account. TEX can generate per-dealer reports summarizing all transactions, including the fees paid by the dealer for both the TEX transaction fee and the vehicle move itself.

A “dealer dashboard” on the home page following dealer login can provide dealers with a high-level snapshot of their current TEX activities and messages, high-level statistics of the overall TEX system, as well as news and website usage hints from personnel operating TEX.

Dealer Kiosk

The TEX dealer kiosk can provide a convenient way for purchasers of vehicles at physical auctions to ship them through TEX. Dealers may authenticate on the kiosk by swiping an auction-provided card, or by entering their auction ID and representative number. Once authenticated, the dealer is presented with a list of purchased vehicles, one or all of which may be selected for shipment via TEX. Next, the dealer selects one or more previously-entered delivery locations for the vehicles, as well as associated preferences, such as transporter quality thresholds. Finally, the dealer may review and confirm the shipment.

Transporter Portal

The TEX transporter portal enables vehicle transporters to request TEX membership, log in to TEX (once their accounts have been approved and activated by TEX personnel), view shipments (varying in size from a single vehicle to a complete load) offered by TEX, accept shipment offers, make counter-offers (such as by proposing a different price, pick-up date, or type of transporting vehicle), and accept/decline counter offers.

Once a shipment is contracted with a transporter, a bill of lading document can be automatically generated by TEX and made available in PDF form to the associated dealer and transporter. The transporter can then use TEX to schedule vehicle pick-up and delivery, to perform pick-up and delivery inspections, to enter position status updates for vehicles in-transit, to change the scheduled pick-up and delivery dates if delays arise. During vehicle moves, transporters can use the TEX message system to contact the vehicles' dealer(s). Transporters can have the ability to view their own feedback and performance metrics, respond to feedback left by a dealer, and to respond to claims submitted by dealers. In accordance with each transporter's individualized profile settings, TEX can provide alerts to transporters, such as when vehicles meeting their criteria are offered for transport, when a counter-offer of the transporter is accepted by TEX personnel, when feedback is submitted by a dealer, relative to the transporter, etc.

All offers made by TEX for the transport of brokered vehicles (and, in turn, all offers or counter-offers accepted by a transporter) can include both the agreed transporter fee for the vehicle move itself, as well as a TEX transaction fee. TEX can generate per-transporter reports summarizing all transactions, including the fees paid by TEX for the move (from funds previously received from the dealers) as well as the transporter transaction fee.

A “transporter dashboard” on the home page following transporter login can provide transporters with a high-level snapshot of their current TEX activities and messages, high-level statistics of the overall TEX system, as well as news and website usage hints from TEX personnel.

TEX Management Application

While the dealer and transporter portals are both web browser-based, client-facing applications, a TEX Management Application (TMA) can be provided as a Multiple Document Interface (MDI) Windows forms application. The TMA can permit TEX personnel to add, delete, activate and deactivate users; configure transport cost estimators (for both the dealer portal and internal use when posting vehicles); review vehicles posted by dealers and consolidate them into loads; and negotiate with transporters for the transport of posted loads. The TMA can also permit TEX personnel to monitor the progress of all vehicle shipments and deliveries.

The TMA can also provide several reports, including: 1) exception reports, identifying important events, including indications of loads which have not been accepted by any transporter within a predetermined time period, delays in vehicle delivery, and claims for damaged vehicles; 2) dealer billing reports; 3) auction and transporter remittance reports; and 4) daily, weekly and monthly aggregate activity reports.

Detailed Specifications

Detailed specifications for the Dealer Portal, Dealer Kiosk, Transporter Portal, and Tex Management Application are shown below.

Dealer Portal

Each primary function of the Dealer Portal is identified in the following sections.

Dealer Registration

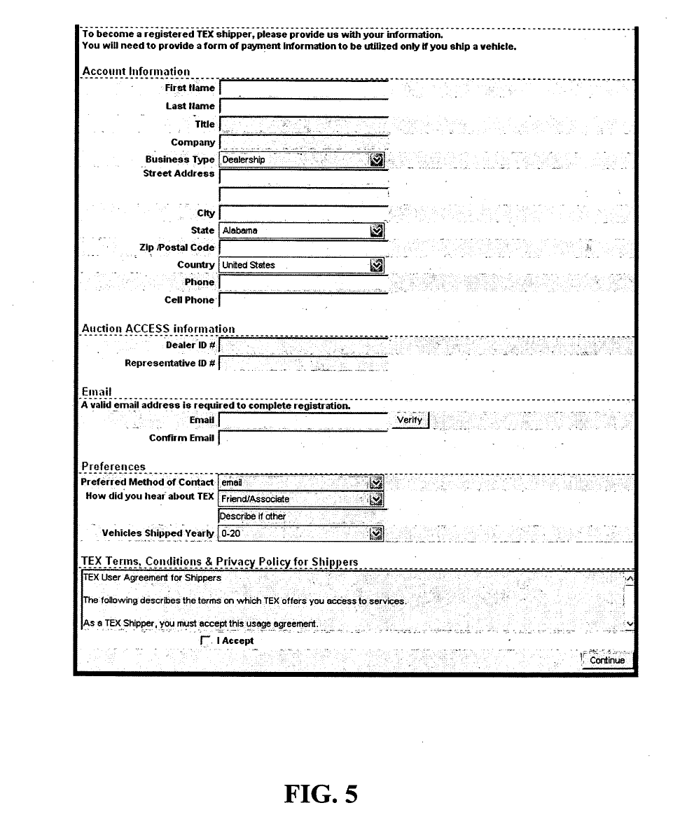

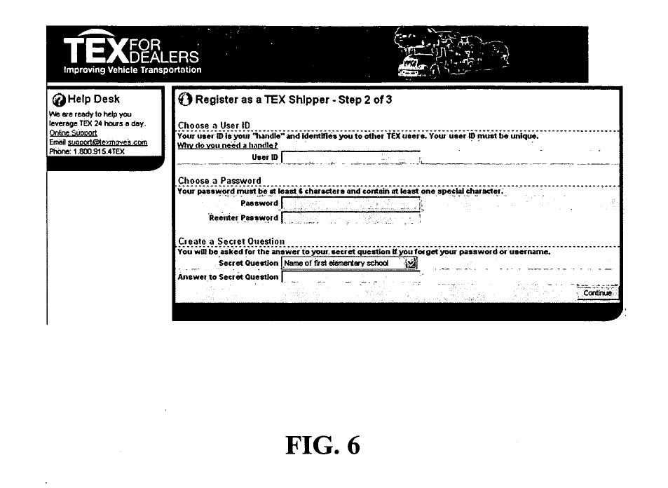

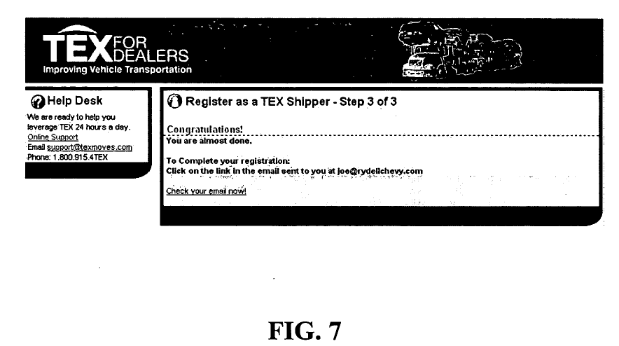

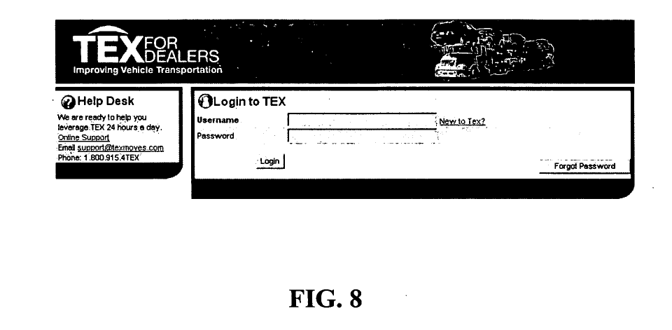

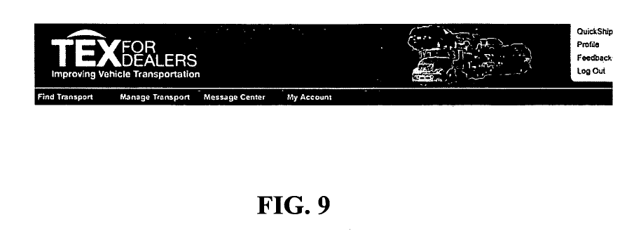

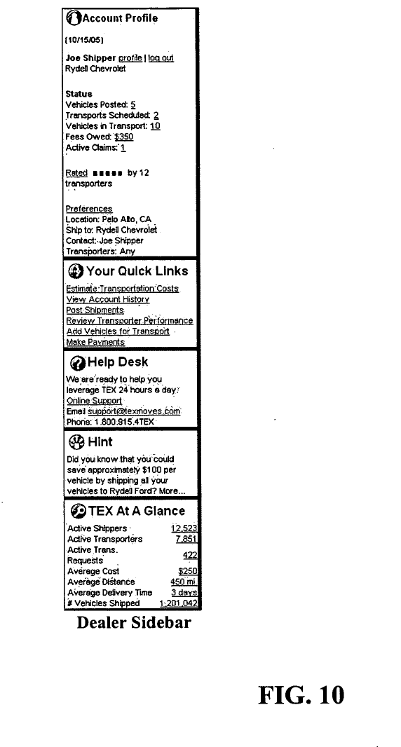

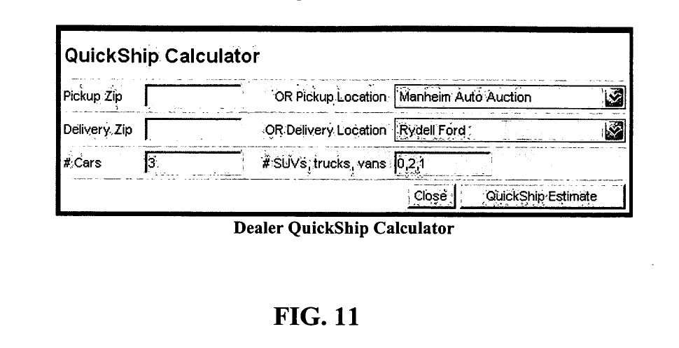

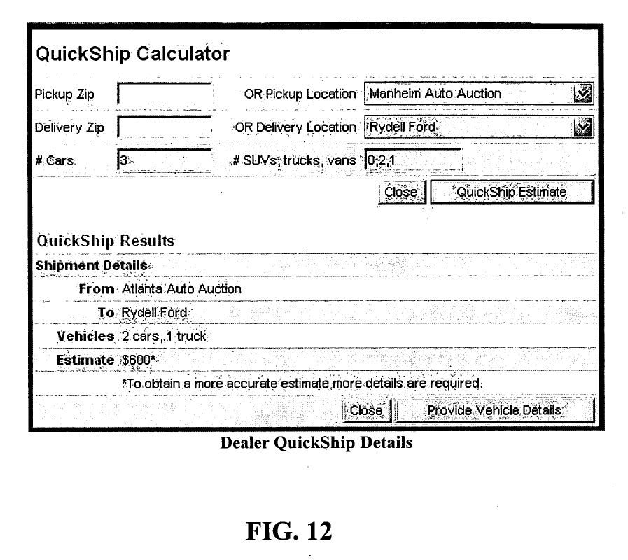

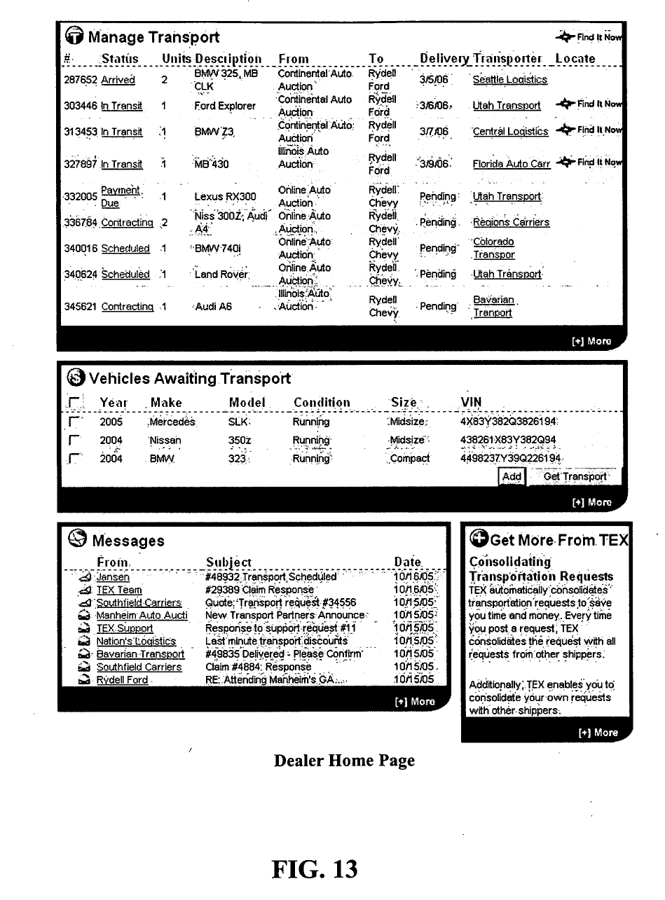

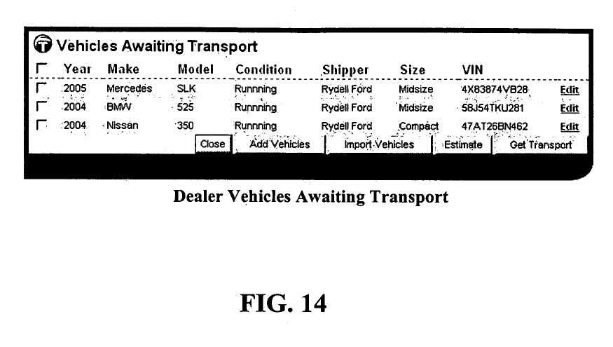

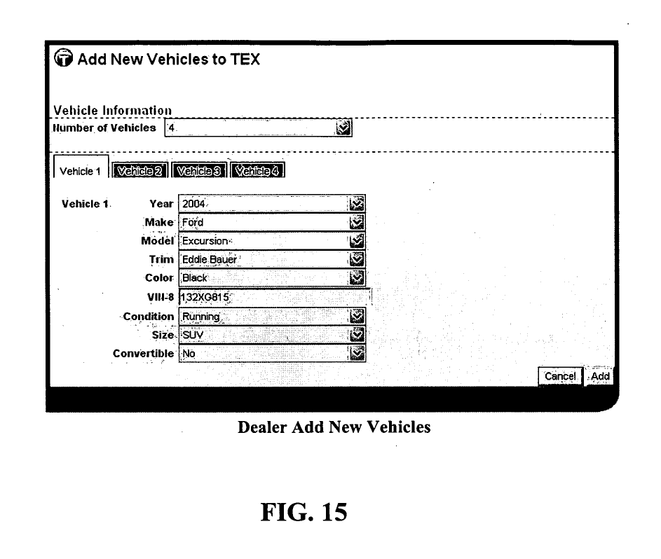

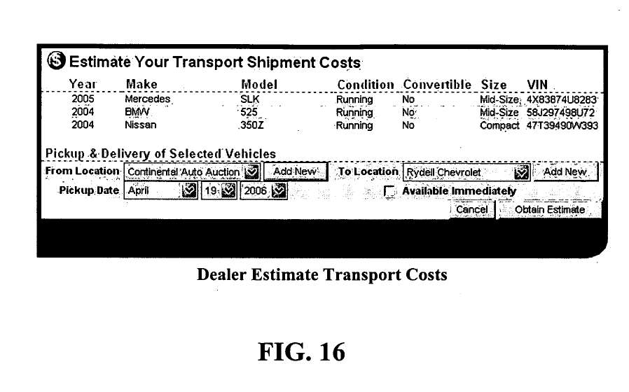

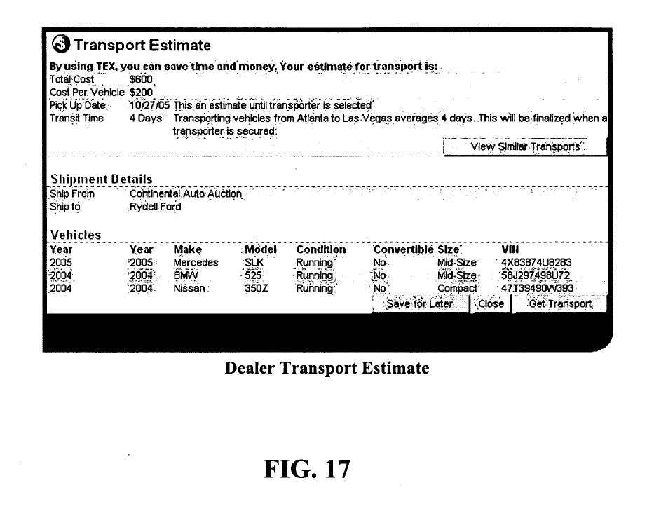

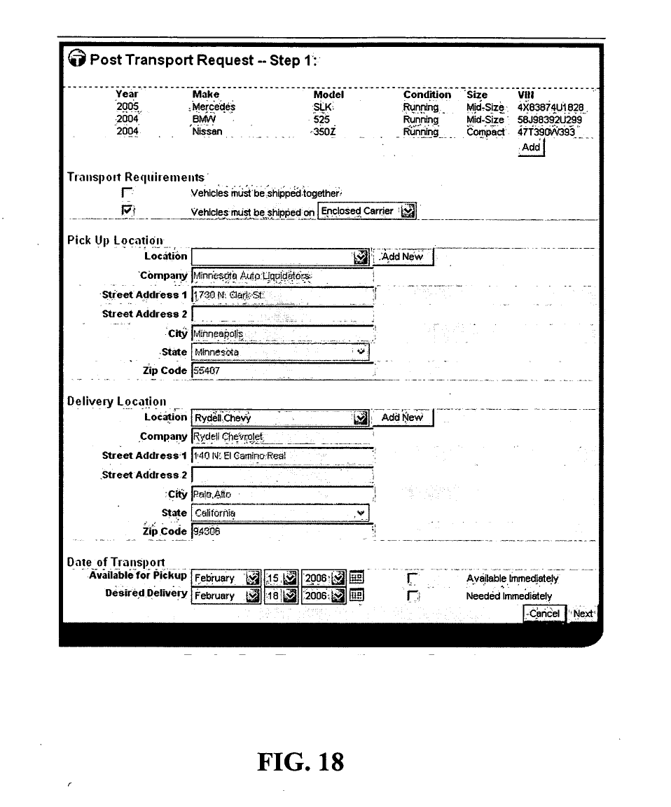

Dealers may register to use TEX via the dealer-facing portal. Following registration, an alert can be issued to TEX personnel, who can then review the application and, if appropriate, activate the dealer's account to enable access to TEX. Since dealer registration involves sensitive/confidential information of the dealer, it can be performed using Secure Socket Layer (SSL) encryption. Dealer registration is a multi-page process, as shown in FIG. 5 (Dealer Registration, Page 1 of 3).

Note that while date entry is shown for access information to a single auction, dealers may be members of multiple auctions. Accordingly, this can be implemented as a multi-tabbed region of the page, allowing for the identification of multiple auctions, as well as the unique access information for each auction.

The Continue button on page 1 of the registration process can only become enabled after the terms and conditions have been accepted by the dealer. See FIG. 6 (Dealer Registration, Page 2 of 3) and FIG. 7 (Dealer Registration, Page 3 of 3).

In order to validate the email address supplied by the Dealer, TEX can automatically generate an email to the address entered by the dealer in the second registration page. The email can contain a link to a validation page. When the validation page is visited by the dealer, the registration request is completed. An email alert can be issued to TEX personnel, and the TMA can identify the dealer in a list of applicants awaiting validation/activation. For TEX, dealer registration can establish both the dealer account and the sole user account associated with the dealer for all TEX access by that dealer. Multiple users per business entity (dealer or transporter) need not be supported by TEX.

Dealer Login

Registered dealers who have been activated by TEX personnel can login via the dealer login page, as shown in FIG. 8 (Dealer Login).

The “New to TEX?” link can navigate to the dealer registration page. The Forgot Password button can link to a page that will allow the dealer, via a correct answer to their previously entered security question/answer, to enter a new password and regain access to their account.

Dealer Menu Bar

Following a successful login, the dealer home, or main dealer page will appear.

The dealer home page, and all post-login dealer pages, can have the top menu as shown in FIG. 9 (Dealer Top Menu).

Below the top horizontal image are four pull-down navigation menus, entitled “Find Transport”, “Manage Transport”, “Message Center” and “My Account”. In addition, four links along the right edge of the horizontal image will permit the dealer to run a “QuickShip” shipping cost estimator, to access their profile, to access their own feedback, and to log out of TEX, respectively.

Dealer Sidebar

The dealer home page, and all post-login dealer pages, will have the following sidebar along the left-hand side. The sidebar will display the identity of the logged in dealer, the dealer's preference settings, and a “TEX at a Glance” summary of TEX. Although provided in the sidebar, the TEX sidebar need not include individualized “quick links”, a link to online support, or usage “hints. See FIG. 10 (Dealer Sidebar).

Dealer QuickShip Calculator

The QuickShip calculator provides a rapid, rough approximation of the dealer's potential shipping costs. An example of the calculator is shown in FIG. 11 (Dealer QuickShip Calculator).

The dealer may enter pick-up and delivery ZIP codes or, alternatively, may select from amongst their previously-entered pick-up and delivery locations. The dealer also enters the number of vehicles to be shipped, and an identification of their types (SUVs, trucks, etc). Next, the dealer clicks on the QuickShip Estimate button, causing the calculator to expand to display appropriate estimated costs, as shown in FIG. 12 (Dealer QuickShip Details).

Clicking on the Provide Vehicle Details button navigates to the Dealer Vehicles Awaiting Transport page, to permit the specification of more details, towards obtaining a more accurate estimate for the dealer.

Dealer Home Page

Following a successful login, the home, or main page will appear. The dealer home page can have the following general arrangement shown in FIG. 13 (Dealer Home Page).

The Manage Transport section will show, in a non-pageable grid, the most recent activity for up to 10 vehicle postings made by the dealer (i.e., groups of 1 or more vehicles posted for transport by the dealer). By clicking on the associated “more” button, or by an associated pull-down menu entry, a dedicated vehicle tracking page, with a fully pageable grid, may be viewed.

The Vehicles Awaiting Transport section will show vehicles which have been entered into TEX but which have not been posted for transport by the dealer. These vehicles may have been manually entered via TEX, or, as described in detail below with reference to the Dealer Kiosk application, the vehicles may have been entered into TEX via a web service accessed by an originating physical or virtual auction. By clicking on the associated “more” button, or by an associated pull-down menu entry, a dedicated vehicle posting page, with a fully pageable grid, may be viewed. By selecting one or more vehicles (via an associated checkbox) and then clicking on the Get Transport button, the dealer may navigate directly to the Post Transport Request page.

The Messages section will show the dealer's 10 most recently received TEX messages. By clicking on the associated “more” button, or by an associated pull-down menu entry, a dedicated TEX message center page, with a fully pageable grid, may be viewed.

Although the dealer home page displays news and hints frames, such as the “Get More from TEX” frame shown above, these features need not be implemented in TEX. TEX personnel will, however, be able to send TEX messages to all dealers and/or all transporters, which may contain news and/or usage hints.

Dealer Vehicles Awaiting Transport

The Dealer Vehicles Awaiting Transport may be reached by clicking on the “more” button of the Vehicles Awaiting Transport section of the dealer home page, or via the Find Transport→Add/View Vehicles pull-down menu item. See FIG. 14 (Dealer Vehicles Awaiting Transport).

This page shows vehicles belonging to this dealer which have been entered into TEX, but have not yet been posted by the dealer for transport. If more than 10 dealer vehicles are awaiting transport, the vehicles will be displayed as a pageable grid. Vehicles are selected for posting by clicking on the associated check box for one or more vehicles, and then clicking on the Get Transport button, resulting in navigation to the Post Transport Request page. Clicking on the top checkbox in the column header row will automatically select all vehicles awaiting transport.

Clicking on the Add Vehicles button will navigate to the Add New Vehicles page. Clicking on the Edit link for any vehicle will result in navigation to the Edit Vehicle page. Clicking on the Estimate button will navigate to the Estimate Your Shipment Costs page for the currently selected vehicles. Clicking on the close button will navigate to the main menu. Note that Import Vehicles function need not be implemented in TEX. Vehicles may be manually added, or may be added by a physical/virtual auction via a web service provided by TEX.

Dealer Add New Vehicles

The Dealer Add New Vehicles page, reached by clicking on the Add Vehicles button on the Vehicles Awaiting Transport page. See FIG. 15 (Dealer Add New Vehicles).

The Number of Vehicles box allows the dealer to indicate the number of vehicles to be added (from 1 to 9 vehicles may be added simultaneously, if desired). Changing the number of vehicles to be added will dynamically change the number of horizontal vehicle tabs displayed immediately below. Clicking on one of the vehicle tabs will dynamically display data entered (or to be entered) for that particular vehicle.

New Vehicle information entry will be data driven, based upon an associated database of vehicle year/make/model/trim information. Initially, only the year information will be enabled for a vehicle, with choices of “pre-1990” and individual choices of years from 1990-present. Selecting a particular year will enable the Make data selector, populated with all vehicle makes manufactured during the specified year. Selecting a particular make will enable the Model data selector, populated with all Models manufactured for the specified year and make. Selecting a particular model will enable the Trim data selector, populated with all trim packages for the specified year, make and model (if any). Color selection will be from amongst a list of predetermined colors, rather than being make/model/trim specific. The Vin-8 will permit data entry for the first eight characters of the vehicle's VIN number. The condition selector will permit selection from amongst a set of relevant condition types, including running, no brakes, no steering, etc. Size selection will indicate whether the vehicle is compact, mid-size, SUV, etc. and, if known from the entered year/make/model information, will be automatically set to an initial value. Finally, the dealer will indicate whether or not the vehicle is a convertible.

Clicking on the Add button will trigger a check that all required data has been entered for all of the selected quantity of vehicles. If not, a warning message will be displayed indicating what information is still required. Otherwise, the new vehicle(s) will be added to the database and the browser will navigate back to the Vehicles Awaiting Transport page. Clicking on the cancel button will also return to the Vehicles Awaiting Transport Page.

Dealer Estimate Transport Costs

The Dealer Estimate Transport Costs page, reached by clicking on the Estimate button on the Vehicles Awaiting Transport page. See FIG. 16 (Dealer Estimate Transport Costs):

A list of the vehicles selected for the cost estimate is shown at the top of the page. The dealer may select from a list of predetermined pick-up and delivery locations, or may click on associated Add New buttons to add a new pick-up and/or delivery locations to their associated pick-up/delivery location lists. The earliest available pick-up date may be entered using the month/day/year dropdown lists, which may alternatively be populated via a date picker control (not shown). Checking the “available immediately” box will automatically set the pick-up date to the current date. Clicking on the Obtain Estimate button will display the estimated transport costs. See FIG. 17 (Dealer Transport Estimate).

Clicking on the Get Transport button will navigate to the Post Transport Request page with the estimated vehicles selected for posting. Clicking on Close will navigate back to the Estimate Transport Costs page. Although shown in FIG. 17, the View Similar Transports and Save for Later functions need not be implemented in TEX.

Dealer Post Transport Request

The Dealer Post Transport Request page is reached by clicking on the Get Transport button from the dealer home page, the Vehicles Awaiting Transport page, or the Transport Estimate page; or via the Find Transport→Post Transport Requests menu item. Page 1 of this multi-page function is shown in FIG. 18 (Dealer Post Transport Request, Page 1).

The Post Transport Request, Page 1 page is initially populated with the previously selected vehicles, the pick-up and delivery locations used in cost estimation (if performed by the dealer prior to posting), the dealer's current transport requirements preference settings (whether vehicles in a posting must ship together, and required type of carrier), and dates of pick-up and delivery (if entered in cost estimation). The dealer may, if desired, add additional vehicles via the Add button (which will navigate to the vehicles awaiting transport page), change the transport requirements from their preference setting values, change pick-up and/or delivery locations, add new pick-up and/or delivery locations via the associated “Add New” buttons, and change the desired pick-up and/or delivery dates. Dates may be changed using the month/day/year dropdown lists, the date picker controls, and/or the available/needed immediately check boxes.

If new pick-up or delivery location entry is selected via an Add New button, the page pick-up or delivery location portion of the page will automatically change to display editable data entry fields. See FIG. 19 (Add New Pick-up Location).

The Add New Delivery Location page will be similar in appearance, but with earliest/latest delivery, rather than pick-up settings.

Referring back to the overall Dealer Post Vehicle for Transport Page 1 page, Clicking on the Cancel button will navigate to the vehicles awaiting transport page. Clicking on the Next button will navigate to Page 2 of the Post Transport Request function. See FIG. 20 ((Dealer Post Transport Request, Page 2).

On the second page of the transport request posting, an overview of the posting is presented, together with an identification of the dealer's default carrier preferences (i.e., the minimum threshold quality rating for the transporter, as well as the regions in which the transporter must operate). The dealer may change these settings for the current posting only, by clicking on the Edit link. Alternatively, the dealer may change these preferences globally, by clicking on the Change Shipping Preferences link, which will navigate to the Dealer Preferences Setup page.

Although a Save For Later button is shown in FIG. 20, no saving of partial transport requests need be supported by TEX. Clicking on the Post link will post the request to the database, and navigate to a posting confirmation page. See FIG. 21 (Dealer Post Transport Request Confirmation).

Clicking on the OK button will navigate back to the dealer home page.

Dealer Manage Transport/Find Vehicles

The Dealer Manage Transport/Find Vehicles page is reached by clicking on the More link associated with the Manage Transport panel of the dealer home page, or via the Manage Transport→Track Vehicles menu item. The Dealer Manage Transport/Find Vehicles page is shown in FIG. 22.

This page will display data as a pageable grid, with up to 10 rows per page. Each line item reflects an individual transport carrying one or more vehicles of the dealer. Note that if a dealer did not expressly require that a multiple-vehicle posting be shipped together, TEX personnel may split the posted vehicles into multiple vehicle loads in the offers made to transporters. In such cases, a single dealer posting may result in multiple transports, with each transport being identified as a separate line item on this page.

For each line item, the scheduled delivery date (or pending, if presently unscheduled), pick-up location, delivery location, vehicles (or subset of vehicles that will fit in the associated cell), current status, transport ID, and selected transporter will be displayed. Although a Locate column is displayed in FIG. 22, the “Find it Now” function need not be supported in TEX of the present invention. Dealers will, however, be able to view location updates for in-transit shipments when such data has been entered by the transporter.

The Status and Date dropdown lists will permit rapid, on-page filtering of the displayed transports. Initially, both dropdowns will be set to All. The shipment lists may be filtered by their current status, by selecting a current status of Completed, Arrived, In-transit, Payment Due, Confirmation Required, Scheduled or Contracting from the status dropdown list. They may also be filtered by date, by selecting Last 30, 60, 120, or 365 days from the Date dropdown list.

Clicking on the Advanced Search button navigates to the Find Vehicles Advanced Search page, as shown in FIG. 23 (Dealer Find Vehicles Advanced Search).

This page permits the dealer to search by any combination of a variety of criteria, including the shipment status, pick-up location, delivery location, requested delivery date, vehicle make and model, and transporter name. Clicking on the Cancel button navigates back to the Dealer Manage Transport/Find Vehicles page without performing the search. Clicking on the Search button also navigates back to this page, but with the displayed shipments filtered to only those matching the advanced search criteria entered by the dealer.

Dealer Transport Status Details and Transport-Related Pages

The Dealer Transport Status Details page is reached by clicking on a link in an entry in either the Status column of the Dealer Manage Transport/Find Vehicles page, or the Status column of the Manage Transport panel of the Dealer Home Page. The Dealer Transport Status Details is shown in FIG. 24.

The top pane of this page identifies the current status of the specified shipment, similar to the selected entry on the Dealer Manage Transport/Find Vehicles page. The bottom pane displays the entire historical record for the shipment, from dealer posting through vehicle delivery. As shown above, most of the line-items may be drilled down into by clicking on the associated status link. Examples of each of these drill-down pages are shown in FIG. 25.

Clicking on a Posted status link displays the Dealer Transport Details page. This page displays a summary of the posting information entered by the dealer, together with the dealer costs and estimated delivery dates. If the posting has reached the phase where a transporter has scheduled vehicle pick-up, the View Documentation button will be enabled. Clicking on the View Documentation button will display an associated bill of lading document, generated automatically by TEX software, in PDF file format. An example bill of lading is shown in FIG. 26.

Clicking on the Close button navigates back to the Transport Status Details page. See FIG. 27 (Dealer Transport Scheduled).

Clicking on a Posted status link displays the Dealer Transport Scheduled page. This page displays an overview of the scheduling information for the contracted shipment, including the selected transporter, and scheduled pick-up and delivery dates and times. Clicking on the View All Details button displays a page similar to the Dealer Transport Details page above, but with scheduled pick-up and delivery dates, rather than requested and estimated dates, respectively. Clicking on the View Documentation button will display an associated bill of lading document, generated automatically by TEX software, in PDF file format. Clicking on the Close button navigates back to the Transport Status Details page.

Clicking on a Payment Made status link on a Transport Status Details displays an associated Dealer Invoice for the shipment, generated automatically by TEX software, in PDF file format, an example of which is shown in FIG. 28 (TEX Dealer Invoice).

Clicking on a Vehicle in Route link, associated with a transport position update entered by the transporter, will navigate to the Dealer Transport Tracking page, as shown in FIG. 29 (Dealer Transport Tracking).

The Dealer Transport Tracking page displays the position information entered by the transporter, the delivery status indication (i.e., on-time, early, delayed), as well as useful summary information for the shipment. Clicking on the Close button returns to the Transport Status Details page.

Clicking on a Vehicle Delivery—Confirmation Pending link on the Transport Status Details Page displays the Dealer Confirm Delivery page. See FIG. 30.

The Dealer Confirm Delivery page permits the dealer to confirm receipt of a shipment, once the transporter has indicated delivery. This page may also be reached from the pull down menu, via the Manage Transport→Accept Delivery item. This page is initially populated with date/time information from the transporter's delivery and vehicle inspection data. The dealer may modify any of this pre-populated data. Clicking on the Confirm button will confirm delivery, resulting in a navigation back to the Dealer Transport Status Details page, with a new line item for the shipment, indicating that delivery has been confirmed by the dealer. Clicking on the Delivery Confirmed link on the Dealer Transport Status Details page will re-display the Dealer Confirm Delivery page, pre-populated with the previously-entered data. Clicking on the View Documentation button displays the TEX bill of lading for the shipment. Clicking on the View Inspection displays the transporter's delivery inspection report, in read-only format. An example inspection report is shown in FIG. 31 (Dealer Inspection Report).

Clicking on the Close button returns to the Dealer Confirm Delivery page. On that page, clicking on the Submit a Claim button displays the Dealer Submit Claim page. This page is similar to the Delivery Inspection Report except, instead of being read-only, the dealer is permitted to enter its own inspection information to create a Claim for monetary damages from the Transporter. Clicking on any damage area checkbox will automatically pre-populate the detailed damage description box with text identifying the damaged area, visually prompting the user for additional information on the particular damage to that area. This page will have both Cancel and Submit Claim buttons. Clicking on Cancel will navigate back to the Dealer Confirm Delivery Page. Clicking on Submit Claim will navigate to the Manage Claims page, as shown in FIG. 32 (Dealer Manage Claims).

The Dealer Manage Claims page displays all of the claims which have been submitted by the dealer. In addition to clicking the Submit a Claim button on the Dealer Confirm Delivery page, this page may be reached via the pull-down menu, via the Manage Transport→Manage Claims menu item. Clicking on the Add New Claim navigates to the Dealer Submit Claim page, which is substantially similar to the Delivery Inspection Report. The Dealer may view the details and status of an individual claim, by clicking on the associated claim number, which navigates to the Dealer Claim Details and Status page, as shown in FIG. 33.

Referring back to the Transport Status Details page, clicking on a Feedback Submitted link will display the particular feedback that the dealer had left relative to the transporter, concerning the individual transport transaction.

As shown in FIG. 33, the Dealer Claim Status and Details page displays the detailed claim information submitted by the dealer, as well as additional events relating to the claim, including any responses thereto by the vehicle's transporter. Clicking on the “Contact Transporter” will initiate the creation of a message from the dealer to the transporter via the TEX message center (described in detail below), automatically populating the recipient and re: fields with the transporter and identification of the claim, respectively.

Dealer View Account Summary

The Dealer View Account Summary page, which can be reached by the pull-down menu via the Manage Transport→View Account Summary link, is shown in FIG. 34.

This page can be initially populated with the current month selected, and associated monthly and year to date summary information displayed. One year of historical data can be available online to the dealers, and summaries for prior months may be displayed by changing the month in the dropdown list. Clicking on the Print button will launch a printer-friendly version of the report, without the page's controls, header, menu or sidebar, in a separate window. Although a Download button is shown in FIG. 34, no Dealer data export or downloading need be supported in TEX of the present invention.

Clicking on the View Details button will navigate to an expanded, shipment-by-shipment monthly report. See FIG. 35 (Dealer View Account Details).

This page will again initially be populated with the current month selected. Shipments occurring during the selected month will be displayed in a pageable grid, with a maximum of 10 shipments per page. Clicking on an individual shipment number will navigate to the Transport Details page for the selected shipment. Clicking on a fee value will display the Dealer invoice for the shipment, in PDF file format. Clicking on a Yes link under the claim column will display the Claim Status and Details page for the selected claim. Clicking on the Print button will launch a printer-friendly version of the report, without the page's controls, header, menu or sidebar, in a separate window. Although a Download button is shown FIG. 35, no Dealer data export or downloading need be supported in TEX.

Dealer Profiles, Preferences, Payment Methods and Alerts

The Dealer profile, preference and alert pages will employ Secure Socket Layer (SSL) encryption. Selecting My Account→View Profile from the pull down menu navigates to the Dealer User Profile page, shown in FIG. 36.

This page permits the dealer to change their password and password recovery information, their auction access information, and their personal information. Clicking on the Billing link, or the My Account→Billing Information link on the pull-down menu navigates to the Dealer Billing Information page or Dealer Payment Information. See FIG. 37.

This page permits the dealer to enter and change their TEX payment information, including the use of credit cards, checking account authorizations, PayPal, and/or the establishment of a wholesale account with TEX (subject to credit approval).

Clicking on the Notifications link, or selecting My Account→Set Alerts from the pull-down menu, navigates to the Dealer Notification Preferences page. See FIG. 38.

This page permits dealers to select the method(s) of alerting them to significant events occurring on TEX, using any combination of TEX messages, email, and SMS text messages. The dealer may also select the particular events that trigger an alert message, such as when a vehicle delivery date is changed, a vehicle is picked up, or its account is invoiced.

Clicking on the Shipping & Delivery link navigates to the Dealer Shipping and Delivery preferences page. See FIG. 39.

This page permits the dealer to enter vehicle pick-up and delivery locations, identify preferred pick-up and delivery preferences, set the minimum quality threshold for transporters who may carry their vehicles, and to create and edit their own Carrier Quality List, where the dealer may expressly exclude identified transporters from carrying their vehicles in the future. In addition, dealers who have special arrangements with a particular transporter may use the Carrier Quality List to specify that only a particular transporter may be used to carry their vehicles.

Feedback and Transporter Profile Information

Dealers may leave feedback concerning the transporters carrying their vehicles, review prior feedback concerning these transporters, and view feedback concerning them left by transporters. Clicking on the Feedback link on a profile/preference page, or selecting Manage Transport→Manage Feedback from the pull-down menu, navigates to the main feedback page. See FIG. 40 (Dealer Feedback).

This page permits the dealer to view their recently completed transactions for which feedback has not been submitted, and to view the most recent feedback that transporters have submitted, relative to the dealer. Clicking on the View All button will display all of the feedback received, in a pageable grid. Clicking on a Leave Feedback link will navigate to a Dealer Leave Feedback About Transaction page. See FIG. 41.

This page displays information identifying the transaction, and permits the dealer to rate the transporter's performance on a timeliness, quality, service, and overall basis. The dealer may also leave associated comments as a part of the submission. As specified below, the dealer may also leave general feedback concerning a transporter which is not necessarily identified with a particular transaction.

Throughout the Dealer Portal, whenever a particular transporter's name is displayed, it is in the form of a hyperlink, which navigates to the associated Transporter Profile page. See FIG. 42.

The Transporter Profile page displays general information concerning the transporter, including how long the transporter has been in business, the types of vehicles in the transporter's fleet, etc. The transporter's quality ratings and most recent feedback are displayed. Clicking on the View All button navigates to a pageable grid displaying all of the transporter's feedback. Clicking on the Submit Feedback navigates to a page that is similar to the Dealer Submit Feedback About Transaction page discussed above, except that the feedback that is left is general, rather than being associated with a particular transaction. By clicking on the View Insurance Certificate button, the dealer may view a copy of the transporter's insurance certificate in PDF file format By clicking on the View Performance button, a pop-up window is displayed with a detailed performance summary for the transporter. See FIG. 43.

As shown above, this page summarizes the dealer's performance metrics, including vehicles shipped, timeliness of delivery, and claims filed, on a monthly, year to date, and from the inception of the transporter's TEX membership basis.

TEX Message Center

The TEX message center will permit the dealer to view messages received from transporters and TEX personnel, to review alert messages (if TEX messages was amongst the alert notification methods specified by the dealer in its preferences) and to send messages to transporters carrying their vehicles and to TEX personnel. Through an address book that is assembled “on the fly” as a dealer attempts to issue a new message, dealers will only be permitted to use the TEX message center to communicate with transporters which are assigned to their vehicles but have not completed delivery (unless a claim is filed, in which case the dealer will be permitted ongoing communication relative to the claim), and to communicate with TEX personnel. The TEX message center is shown in FIG. 44.

As shown above, TEX messages will be placed into one of four predefined folders: Shipping in progress, Vehicles Delivered, General and Sent. The “New” folder displays unread incoming messages, grouped by their associated folder. For TEX, all messages can be placed into one of these predetermined folders, and users need not be permitted to create new folders, to delete existing folders, or to move messages between folders.

Dealer Kiosk

The Dealer Kiosk will be optionally be employed at physical auctions to enable dealers with established TEX accounts to easily ship their vehicles through TEX. In addition to the TEX Dealer Kiosk application, the auction kiosks will also be running other, auction-specific functions on behalf of the physical auctions themselves. While the Dealer Kiosk will be a conventional web-based application, it will also have access to kiosk-specific hardware features, such as a magnetic card reader and touch screen.

Each primary function of the Dealer Kiosk is identified in the following sections.

Welcome Page

Initially, the dealer is presented with a welcome page, where the dealer is asked to swipe his/her auction access card, or to manually enter an auction access number and auction representative number. An example of a “Welcome” page is shown in FIG. 45.

If the dealer swipes a key card, the auction access number and representative number from the card are compared with the associated information entered into the Dealer by TEX as part of its profile. If a match is found, the display navigates to the Select Vehicles for Transport page. Otherwise, if the dealer has manually entered an auction access number, the dealer is then prompted for an associated representative number. Whether data was entered via a keycard swipe or manually, the Select Vehicles for Transport page is displayed. See FIG. 46 (Dealer Kiosk Select Vehicles for Transport).

The dealer is presented with a list of vehicles just purchased at auction, and may select one or all of them for shipment by checking the associated checkbox to the left (the topmost checkbox causes all vehicles to be selected). Vehicles will be displayed in a pageable grid format, with five vehicles per page. The dealer then presses an appropriate NEXT button to indicate if the vehicles are being shipped to a single location, or to multiple locations.

If the vehicles are being shipped to a single location, a screen like that shown in FIG. 47 (Dealer Kiosk Single Delivery Location).

The dealer is presented with the list of selected for shipment, and a single dropdown list containing the dealer's previously entered delivery locations. The dealer selects the desired location for the vehicles, and presses the Next button.

If, instead, the dealer has indicated that there are multiple delivery locations for the vehicles, a like that shown in FIG. 48 (Dealer Kiosk Multiple Delivery Locations) is displayed.

As shown in FIGS. 47 and 48, each vehicle has an associated dropdown list, for per-vehicle specification of delivery locations from amongst the dealer's previously entered locations. Whether single or multiple vehicles have been selected, the page like that shown in FIG. 49 (Dealer Kiosk Confirm Transport Preferences) is displayed for shipment preference confirmation:

The dealer is presented with their current preference settings for transport, including whether the vehicles must be shipped together, the type of carrier required, and the minimum transporter quality threshold. The user may alter the settings for the current shipment, as desired. Pressing the Next button navigates to the Confirm Shipment Details page, as shown in FIG. 50.

The dealer is presented with a summary of their vehicles, grouped into shipments by delivery locations. As shown in FIG. 51, the dealer may review details concerning a particular shipment by pressing an associated Details button.

Pressing the Back button navigates back to the Confirm Shipment Details page. On that page, pressing the Ship button posts the dealer's shipment request(s), and displays the confirmation page as shown in FIG. 52.

Transporter Portal

Each primary function of the Transporter Portal is identified in the following sections.

Transporter Registration

Transporters may register to use TEX via the transporter-facing portal. Following registration, an alert will be issues to TEX personnel, who must then review the application and, if appropriate, activate the transporter's account to enable access to TEX. Transports will initially be required to enter a significant amount of information about them, not all of which will be shown to dealers. Instead, much of the information will be used by TEX personnel to review assess the Transporter's suitability for TEX membership, and to assign an initial TEX quality rating. Since transporter registration involves sensitive/confidential information of the dealer, it will be performed using Secure Socket Layer (SSL) encryption. Transporter registration will be a multi-page process, and will collect the following information:

Company name & Address

Contact information—name, phone, fax, email

Preferred contact methods

Years in Business

References—Names, numbers, length of relationship, notes

Federal Transport #

State DOT # (s)

Owner/Operator? Y/N

Broker? Y/N

Nationwide? Y/N

Regions served

Fleet (for each vehicle, an indication of the truck #, carrying capacity in both number of vehicles and gross weight, and select truck type from a drop down list

Insurance Coverage—Cargo, E&O, Liability

Insurance Coverage Limits for each coverage type

Insurance Company.

Policy Expiration

Upload of insurance policy in PDF file format

Any special terms and/or requirements of the transporter

The average number of vehicles shipped per year

The average distance shipped per vehicle per year

Standard Rates

Payment terms (i.e., 50% on pick-up, 50% on delivery) and specification of payment receipt methods and accounts.

Any special areas of transporter specialization: Multi-list drop downs including luxury vehicles, salvage, non-running vehicles, oversized vehicles, etc.

Safety Statistics

Transporter Login

Registered transporters who have been activated by TEX personnel will login via the transporter login page, as shown in FIG. 53.

A “New to TEX?” link will navigate to the transporter registration page. A Forgot Password button will link to a page that will allow the transporter, via a correct answer to their previously entered security question/answer, to enter a new password and regain access to their account.

Transporter Menu Bar

Following a successful login, the transporter home, or main transporter page will appear. The transporter home page, and all post-login dealer pages, will have the top menu, like that shown in FIG. 54.

Below the top horizontal image are four pull-down navigation menus, entitled “Find Transport”, “Manage Transport”, “Message Center” and “My Account”. In addition, links along the right edge of the horizontal image will permit transporters to view/edit their profiles and preferences, and to review their feedback, and to log out of TEX, respectively. Although shown in the graphic above, online Help need not be provided in TEX.

Transporter Sidebar

The transporter home page, and all post-login transporter pages, will have the following sidebar along the left-hand side. The sidebar will display the identity of the logged in transporter, the transporter's preference settings, and a “TEX at a Glance” summary of TEX. Although shown in the sidebar, the TEX sidebar need not include individualized “quick links”, a link to online support, or usage “hints. See FIG. 55.

Transporter Home Page

Following a successful login, the home, or main page will appear. The transporter home page will have the general arrangement like that shown in FIG. 56.

The Fill Loads section will show, in a non-pageable grid, the 10 most recent loads (i.e., groups of 1 or more vehicles posted for transport by the TEX personnel) that meet the criteria of the current transporter (i.e., minimal quality rating, not excluded by the associated dealer, etc). By clicking on the associated “more” button, or by an associated pull-down menu entry, the Transporter Search for Vehicles Awaiting Transport page is displayed, to enable the display of all available loads, or loads meeting particular search criteria. By clicking on an Accept link for a displayed load, a transporter may proceed directly to the Transporter Confirm Acceptance page for the particular vehicle load.

The Transport Dashboard section will show the status of the 10 most recent loads which have been contracted to the transporter, and are awaiting pick-up, in transit, delivered, etc. By clicking on the associated “more” button, or by an associated pull-down menu entry, a dedicated transport dashboard page, with a fully pageable grid, may be viewed. By clicking on a status entry of a particular load, the Transport Status Details page for the load may be viewed.

The Mailbox section will show the transporter's 10 most recently received TEX messages. By clicking on the associated “more” button, or by an associated pull-down menu entry, a dedicated TEX message center page, with a fully pageable grid, may be viewed.

Although the transporter home page above includes news and hints frames, such as the “Get More from TEX” frame shown above, these features need not be implemented in TEX. TEX personnel will, however, be able to send TEX messages to all dealers and/or all transporters, which may contain news and/or usage hints.

Transporter Search for Vehicles Awaiting Transport

The Transporter Search for Vehicles Awaiting Transport page may be reached by clicking on the “more” button of the Fill Loads section of the dealer home page, or via the Find Transport→Find Vehicles Awaiting Transport pull-down menu item. See FIG. 57.

This page is initially populated with search criteria encompassing all posted loads. Accordingly, clicking on the Search button will display all loads which the transporter, given its quality ratings and capabilities, is capable of accepting. Alternatively, the transporter may narrow the search by entering a pick-up or delivery city, state or ZIP, specifying a 25, 50, or 100 mile radius from the specified pick-up and delivery locations, specify a range of pick-up dates, a range of prices for the load, and/or a range of vehicles in the load. Clicking on the Search button will display all vehicle loads meeting the search criteria and the transporter's qualifications. See FIG. 58 (Transporter Search for Vehicles Awaiting Transport Results).

The search results page is a pageable grid, with up to 10 vehicle loads displayed per page. The dealer may view additional details concerning a particular load by clicking on the associated Posting #, may view details concerning the shipping dealer by clicking on a dealer's name, or may proceed directly to the acceptance confirmation by clicking on the Accept link. A Counter link indicates that the transporter has made a counter offer on the load, which may be accepted or declined (or ignored) by TEX personnel. Clicking on the Refine Search button will navigate back to the Transporter Search for Vehicles Awaiting Transport page, with the prior search criteria repopulated into the page's controls. Clicking on New Search will also navigate to the search page, but with cleared controls.

Transporter Offer Review, Counter Offer, Acceptance, and Declining of Offers

Clicking on an individual transport request, from either the transporter main page or the Transporter Vehicle Search Results page will navigate to the Transporter Review Transport Request Details Page. See FIG. 59.

The Review Transport Request Details shows all of the details for the transport request, including an identification of all of the associated vehicles, whether they must be shipped together, whether a covered carrier is required, whether negotiations are permitted, etc. Although a single pick-up and delivery location is shown in the example above, a transport request may include different per-vehicle pick-up and delivery locations. If so, horizontal tabs will display the pick-up and delivery locations for each vehicle in the load.

The dealer may accept the transport request by clicking on the Accept button, which will navigate to the Transporter Confirm Acceptance of Transport Request page. If negotiations are permitted, the Counter button will be enabled, and clicking on the Counter button will navigate to the Transporter Submit Counter Offer page. See FIG. 60.

The Submit Counter page shows the current offer (or counter offer) made by TEX personnel or TEX automatically, and permits the transporter to issue a counter offer, varying the price, pick-up or delivery dates, type of carrier to be used, and to specify additional terms, if any, in free format text. The transporter may also specify whether TEX, such as TEX personnel, may come back with further counter offers, as well as an expiration time for the counter offer. For TEX, transporters need not be able to counter-offer to take less than the full set of vehicles in the offer. Clicking on the Submit button displays a brief message, confirming submission of the counter-offer.

The Transporter Confirm Acceptance of Transport Request page is reached when the transporter clicks an accept link (on the transporter home page or vehicle search results page), or clicks the Accept button from the Review Transport Status Details Page. See FIG. 61.

This page displays a summary of the transport request. By clicking on the Confirm Acceptance button, the transporter is assigned the posted vehicle load.

The Transporter Manage Offers page, reached via the Find Transport→View Offers pull-down menu item, displays posted loads for which the transporter has made an offer. See FIG. 62.

Initially, all loads for which the transporter has made an offer are displayed in a pageable grid, with up to 10 loads per page. The Status dropdown list permits the transporter to filter the list by offer status (accepted, declined, countered, pending, expired, cancelled), and/or by date of the posting (last 30, 60, 120, or 365 days). Clicking on any particular posting ID# navigates to the Transporter Review Transport Request Details page, as discussed above.

Clicking on any ID# for which TEX personnel have made a counter offer to a counter offer of the transporter displays the counter offer details. See FIG. 63.

The transporter may click on the Accept button to accept the counter offer, which will cause navigation to an acceptance confirmation page, as described above. Alternatively, the transporter may decline the counter offer by clicking on the Decline button, navigating to the Transporter Decline Offer page. See FIG. 64.

The transporter is prompted to enter a reason for declining the offer, and may choose from a list including price, pick-up date, delivery date, or other. If other, explanatory text may be entered.

Transporter Transport Pick-up/Delivery Scheduling, Inspections, and Status Updates

The Transporter Transport Dashboard displays shipments accepted by the transporter, from the moment of acceptance through delivery and, if necessary, claim processing. An example of the dashboard is shown in FIG. 65.

The Transport Dashboard is a pageable grid, with 10 shipments per page. The transporter may filter the displayed shipments by Status (completed, arrived, in transit, payment due, confirmation required, scheduled, contracted), and/or by date (last 30, 60, 120 or 365 days). Alternatively, the transporter may click on the Advanced Search button to navigate to the advanced search page. See FIG. 66.

The Advanced Search page permits filtering shipments by their status, pick-up or delivery location, delivery date, or vehicle make/model. Clicking on Search will return to the Dashboard page with the matching shipment data displayed.

From the transport dashboard page, clicking on the status link in any shipment will display an associated Transport Status Details page for the shipment. An example transport status details page is shown in FIG. 67.

The top pane of this page identifies the current status of the specified shipment, similar to the selected entry on the transport dashboard page. The bottom pane displays the entire historical record for the shipment, from dealer posting through vehicle delivery. As shown above, most of the line-items may be drilled down into by clicking on the associated status link. Examples of each of these drill-down pages are similar to those explained above with respect to the Dealer Transport Status Details page.

If pick-up or delivery has not been scheduled for the displayed shipment, Schedule Pick-up and Schedule Delivery buttons will be displayed, respectively. Each of these buttons will cause navigation to an associated date/time data entry pages. Once pick-up and delivery have been scheduled for the transport, the Pick-up Vehicle and Deliver Vehicle buttons will be displayed respectively. Clicking on the Pick-up Vehicle button displays the Transporter Pick-up Shipment page, as shown in FIG. 68.

An overview of the shipment is displayed towards the top of the page. The transporter enters the driver name, assigned truck number, the date and time the pick-up occurred, and the number of vehicles loaded. Clicking on the View Documentation link displays the bill of lading for the shipment, generated automatically by TEX software in PDF file format. For each vehicle, an associated Inspection link navigates to the Transporter Vehicle Pick Up Inspection page, an example of which is shown in FIG. 69.

An overview of the shipment and particular vehicle are displayed towards the bottom of the page. The transporter identifies they severity, nature, and location of the damage, as well as a detailed explanation of same. Clicking on a vehicle region surrounding the automobile image automatically populates prompting text, such as “Front left damage:”, into the detailed description data entry region. Clicking on the Submit button stores the inspection information and navigates back to the Pick Up Shipment page. Once all data has been entered and all vehicles have been inspected, clicking on the confirm button completes the shipment pick up.

Referring back to the Transporter Transport Status Details page, clicking on Deliver Vehicle button navigates to the Transporter Deliver Shipment page, an example of which is shown in FIG. 70.

As with the Pick Up Shipment page, an overview of the shipment is displayed towards the top of the page. The transporter enters an identification of the dealer representative accepting delivery, the date and time the delivery occurred, and the number of vehicles delivered. Clicking on the View Documentation link displays the bill of lading for the shipment, generated automatically by TEX software in PDF file format. For each vehicle, an associated Inspection link navigates to the Transporter Vehicle Delivery Inspection page, similar in appearance and function to the Transporter Vehicle Pick Up Inspection page, discussed above. Clicking on the Confirm button completes the vehicle pick up process, and navigates back to the Transporter Transport Status Details page.

On the Transporter Transport Status Details Page, clicking on the Update Status button navigates to the Transporter Update Transport Status page, as shown in FIG. 71.

On this page, the transporter may update the status of the shipment from on time to delayed, may specify an updated delivery date, and/or may update the present location of the transport by city and state. Although GPS position is shown in the example above, TEX need not support GPS transport positioning. The transporter may optionally enter additional comments, prior to confirming the status update by clicking the Submit button.

Transporter Claim Management

The Transporter Manage Claims page is reached via the Manage Transport→Manage Claims pull-down menu item. See FIG. 72.

The Transporter Manage Claims page displays all of the claims which have been submitted by a dealer, relative to a vehicle carried by the transporter. Clicking on the Manage Claim button for an associated shipment displays the claim details and status page. See FIG. 73.

This page displays the claim information entered by the dealer in read-only format, together with the claim processing events towards the bottom of the page. The transporter may click on the Contact Shipper button to send a TEX message to the dealer, causing the recipient and subject information to be automatically populated in a new TEX message. The transporter may, alternatively, enter a “formal” response to the claim, such as an offer of settlement, which will be entered into the claim processing history.

Transporter View Account Summary

The Transporter View Account Summary page, reached by the pull-down menu, via the Manage Transport→View Account Summary link, is shown in FIG. 74.

This page will initially be populated with the current month selected, and associated monthly and year to date summary information displayed. One year of historical data will be available online to the transporters, and summaries for prior months may be displayed by changing the month in the dropdown list. Clicking on the Print button will launch a printer-friendly version of the report, without the page's controls, header, menu or sidebar, in a separate window. Although a Download button is shown in FIG. 74, no transporter data export or downloading need be supported in TEX.

Clicking on the View Details button will navigate to an expanded, shipment-by-shipment monthly report. See FIG. 75.

This page will again initially be populated with the current month selected. Shipments occurring during the selected month will be displayed in a pageable grid, with a maximum of 10 shipments per page. Clicking on an individual shipment number will navigate to the Transport Details page for the selected shipment. Clicking on a fee value will display the transporter invoice for the shipment, in PDF file format. Clicking on the Print button will launch a printer-friendly version of the report, without the page's controls, header, menu or sidebar, in a separate window. Although a Download button is shown in FIG. 75, no transporter data export or downloading need be supported in TEX.

Transporter Profiles, Preferences, Payment Receipt Methods and Alerts

The Dealer profile, preference and alert pages will employ Secure Socket Layer (SSL) encryption. Selecting My Account→View Profile from the pull down menu navigates to the Dealer User Profile page. This page will display, and permit the transporter to edit, all of the profile information identified above with respect to the transporter TEX application process.

Clicking on the Notifications link, or selecting My Account→Set Alerts from the pull-down menu, navigates to the Transporter Notifications Preferences page. See FIG. 76.

This page permits transporters to specify the method(s) of alerting them to significant events occurring on TEX, using any combination of TEX messages, email, and SMS text messages. The transporter may also select the particular events that trigger an alert message, such as when a vehicle is posted which matches the dealer's capabilities and preferences, when a counter offer is accepted, when feedback is received, etc.

Feedback and Transporter Profile Information

Dealers may leave feedback concerning the transporters carrying their vehicles, review prior feedback concerning these transporters, and view feedback concerning them left by transporters. Clicking on the Feedback link on a profile/preference page, or selecting My Account→View Feedback from the pull-down menu, navigates to the main feedback page. See FIG. 77.

This page permits the transporter to view their recently completed transactions for which feedback has not been submitted, and to view the most recent feedback that dealers have submitted, relative to the transporter. Clicking on the View All button will display all of the feedback received, in a pageable grid. Clicking on a Leave Feedback link will navigate to a Transporter Leave Feedback About Transaction page. See FIG. 78.

This page displays information identifying the transaction, and permits the transporter to rate the dealer's performance on an overall basis. The transporter may also leave associated comments as a part of the submission.

Clicking on the View Details button on the Transporter Feedback page displays more detailed feedback information. See FIG. 79.

In addition to the most recently-received feedback, the transporter's individual rating scores are displayed for timeliness, quality and service. Clicking on the View Performance Statistics link on this page navigates to the Transporter Performance Details page. See FIG. 80.

As shown in FIG. 80, this page summarizes the transporter's performance metrics, including vehicles shipped, timeliness of delivery, and claims filed, on a monthly, year to date, and from the inception of the transporter's TEX membership basis.

Throughout the Transporter Portal, whenever a particular shipper's name is displayed, it is in the form of a hyperlink, which navigates to the associated Shipper Profile page. See FIG. 81.

The Shipper Profile page displays general information concerning the shipper, the shipper's quality ratings and most recent feedback. Clicking on the View All button navigates to a pageable grid displaying all of the shipper's feedback. Clicking on the Submit Feedback navigates to a page that is similar to the Transporter Submit Feedback About Transaction page discussed above, except that the feedback that is left is general, rather than being associated with a particular transaction.

TEX Message Center

The TEX message center will permit the transporter to view messages received from dealers and TEX personnel, to review alert messages (if TEX messages was amongst the alert notification methods specified by the transporter in its preferences) and to send messages to dealers whose vehicles the transporter is carrying, as well as to TEX personnel. Through an address book that is assembled “on the fly” as a transporter attempts to issue a new message, transporters will only be permitted to use the TEX message center to communicate with dealers whose vehicles are assigned to the transporter but have not completed delivery (unless a claim is filed, in which case the transporter will be permitted ongoing communication relative to the claim), and to communicate with TEX personnel. From the transporter's perspective, the TEX message center is essentially the same in appearance and function as the dealer's perspective, described in detail above.

TEX Management Application

Each primary function of the TEX Management Application (TMA) is identified in the following sections.

Browser-Based Tools

Although most of the TEX management functionality will be built as a Windows forms application, web pages will be employed for purposes of enabling TEX personnel to impersonate shippers and transporters, and to use the TEX message system. This will enable TEX customer support personnel, at any time, to act on behalf of a member who is having difficulty using TEX or has questions concerning using a particular TEX function.

TEX personnel will first login to TEX using their web browser, in a manner similar to shippers and transporters. See FIG. 82.

Once logged in, the Impersonate TEX User page appears. See FIG. 83.

A shipper or transporter is selected by clicking on the desired name, and then clicking on the Login as TEX User button. Thereafter, the TEX web session will proceed as if the specified TEX shipper or transporter has logged into TEX.

Using a pull-down menu, a logged in TEX user may also access the TEX Message Center. See FIG. 84.

The message center will operate in the same manner as described above with respect to the dealer and transporter portals. Incoming messages will include alerts, including those relating to exception reporting, such as delays in vehicle delivery, and loads which have not been accepted by a transporter after a predetermined time period. The message center will also enable TEX personnel to send and receive messages to individual transporters and dealers. Moreover, the address book available to TEX personnel will also have entries for “all dealers”, “all transporters”, and “all users” to enable more global message transmission, such as for the dissemination of important user news.

Feedback Review and Deletion

Finally, logged-in TEX personnel may use their browser to view feedback histories for dealers and transporters, as well as dealer performance summaries. Through a selection page, TEX personnel may select an individual dealer, and individual transporter, or may choose to view the most recent feedback entries posted on TEX, regardless of the target of the feedback. A delete button will enable TEX personnel to remove any feedback deemed inappropriate.

Windows Forms-Based Tools

The remainder of the TEX Management Application will be implemented as a Windows forms application. The application will be a Multiple Document Interface (MDI) application. A top menu will allow the user to select the various forms, identified below, to be displayed within the overall application window. The TMA will access and modify the same SQL Server database as the web-based portals.

Upon launching the application, TEX personnel will first select the login function from the main menu. A login form will appear, permitting TEX personnel to authenticate in the TMA using the same usemame and password as in the web application.

Broker User Management

The Broker User Management form enables TEX personnel to view, edit, activate and deactivate dealer and transporter users, and their associated profiles, preferences, etc. See FIG. 85.

The User Management form permits the user to select all users for selection, or display only shippers (dealers) or transporters. The displayed list of users can also be filtered by whether or not the user has been activated by TEX. Next, an individual TEX user is selected by clicking on the user's name in the Users list box. This populated the User Profiles and Preferences data grid with all of the relevant data for the selected TEX user. The user may be activated, deactivated, or deleted by clicking on an appropriate button below the grid. The grid data will be editable, and clicking on Update User Info will save any changes made to the database.

New user creation will not be supported by the TMA application. Instead, TEX personnel may create a new shipper or transporter user via the dealer or transporter portal, respectively.

Dealer QuickShip, Dealer Detailed, and Broker Shipment Cost Estimator Configuration

The TMA will include a form to enable TEX personnel to configure the dealer QuickShip, the dealer detailed, and the TEX-internal shipment cost estimators. Cost estimation will be based upon rate sheets of selected transporters, the distance to be traveled, whether pick-up and/or delivery locations are in convenient, well-serviced locations, the types of vehicles being transported, the type of carrier required to be used (i.e., covered or open), and other factors. More details concerning the estimation formulas and associated data, the types of configuration required, and how separate estimates are to be calculated by QuickShip, dealer detailed and TEX-internal calculators, are still to be determined.

Broker TEX Dashboard

The Broker TEX dashboard, shown below, will show a snapshot of overall TEX activity. See FIG. 86.

Broker Find Vehicles, Advanced Vehicle Search, and Posting of Loads

The TMA will enable TEX personnel to review the vehicles that have been posted for transport, to do detailed searches for such vehicles, and to group these vehicles into a load that is posted for acceptance or negotiation with transporters.

The Broker Vehicles Awaiting Transport Form is Shown in FIG. 87.

This form will initially display all vehicles awaiting transport, organized by dealer posting, in a scrollable, non-pageable grid. Vehicles are selected for shipment by clicking on their associated checkbox. The vehicles may be filtered on the form by destination city/state, or by shipper name. Clicking on the Estimate button will invoke the fee calculation estimator, and will display, in a separate form, an estimated transporter fee for the selected vehicles. Clicking on the Get Transport button will display to the Broker Post Transport Request form. Clicking on the Advanced Search button will display the Broker Vehicles Awaiting Transport Advanced Search form. See FIG. 88.

This form will enable the user to search for a vehicle by pick-up location, delivery location, date of dealer posting, and vehicle make/model. Clicking on the Search button will load the Broker Vehicles Awaiting Transport Page, populated with the search results.

Posting of the vehicles selecting for transport is a multi-step process. The first step form is shown in FIG. 89.

This form will initially be populated with date from the dealer's posting of the selected vehicles, including a summary of the vehicles themselves, pick-up location(s), delivery location(s), pick-up date, and desired delivery date. TEX personnel may add additional vehicles, and can set the transport requirements, including a required carrier type, and whether the transporter must ship all of the vehicles together. Clicking on the Next button loads the step 2 form. See FIG. 90.

This form will display the selected transport details (and permit them to be changed), to set when the posting to transporters becomes active, its expiration date, and it's posting price. Clicking on the Calculate Market Price button will load an estimator form to calculate the price at which the load is to be offered, and enter that price into the Posting Price field. Alternatively, a posting price, if known, may be manually entered. The user next sets the posting availability to transporters, with a different potential posting delay, based upon the overall quality rating of the transporter. Any additional comments entered will be displayed to transporters as part of the posting details.

Although not shown in the example form above, TEX may develop relationships with preferred transport partners, where TEX will directly assign a posted load to a particular transporter at an agreed-upon rate. The post vehicle forms will include a dropdown list of transporters having a preferred status, permitting TEX personnel to select a transporter for direct assignment of the load. In such cases, the posted load will not go out for bidding, but will proceed immediately to the contracted status with the selected preferred transporter.

Although a Save for later button is shown in FIG. 90, TEX need not support the saving of partial posting requests. Clicking on the Continue button will complete the posting process. The Find Transport Status form will load, displaying the most recently-added posting as the top entry.

Broker Monitoring and Negotiation of Loads Posted for Transport. See FIG. 91.

The Broker Find Transport Status form displays all loads that have been posted for transport, in a non-pageable, scrolling data grid. A posted load can be edited by selecting the load and then clicking on the Edit button, which will load the Broker Post Transport Request form, with data pre-populated to match the current load information. A posted can be deleted by selecting the load and then clicking on the Delete button.

The displayed loads can be filtered by status (accepted, declined, countered, pending, expired) or by date (last 30, 60 120 or 365 days). When an offered load expires (as determined by its duration, as established as the posting process), its vehicles are returned to the “pool” of available vehicles for new transport request postings. Clicking on the Advanced Search button loads the Find Transport Status Advanced Search form. See FIG. 92.

The advanced search form permits searching by any combination of offer status, individual transport number, shipper name, pick-up and delivery locations, posted date, requested delivery date, and vehicle make/mode. Clicking on the Search button loads the Broker Find Transport Status form, with the matching records displayed in the grid.

On the Broker Find Transport Status form, clicking on the status of any particular posting will display an associated Broker Transport Bid Status Details form. See FIG. 93.

The top pane of this form identifies the current status of the specified shipment, similar to the selected entry on the Broker Find Transport Status form. The bottom pane displays the entire historical record of the negotiation process, from posting through an offer acceptance. As shown above, most of the line-items may be drilled down into by clicking on the associated status link. Examples of each of these drill-down pages are shown in FIG. 94.

Clicking on a Posted status link displays the Broker Transport Request Details form. This form displays a summary of the posting information entered by the dealer and TEX personnel, together with the associated costs and estimated delivery dates.

Clicking on a Countered status displays the Broker Review Counter Offer form. See FIG. 95.

Although not shown in the FIG. 95, this form can display summaries of both the current offer made by TEX personnel and the counter offer made by a transporter. TEX personnel may decline the counter offer, accept the counter offer, or counter the counter offer. Clicking on the Counter button will load the Submit Counter Offer form. See FIG. 96.

Although not shown in FIG. 96, this form can summarize the current offer made by TEX personnel, and the counter offer made by a transporter. TEX personnel will enter the new counter offer terms, set the attributes of the counter offer, including when it expires and whether further negotiation will be permitted. Clicking on the submit button will post the counter offer and the Broker Find Transport Status form will load, showing the counter offer as the most recent entry at the top of the grid.

Broker Monitoring of Contracted Shipments

Following the acceptance of a posted load by a transporter, the TMA will enable TEX personnel to monitor the ongoing progress of the shipment, including vehicle pick-up, inspections, deliveries, and claims. At a top level, shipments are monitored using the Broker Find Vehicles Dashboard. See FIG. 97.

This form shows shipments in a non-pageable, scrolling grid. Shipments may be filtered on the form by their status (contracted, scheduled, in transit, payment due, arrived, confirmation required, completed) or by their date (last 30, 60, 120 or 365 days). Clicking on the Advanced Search button loads an advanced search form. See FIG. 98.

This form permits searching by any combination of status, shipper name, transporter name, pick-up or delivery location, delivery date, or vehicle make/model. Clicking on the Search button loads the Broker Find Vehicles Dashboard form, with all matching transports displayed.

Note that, unlike the dealer and transporter portals, drilling down into contracted loads in order to display additional details need not be supported in TEX. If a more detailed view is required of a particular transport, TEX personnel may log in as an associated dealer or transporter in order to view transport details. TEX personnel will, however, be able to print a bill of lading for each shipment directly from the TMA application, and, when necessary, to manually post payments received from a dealer to specific shipments.

Broker Profile and Preference Setup. See FIG. 99.

The Broker Shipping and Delivery Preferences form allows TEX personnel to identify the default settings for what terms of an offer may be negotiated by transporters (such as cost, carrier type, and the quality rating of the carrier). This form also enables TEX personnel to set the broker's own minimal quality rating for transporters, which will become effective if they exceed those of a dealer posting a given vehicle. Finally, this form permits TEX personnel to assign certain member transporters a preferred status, towards potentially directly assigning vehicle loads to such transporters without offering the load to other transporters.

The Broker Notification Preferences form allows TEX personnel to identify events that occur that will trigger a notification to a TEX administrator. Notifications may be via email, SMS message, or both. Tex personnel may select the particular events which will trigger a notification message, including when a posting is accepted or countered, when a claim is submitted concerning a shipment, etc. See FIG. 100.

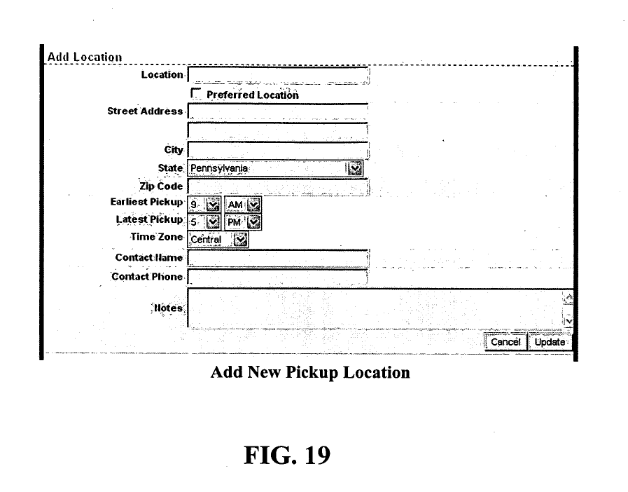

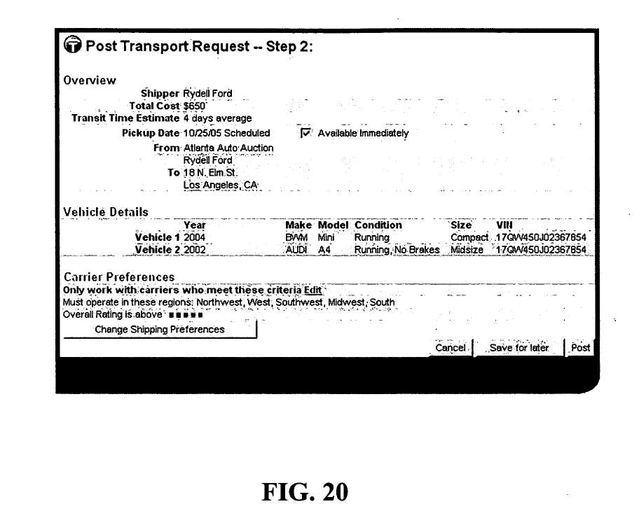

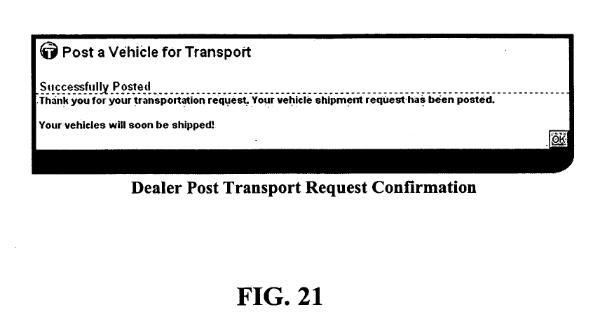

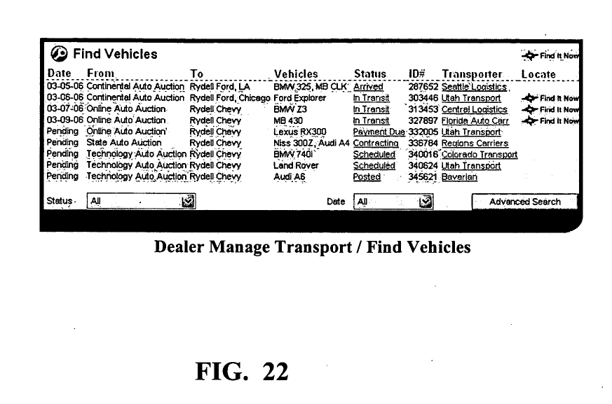

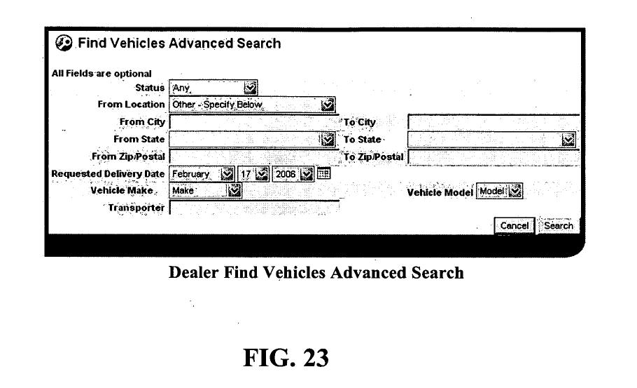

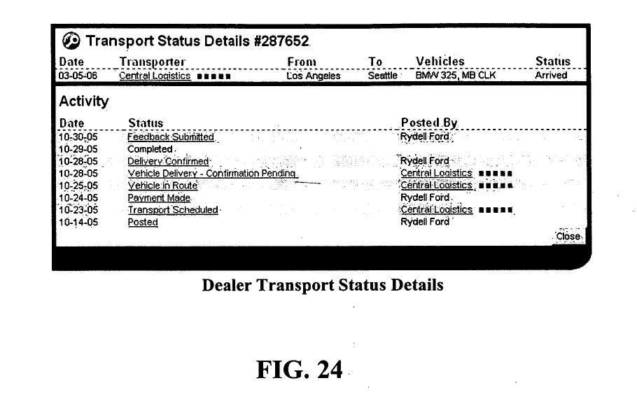

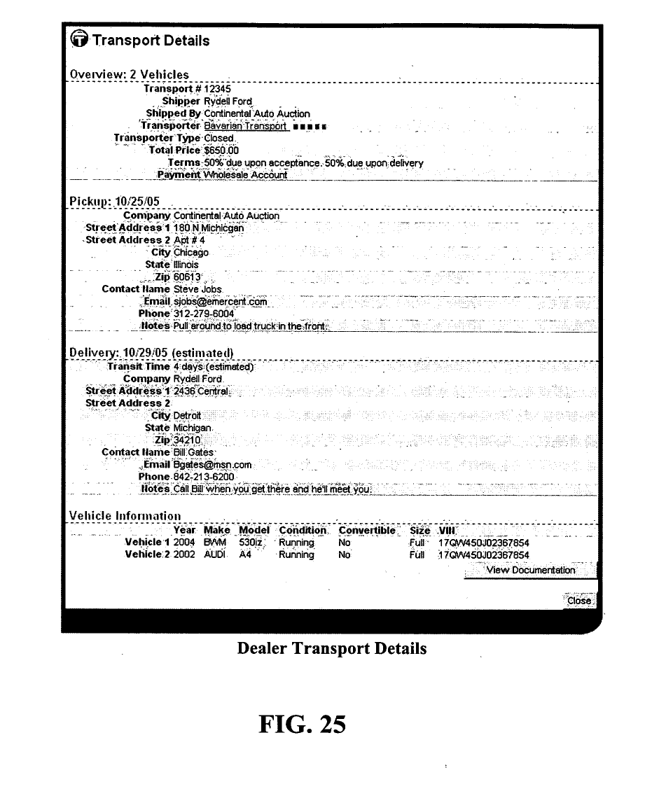

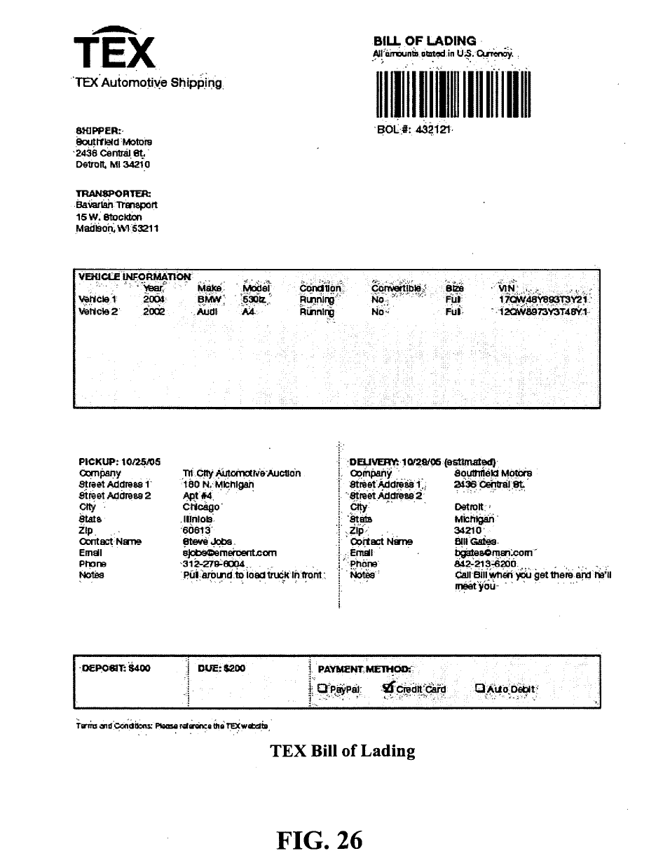

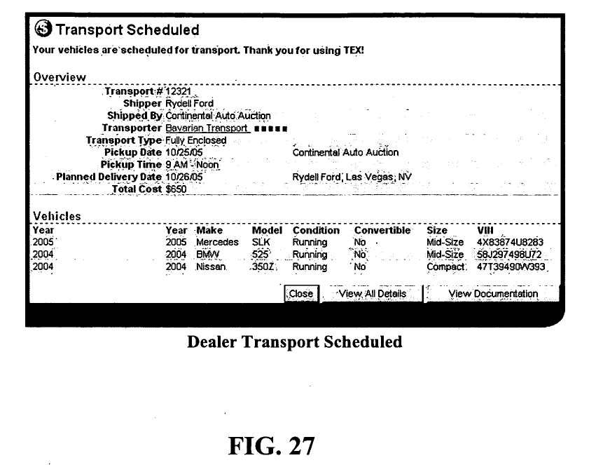

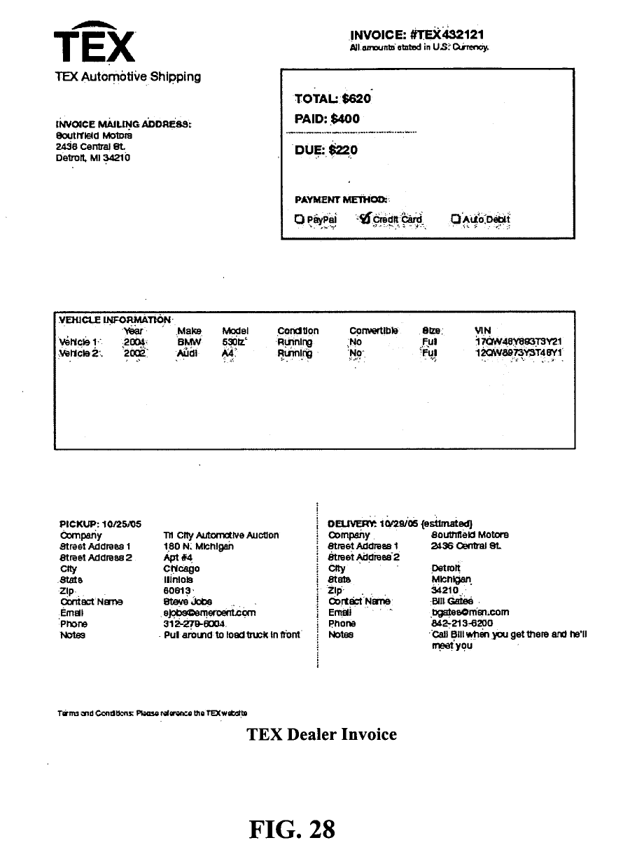

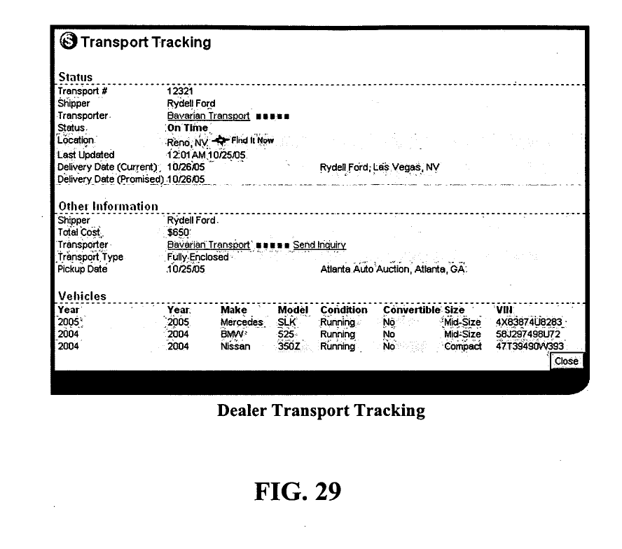

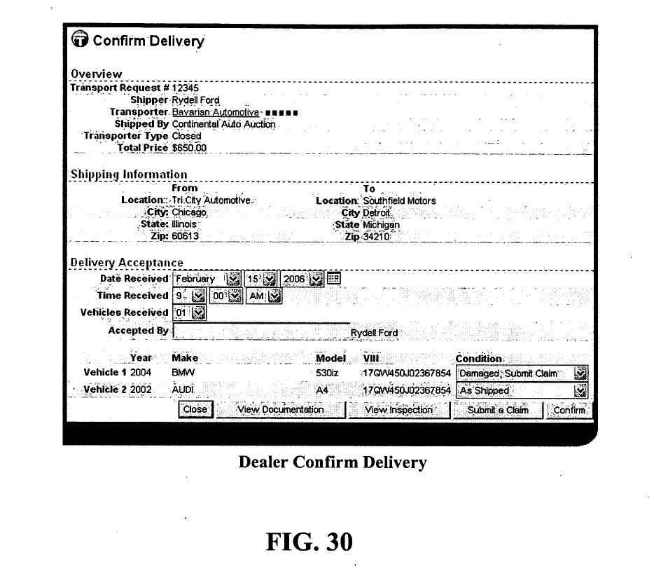

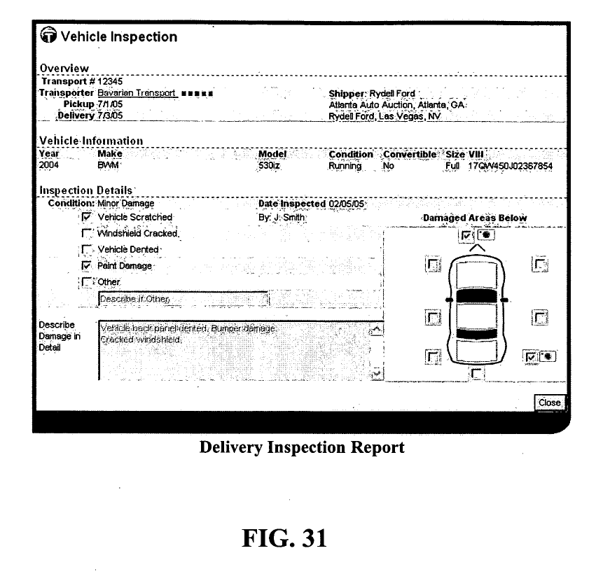

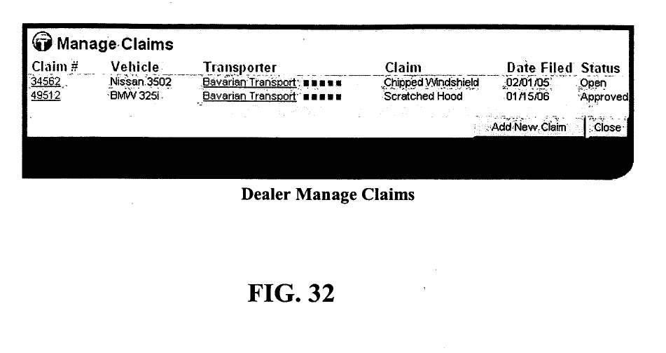

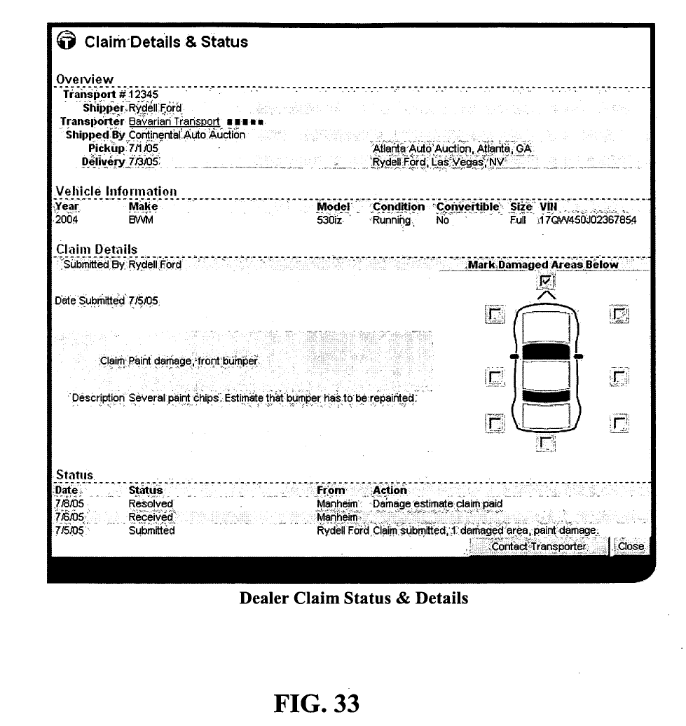

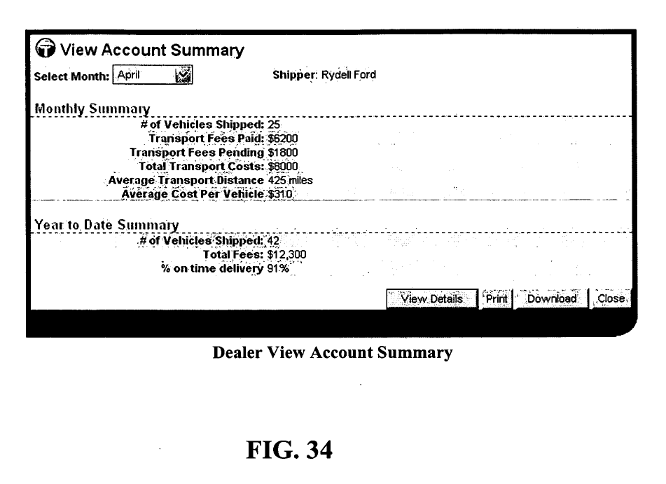

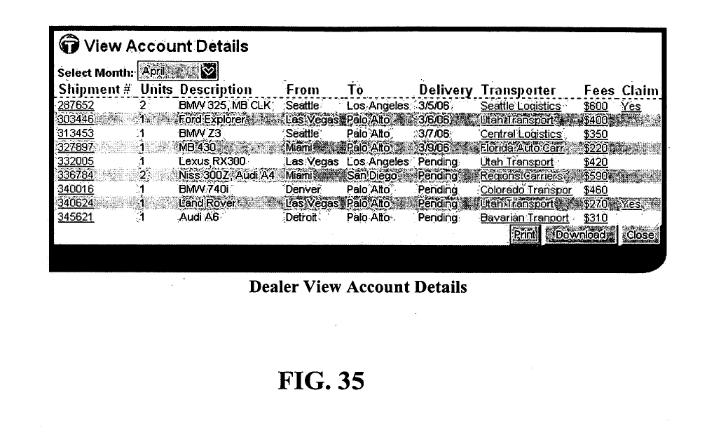

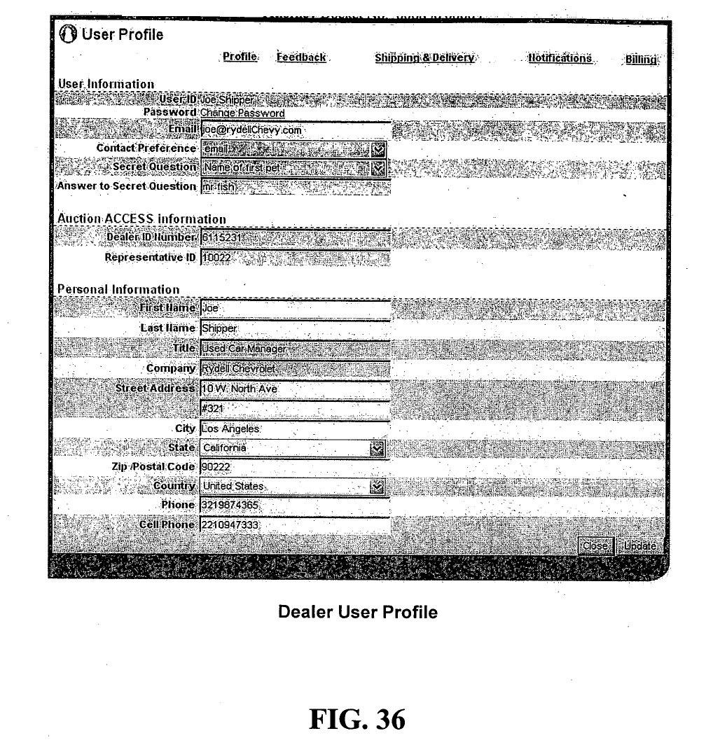

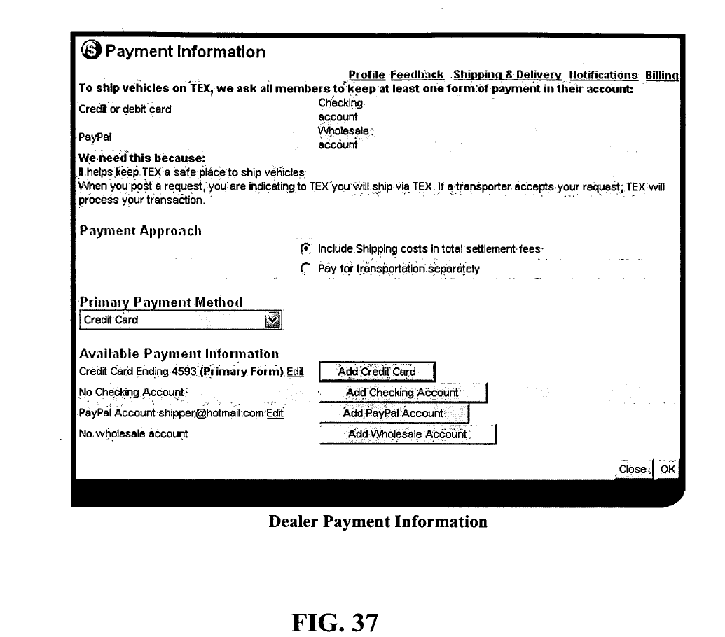

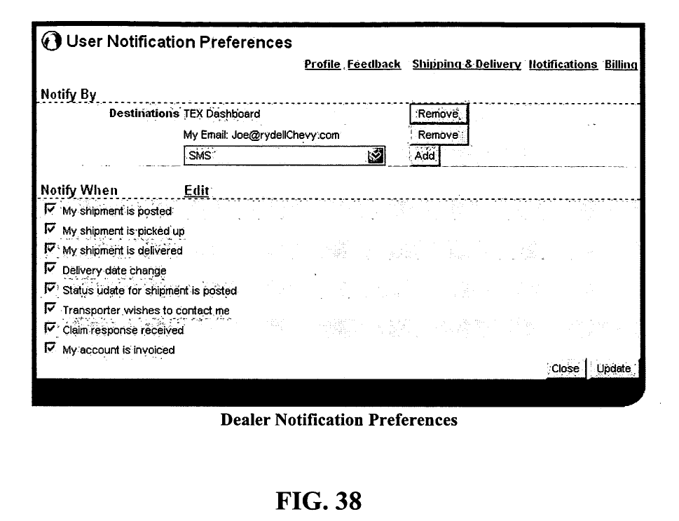

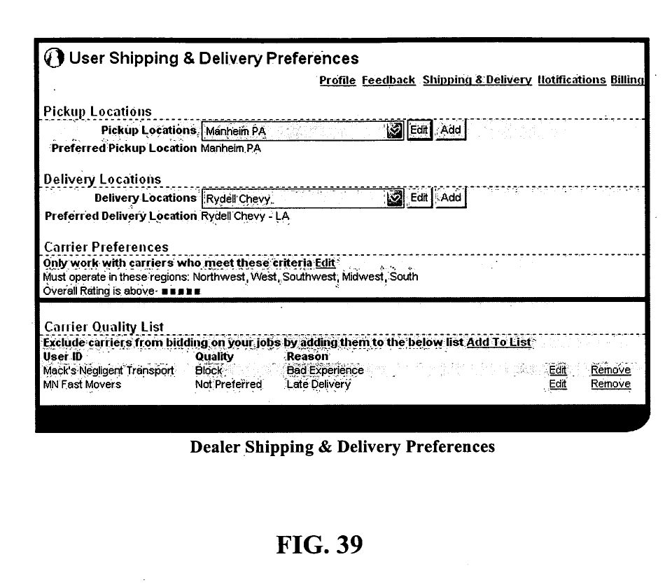

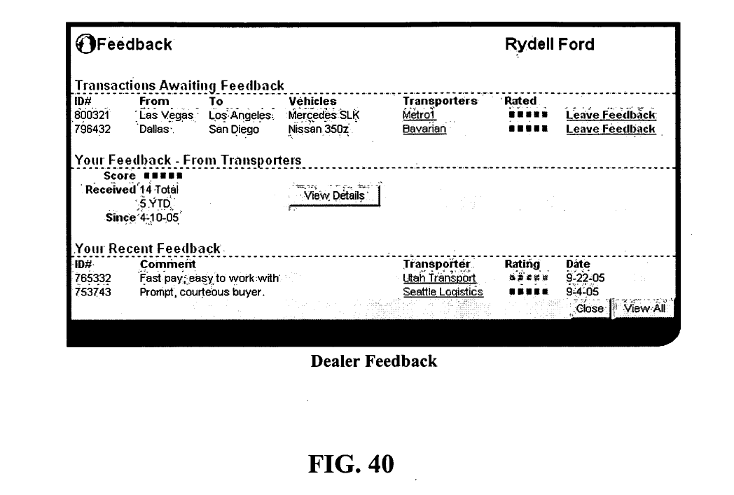

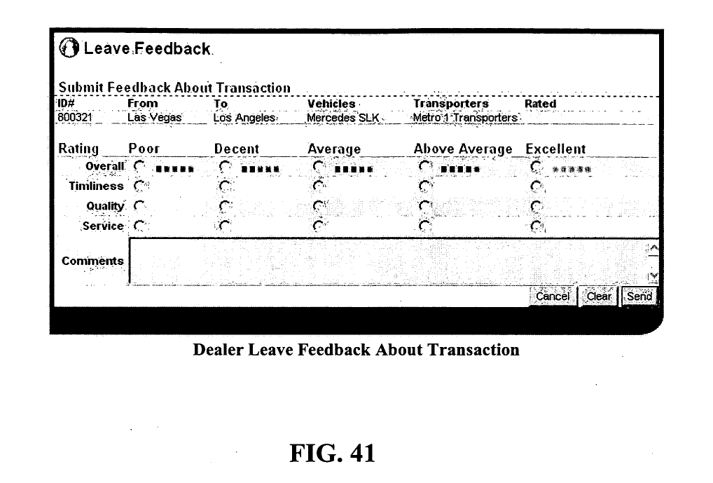

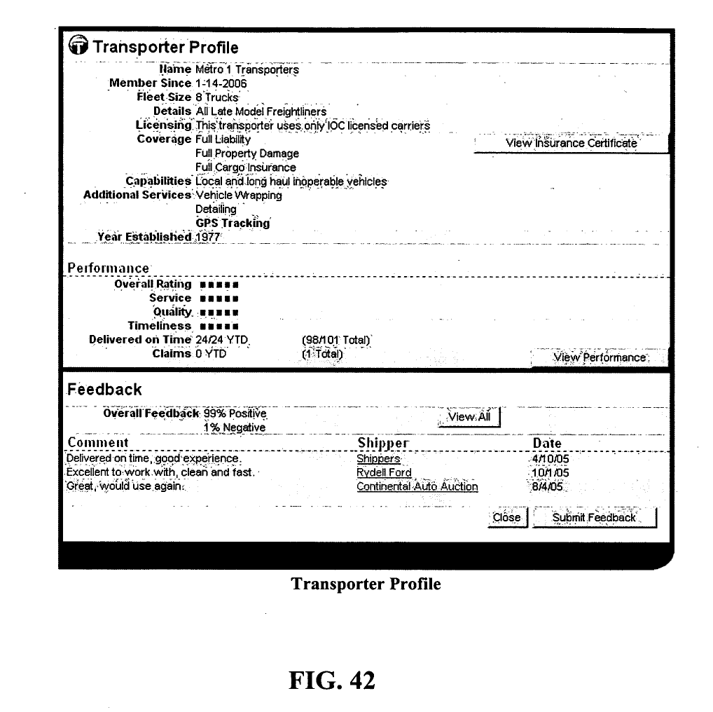

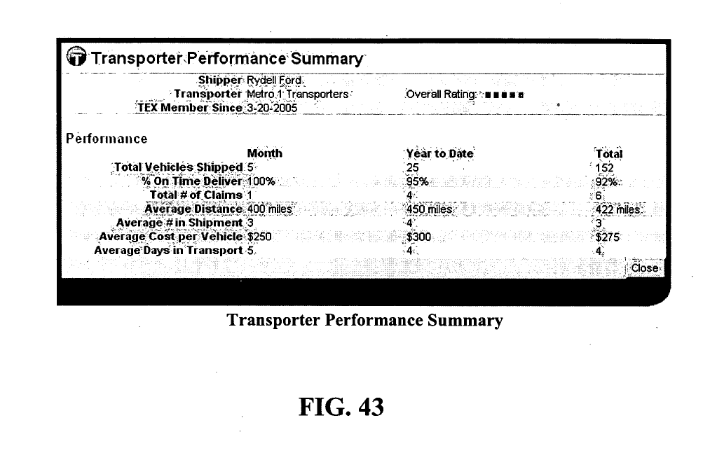

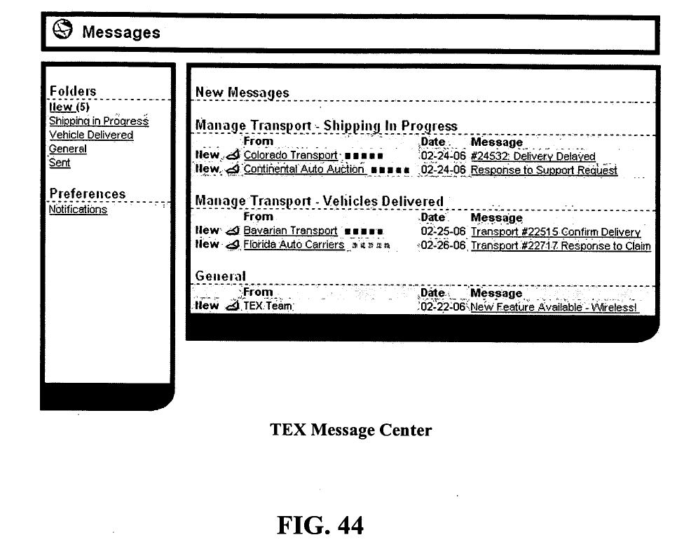

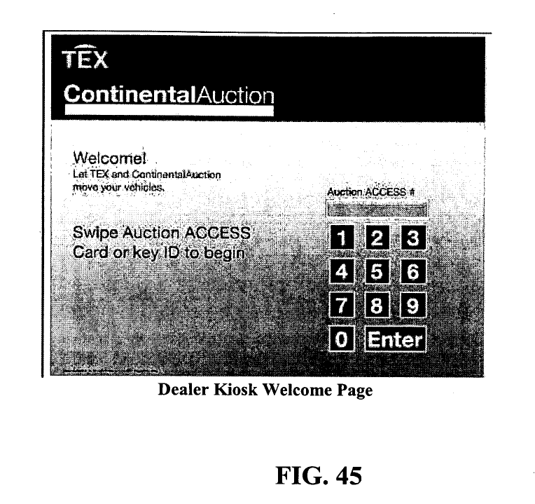

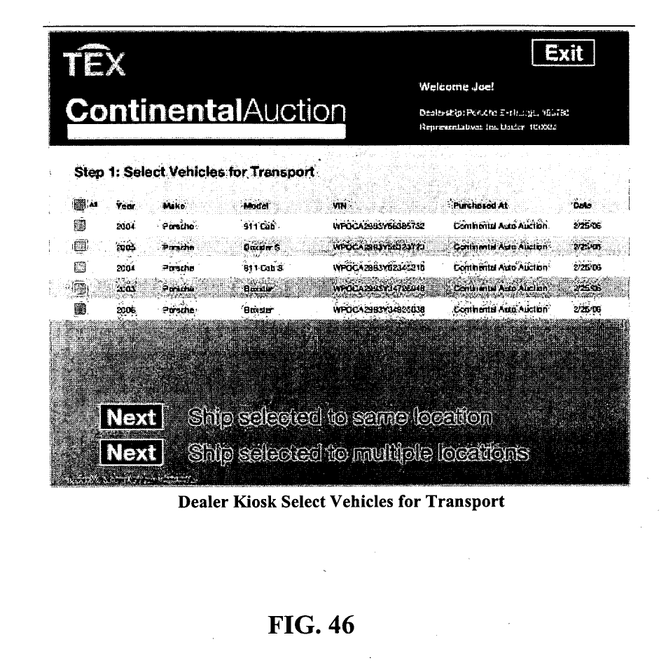

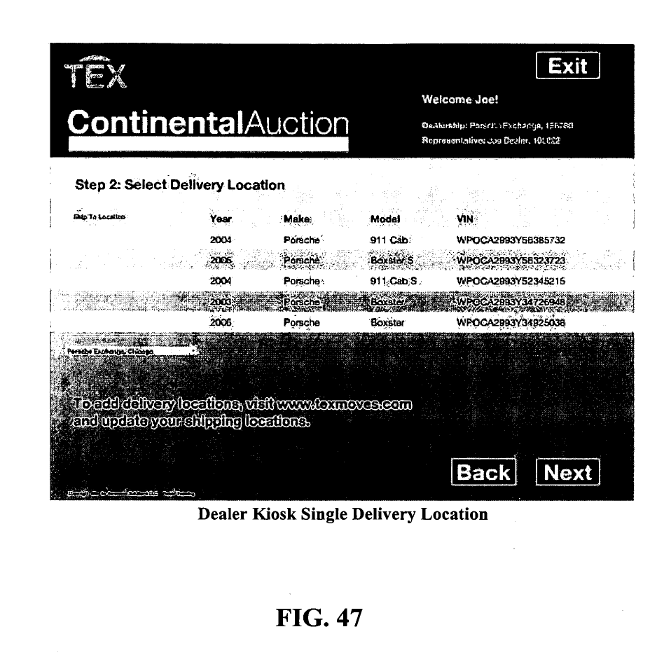

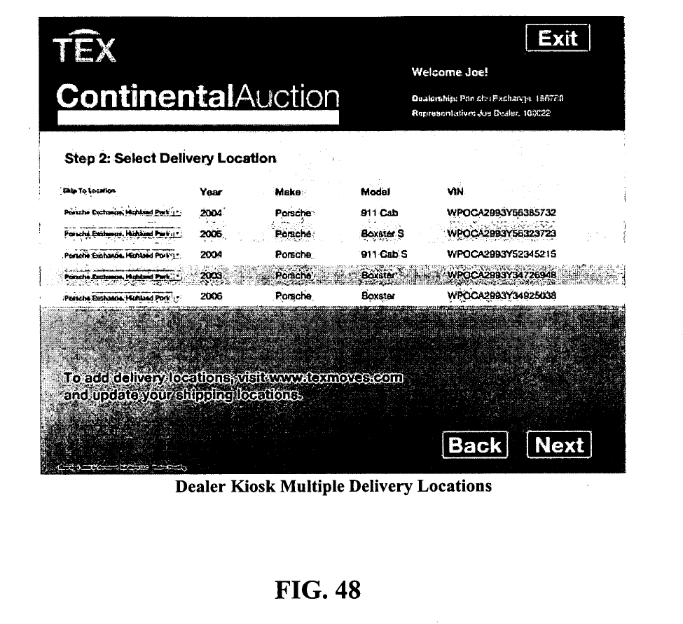

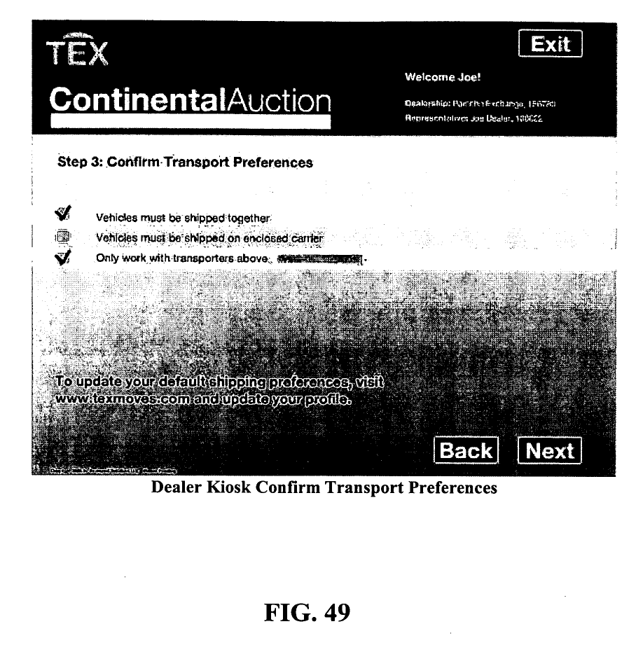

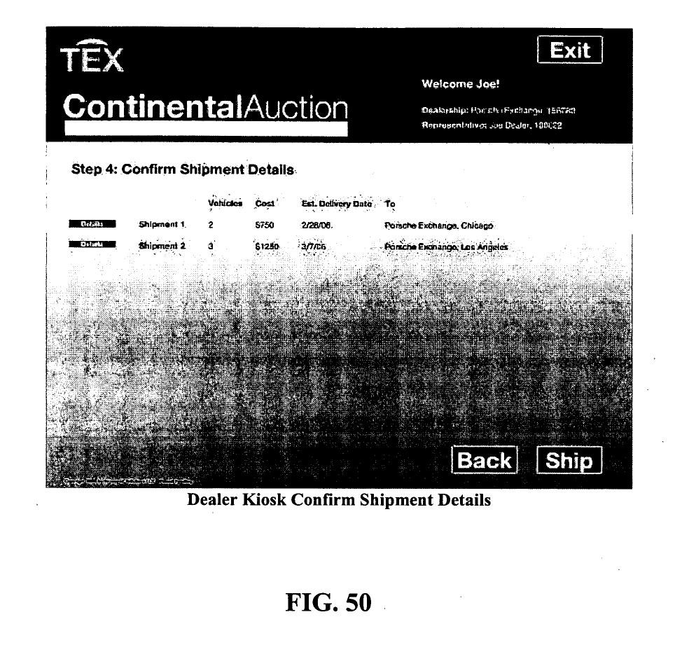

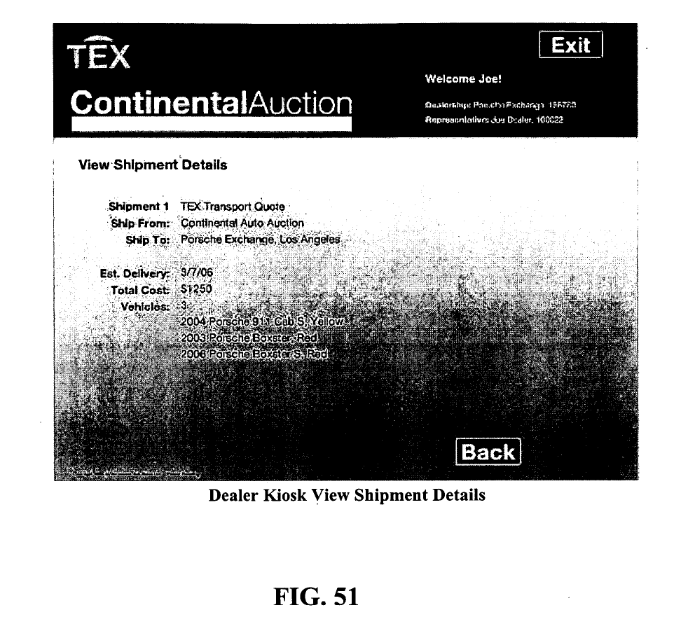

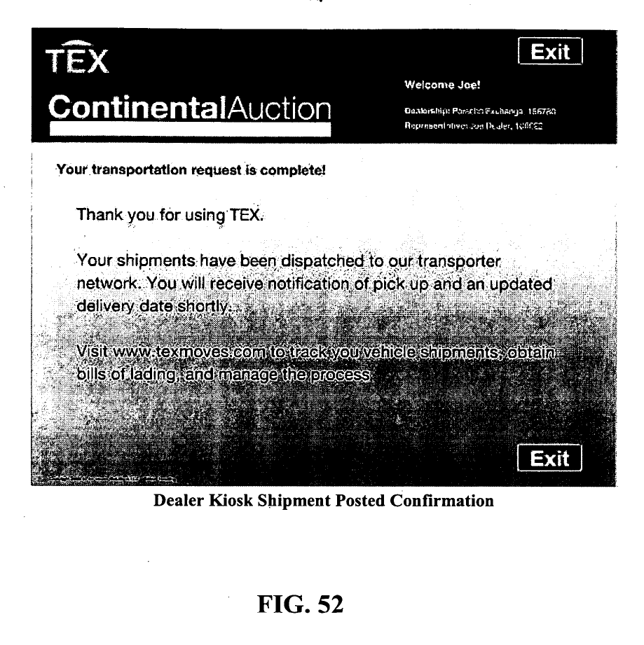

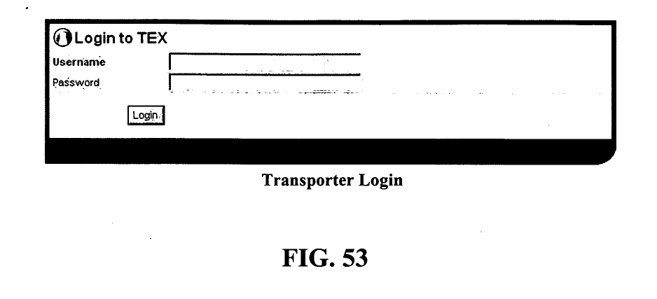

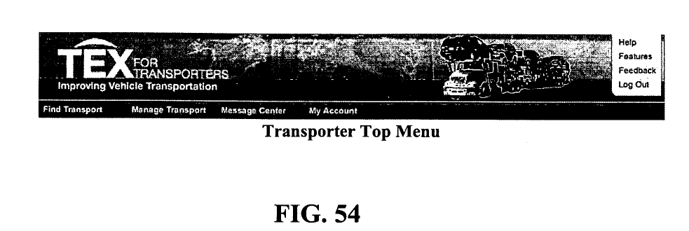

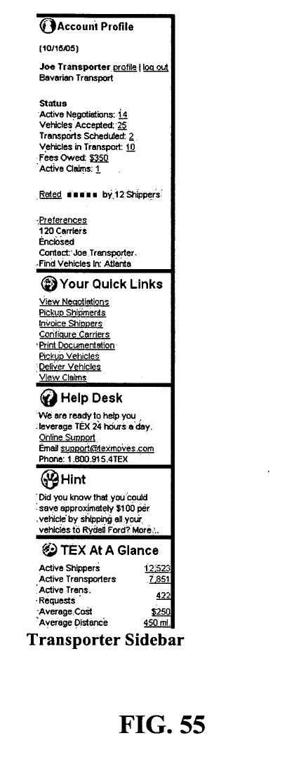

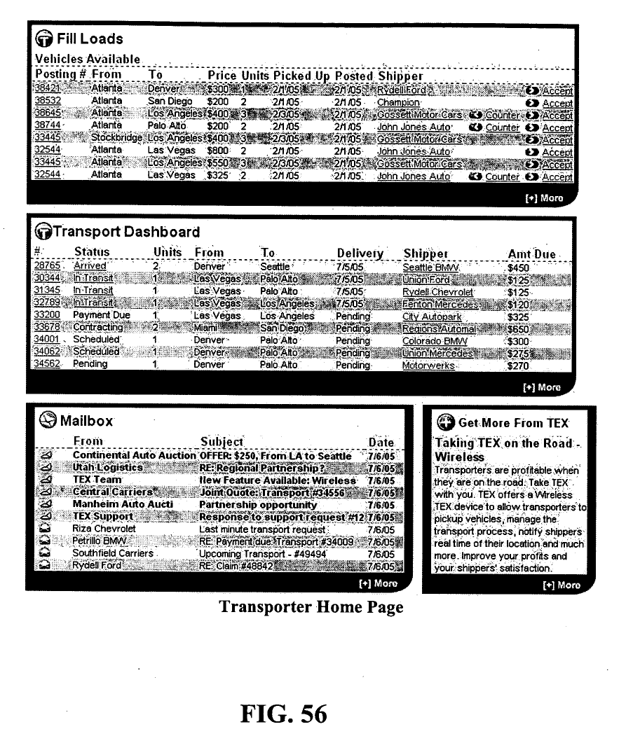

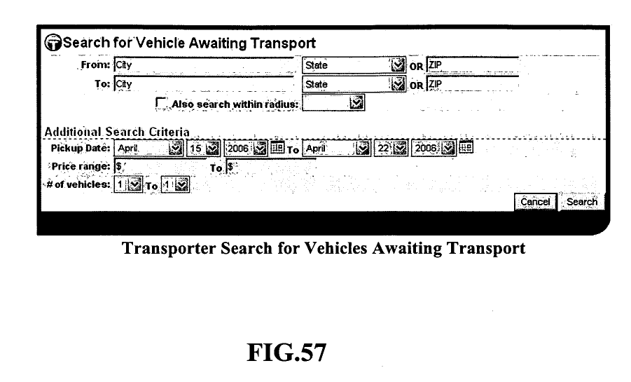

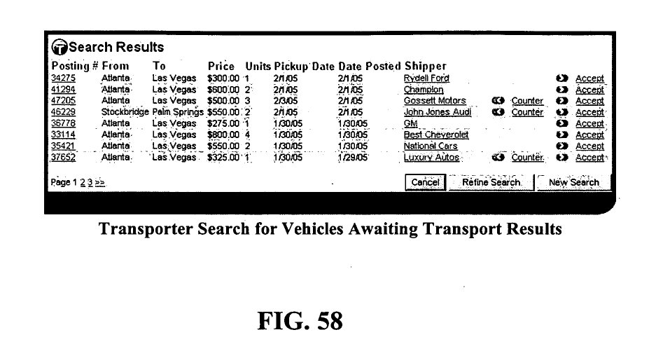

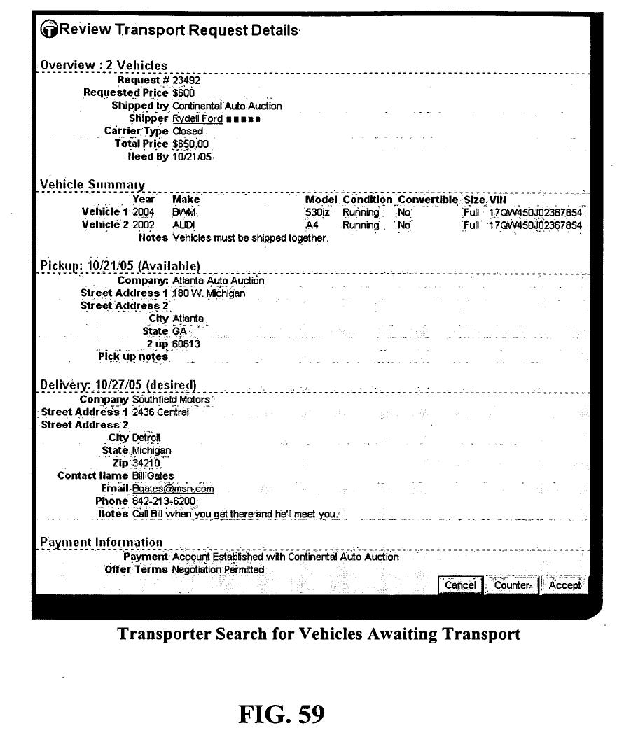

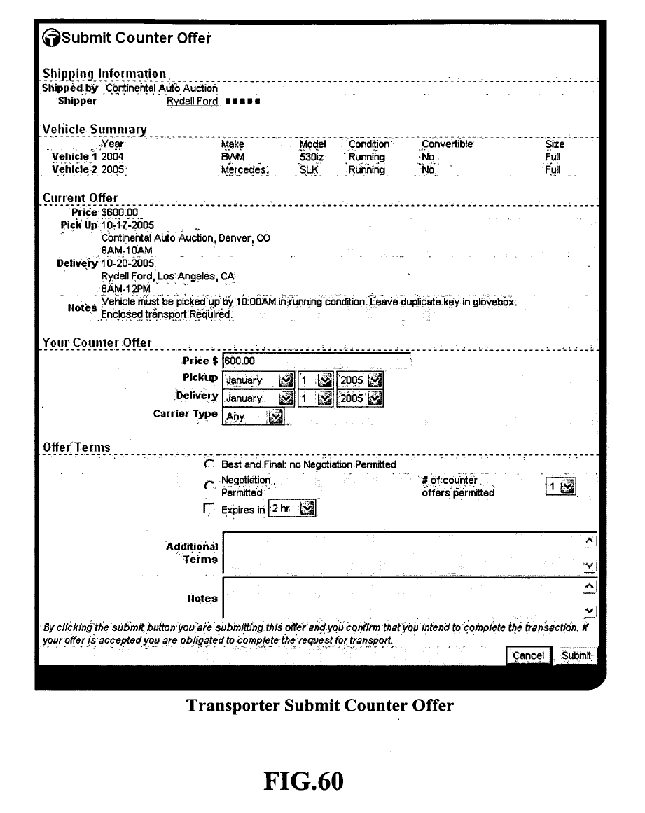

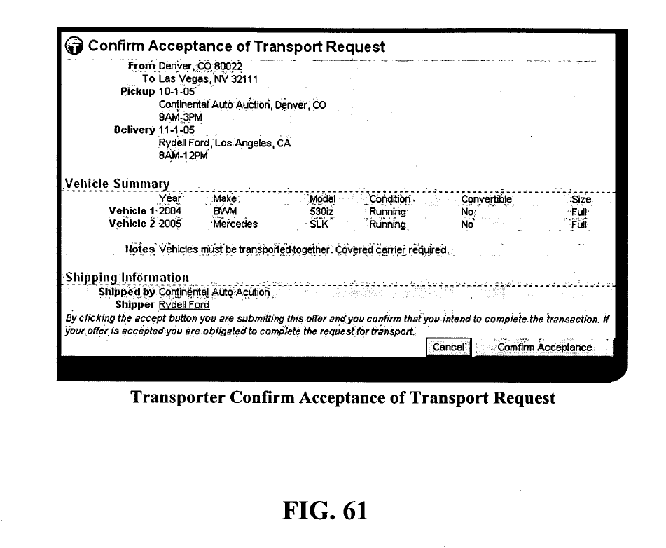

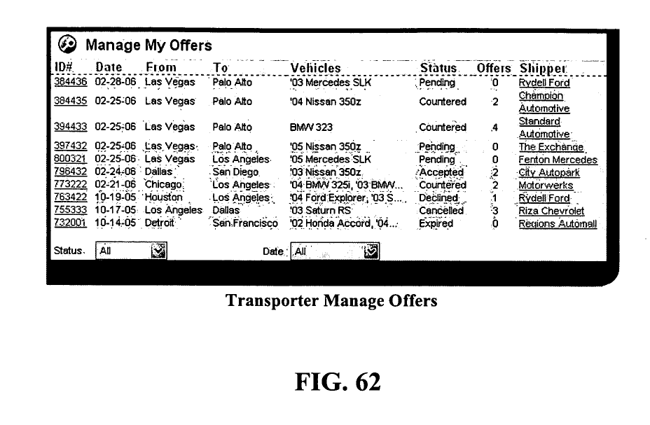

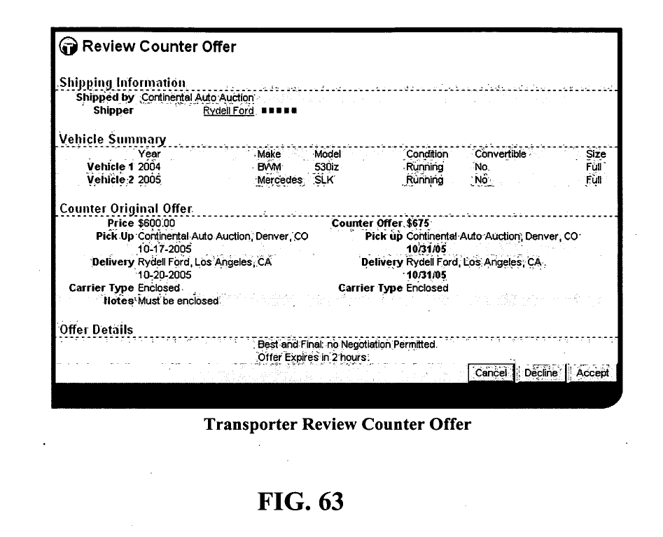

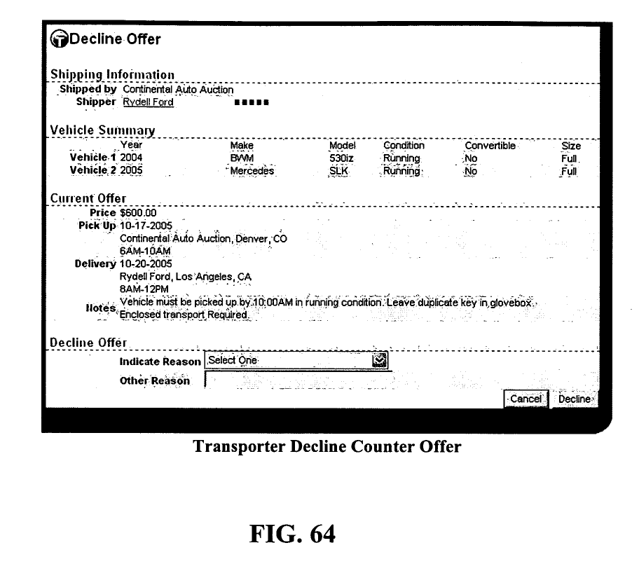

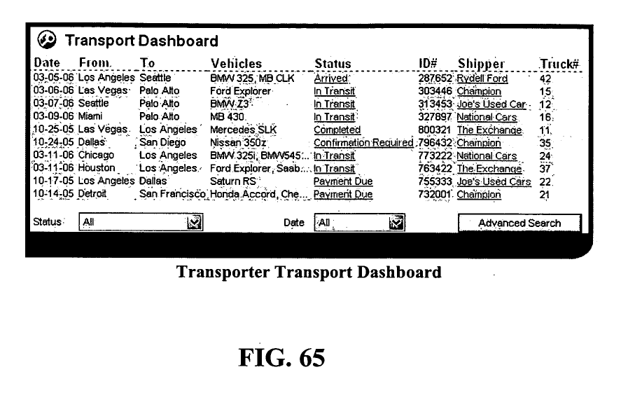

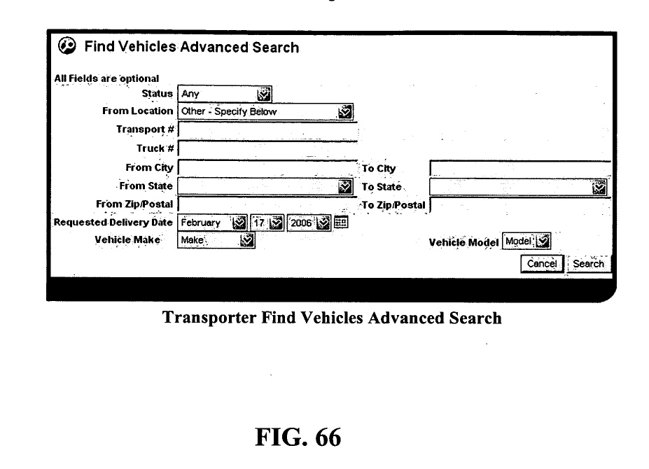

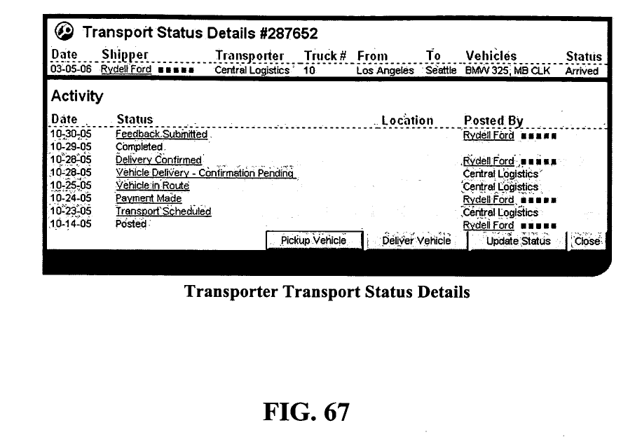

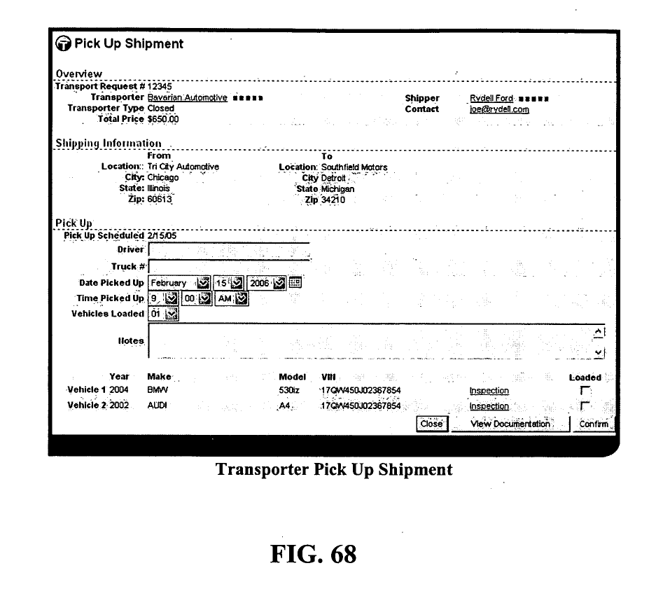

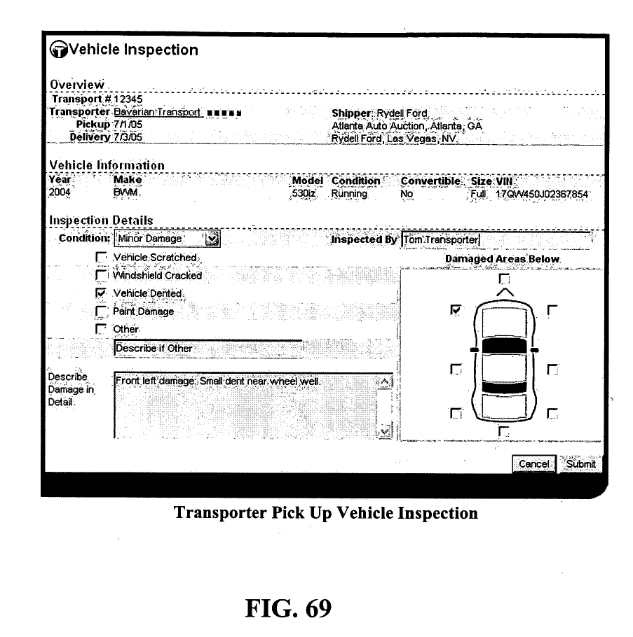

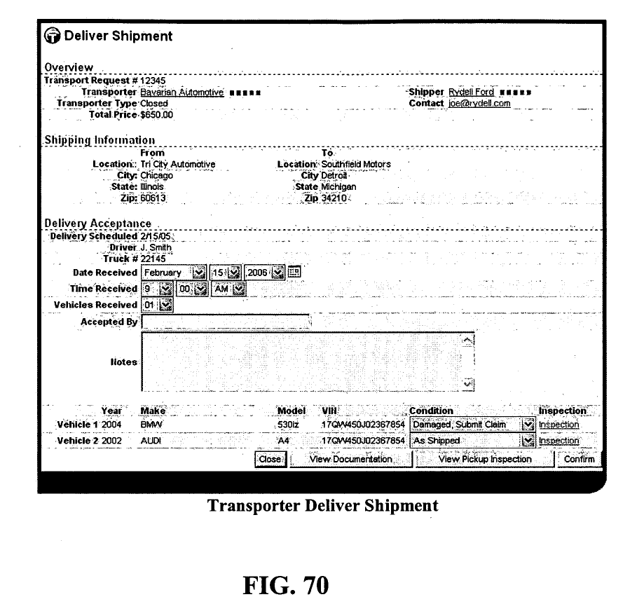

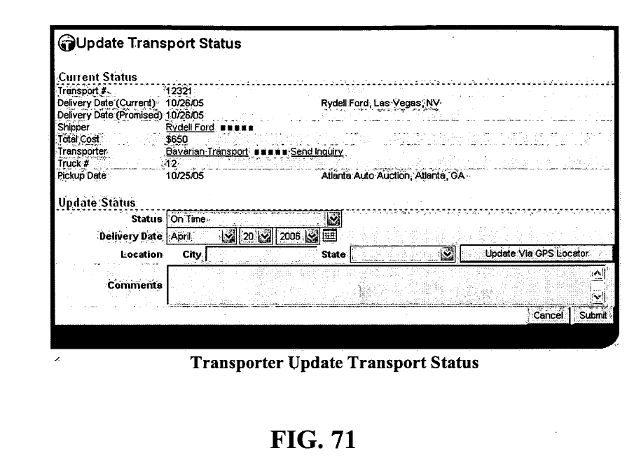

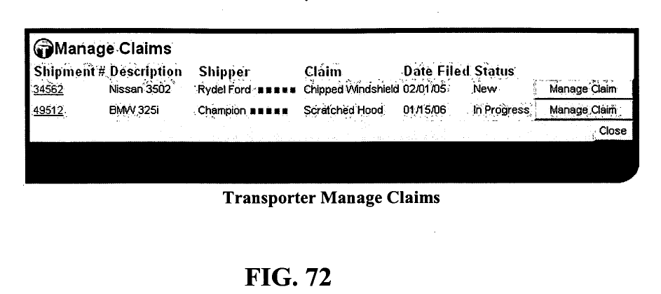

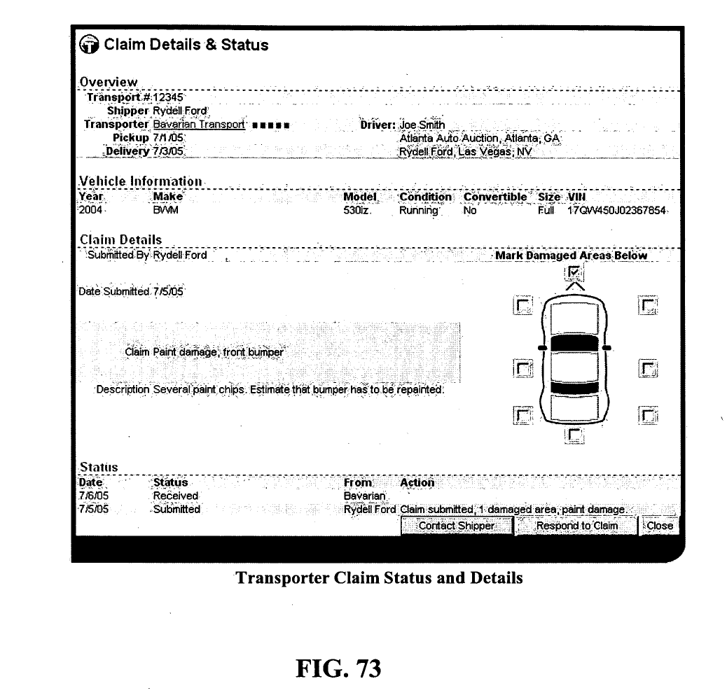

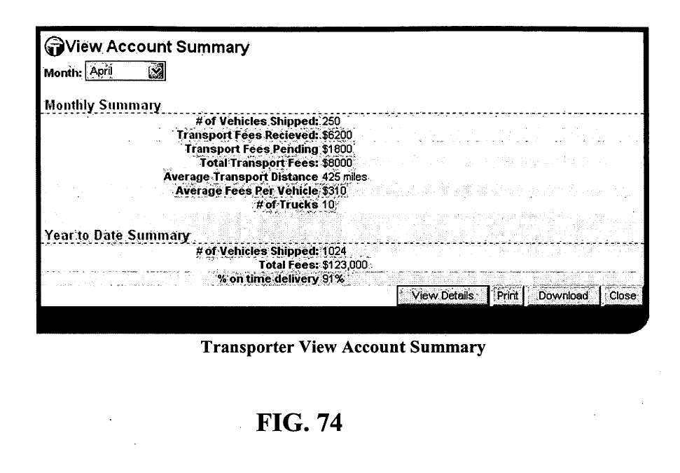

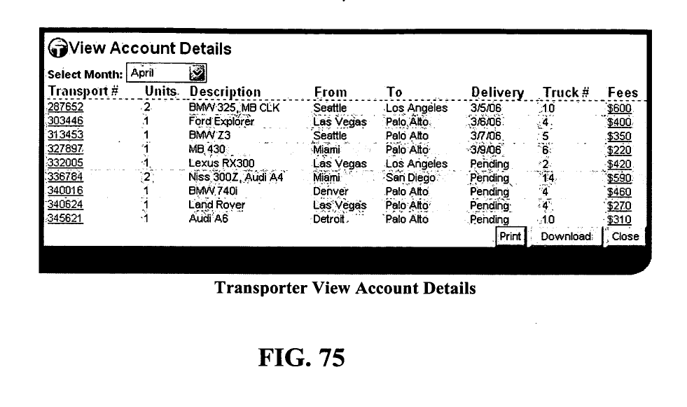

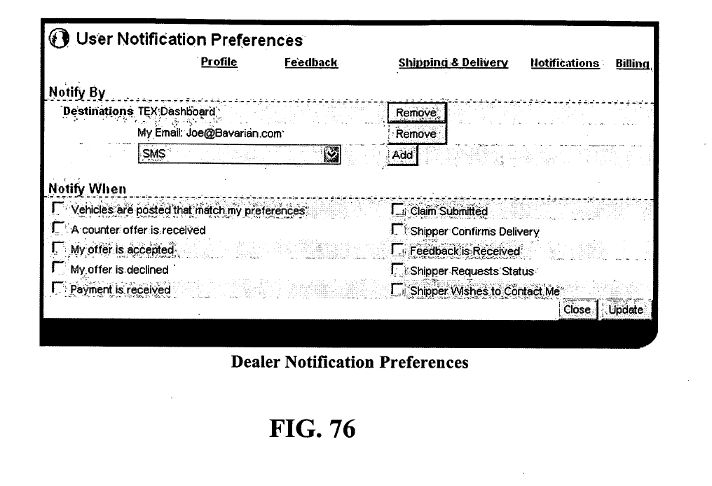

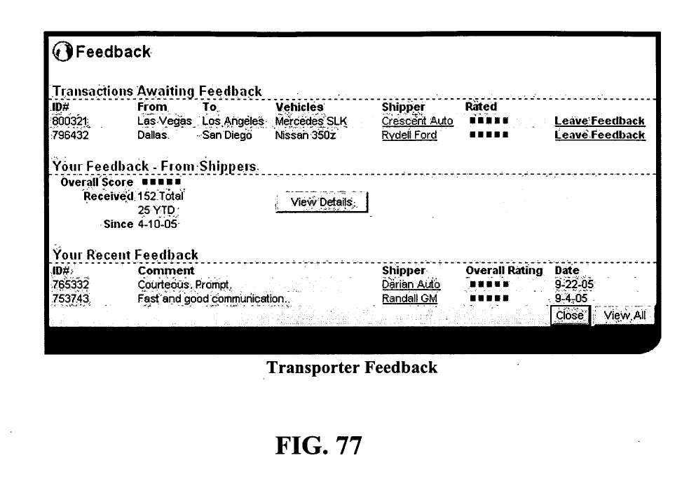

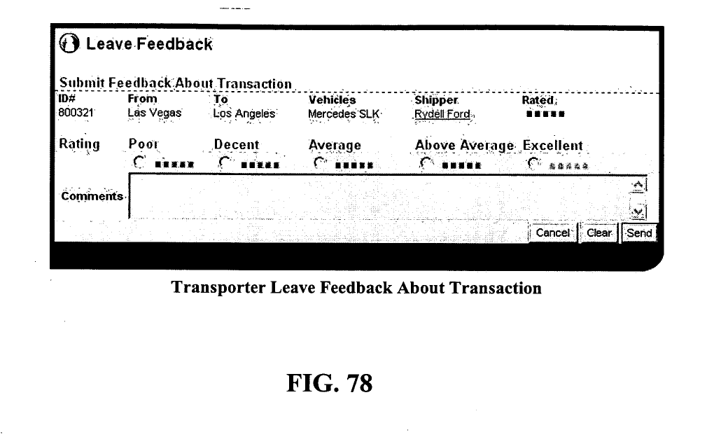

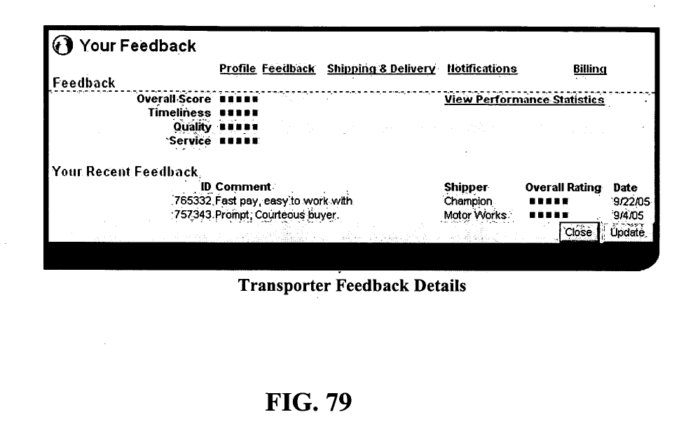

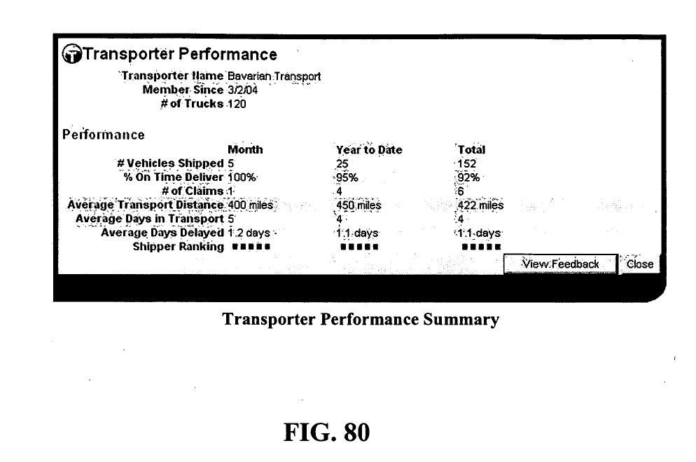

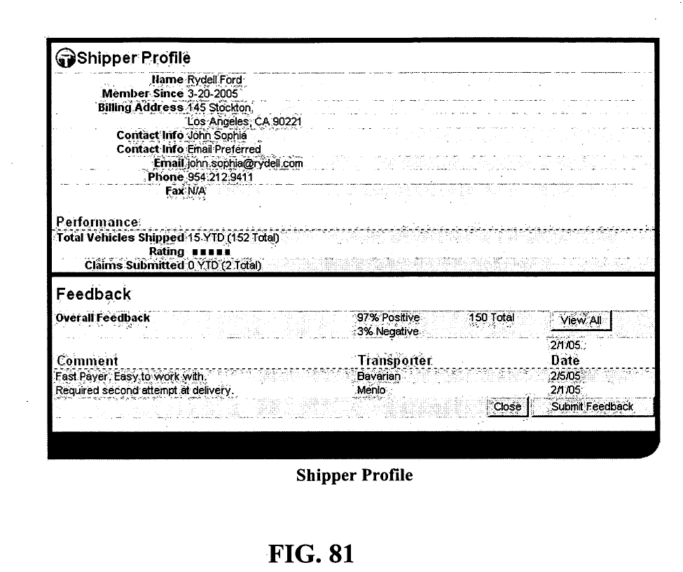

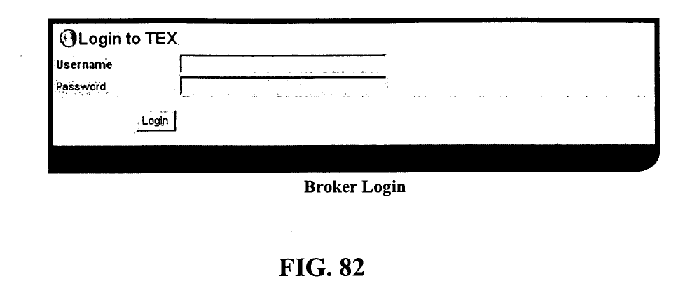

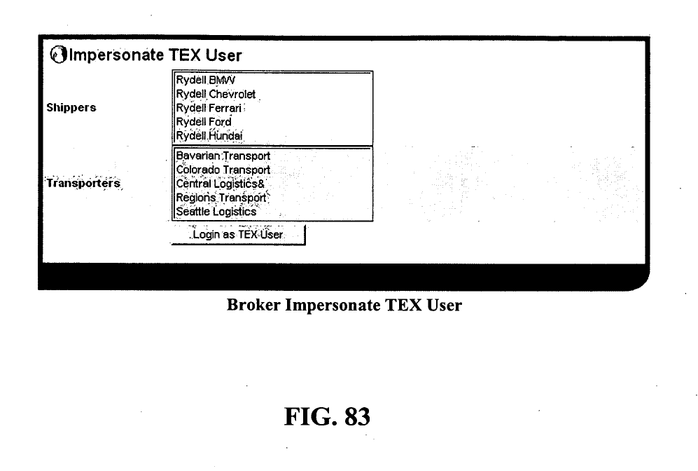

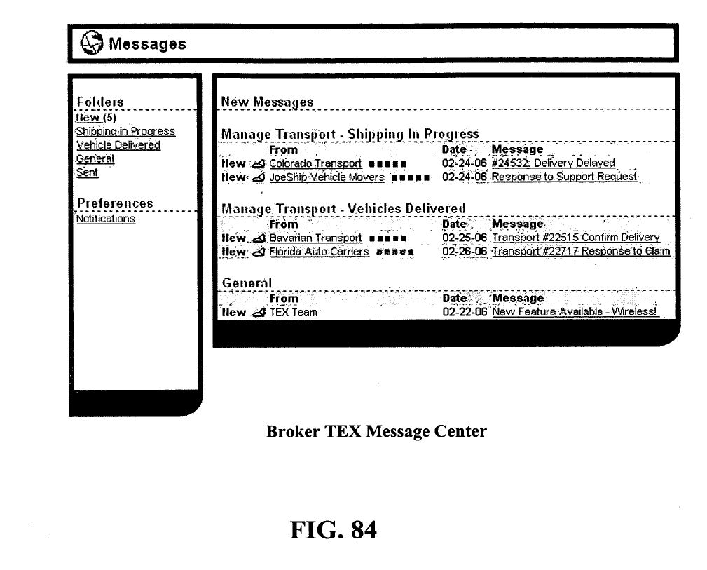

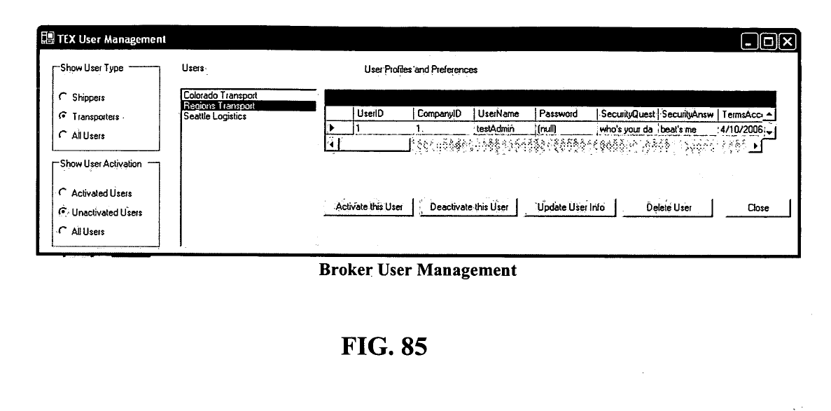

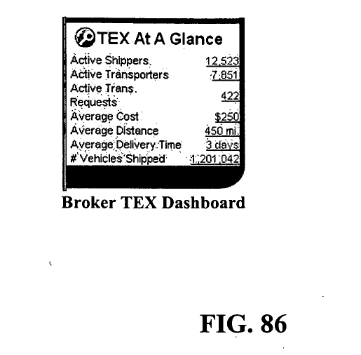

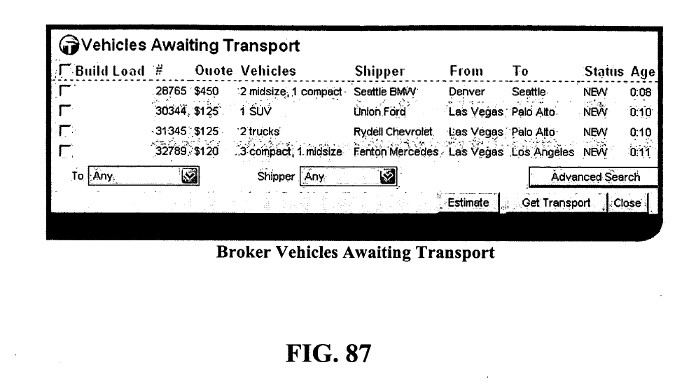

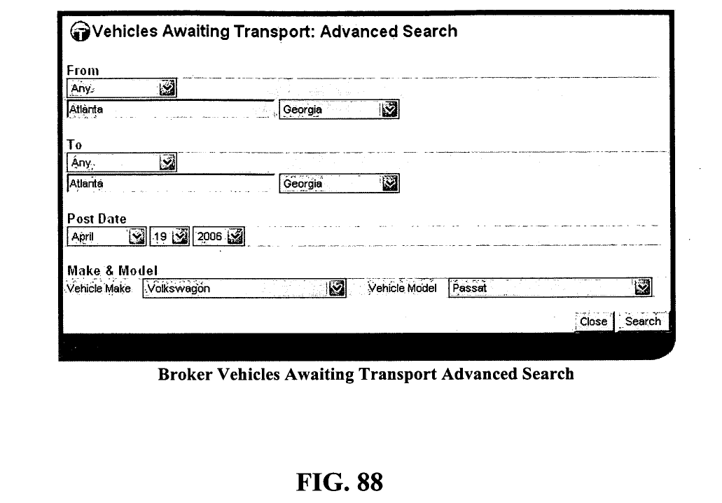

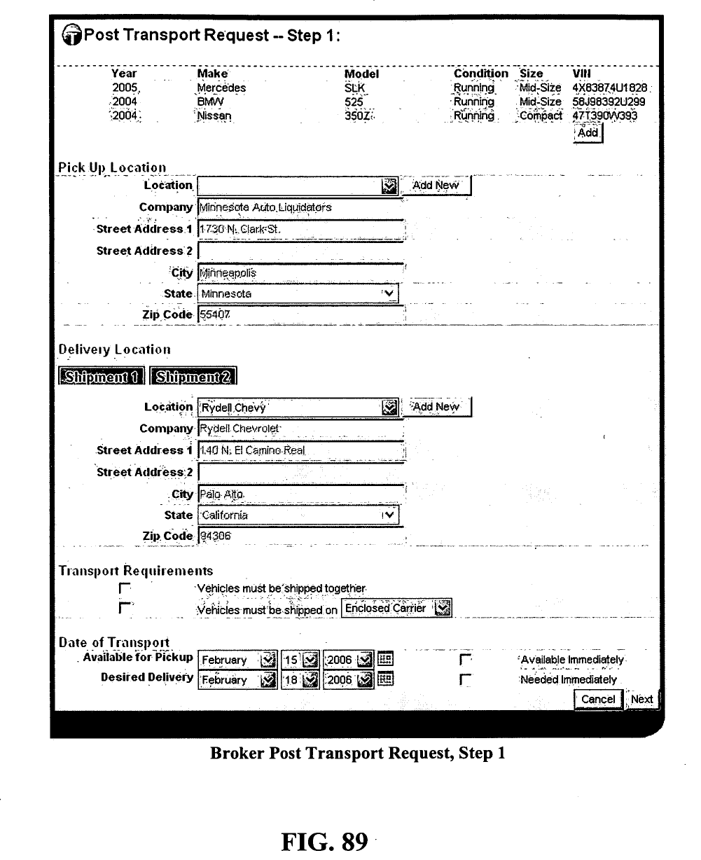

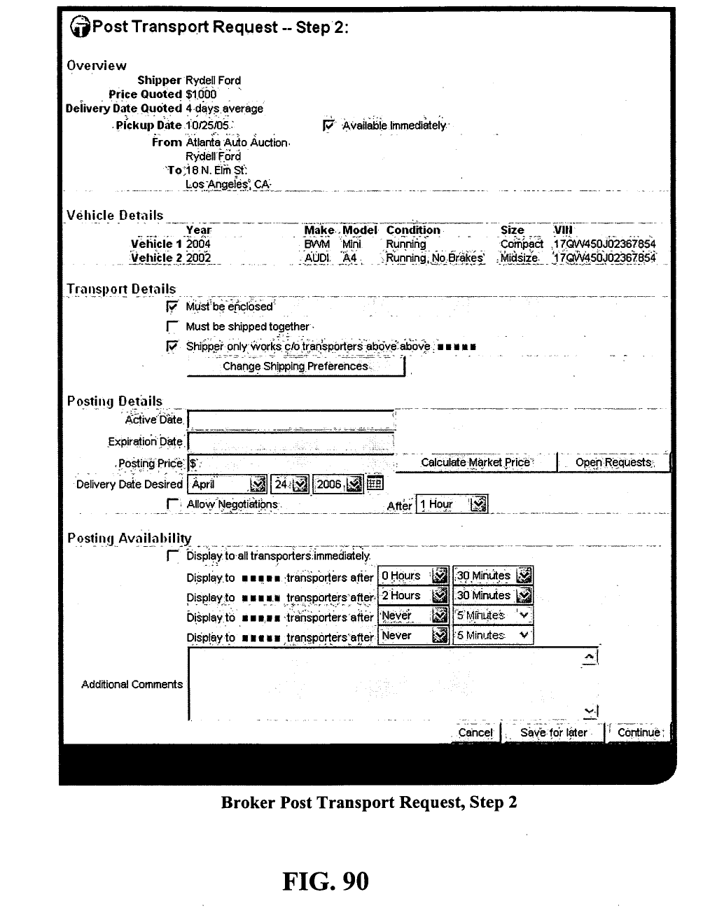

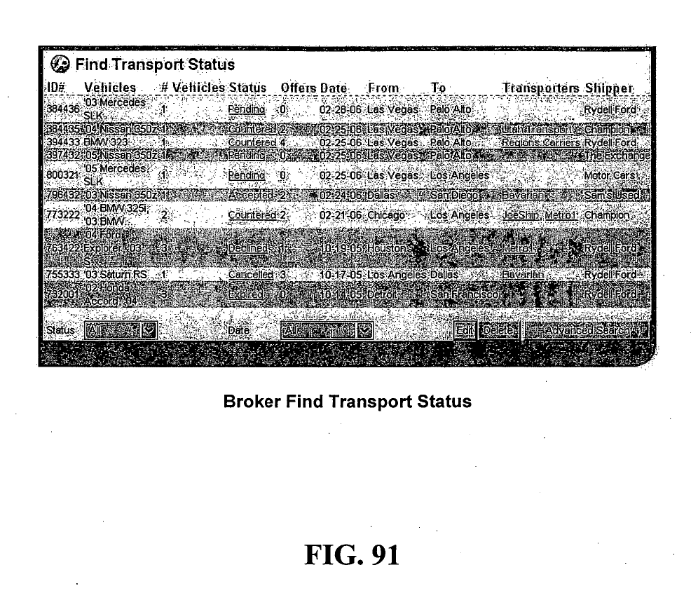

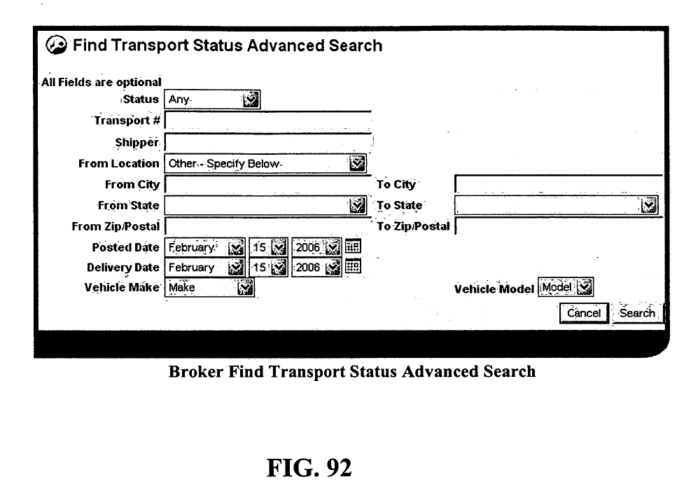

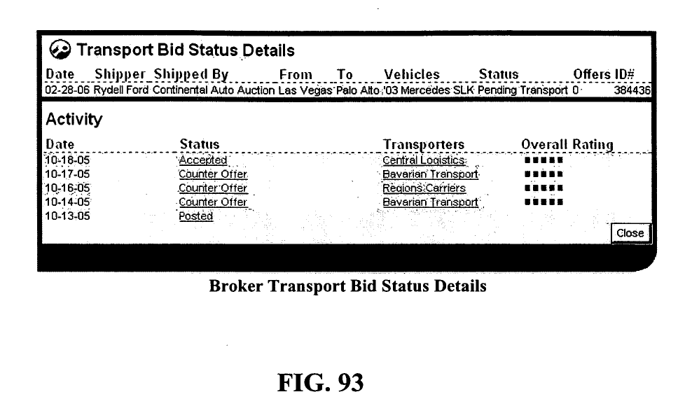

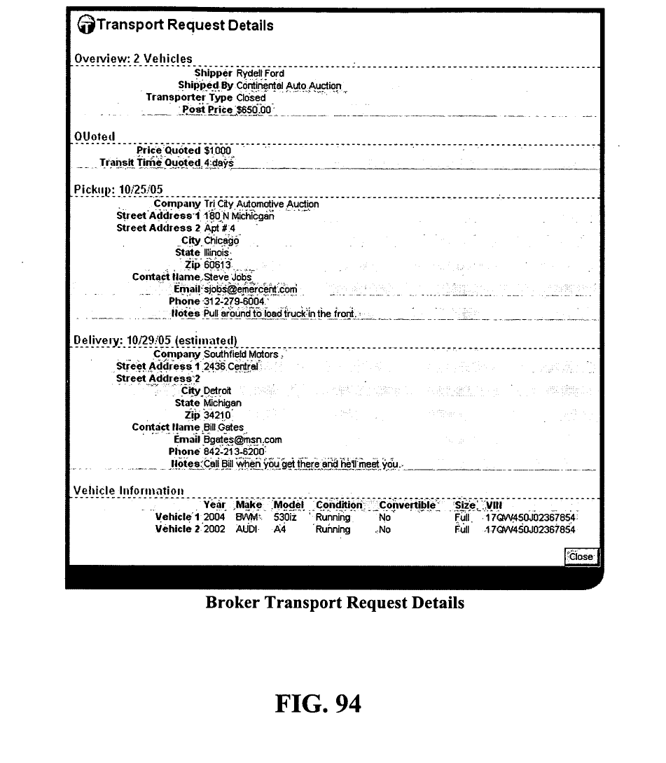

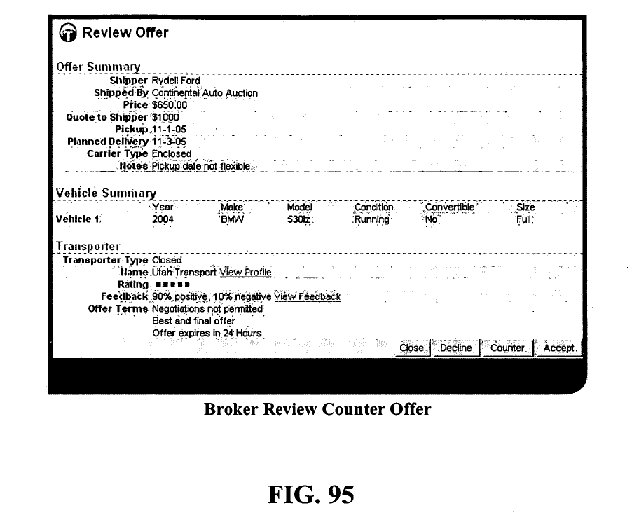

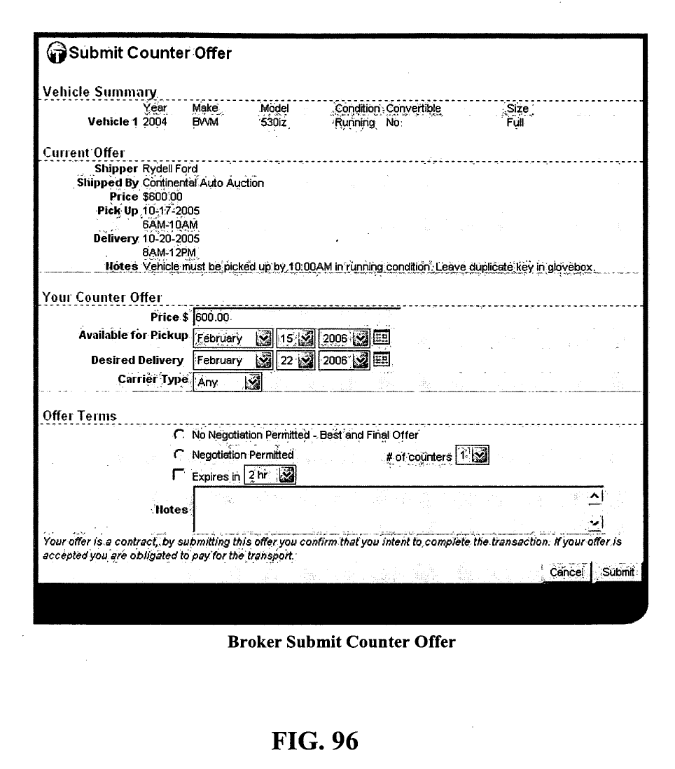

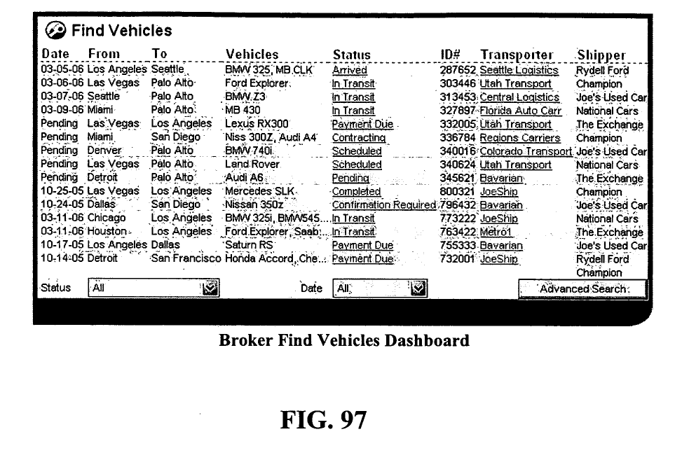

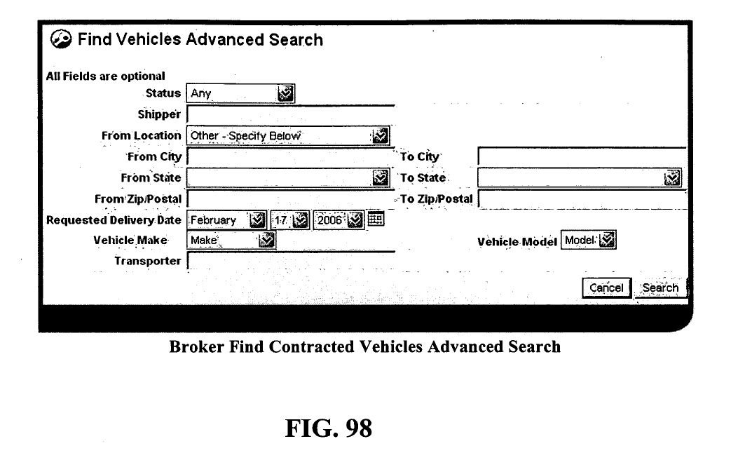

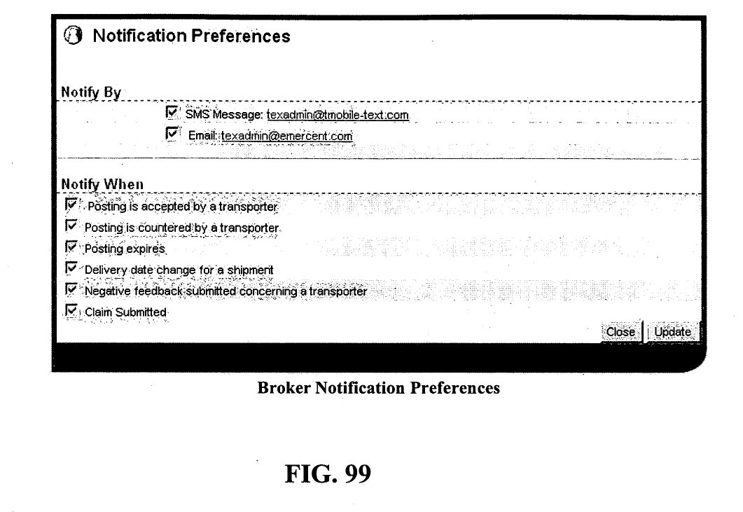

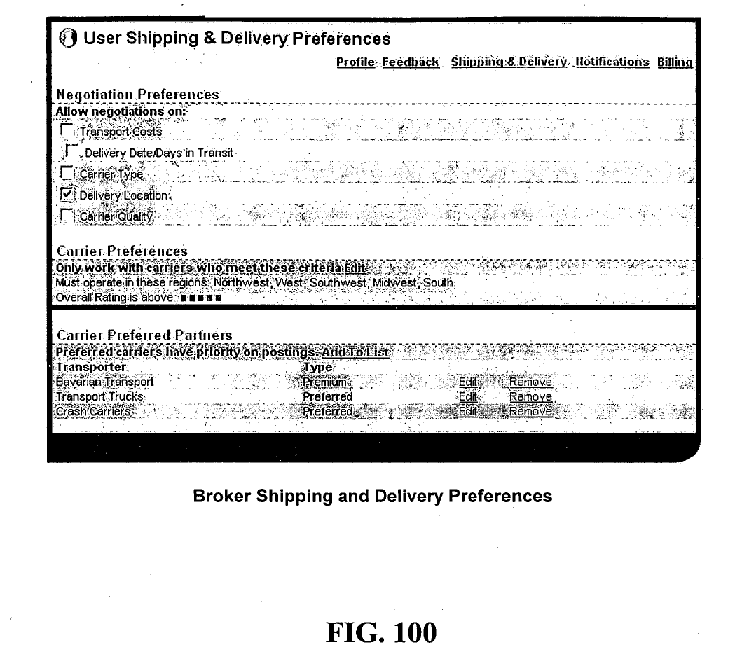

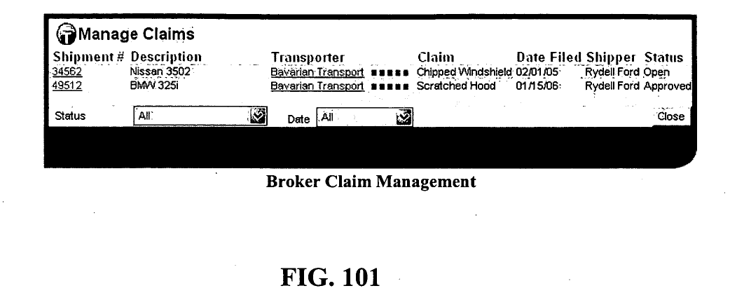

Claim Management. See FIG. 101.

The Broker Claim management form permits TEX personnel to view, at a high level, all claims that have been submitted, including their current status. Initially, all claims will be displayed in a non-pageable, vertically scrolling grid. The displayed claims may be filtered on the form by selecting a particular claim status type, or a particular date (last 30, 60, 120 or 365 days).

Note that, for TEX, only this high level overview of a claim will be available in the TMA. If additional details need to be viewed, TEX personnel may use the dealer or transporter portal, impersonate the dealer or transporter involved in the claim, and drill down into the detailed claim historical information available to dealers and transporters.

Broker Reports

The TMA application will be capable of generating the following reports.

Daily, weekly, monthly and year-to-date exception reports, identifying events occurring on TEX of high significance to TEX personnel, including delays in shipment and rescheduling of deliveries, claims entered by dealers for damage in shipment, and negative feedback entered concerning a dealer or transporter;

Income reports on a daily, weekly, monthly and year-to-date basis;

Dealer invoices on a per-dealer, daily, weekly, monthly and year-to-date basis;

Transporter remittance reports on a per-transporter, daily, weekly, monthly and year-to-date basis;

Auction partner remittance reports on a per-auction, daily, weekly, monthly and year-to-date basis; and

TEX activity reports on a daily, weekly, monthly and year-to-date basis, including all of the information displayed on the TEX dashboard, as described above.

The foregoing examples describe the present invention in the context of transport of automobiles. Application of the present invention, however, is not limited for use in the transport of automobiles. Those skilled in the art will recognize that the present invention can be used for the transport of a wide variety of goods, and can be useful to a wide variety of entities involved in the transport of goods. Thus, the present invention can be applied in a wide variety of marketplaces, including but not limited to:

Types of products:

1) Antiques

2) Powerboats

3) Motorcycles

4) Recreational vehicles

5) Health care equipment

6) Industrial equipment (such as manufacturing tools and equipment)

7) Farm equipment

8) Trucks

9) Construction equipment

10) Goods designated for salvage, including automobiles designated for salvage (including but not limited to automobiles designated for salvage in another country)

11) Airplanes, and airplane engines, and airplane parts

12) Furniture and home decor products, such as products that cannot be economically shipped via overnight mail delivery

Types of Alignment:

1) With auctions or with market exchanges that allow for the ownership transfer of the aforementioned goods

2) With resellers of the aforementioned goods

3) With lessors of the aforementioned goods

4) With manufacturers of the aforementioned goods

5) With owners of the aforementioned goods

FIG. 102 shows an exemplary illustrative non-limiting dashboard screen with dealer selected.

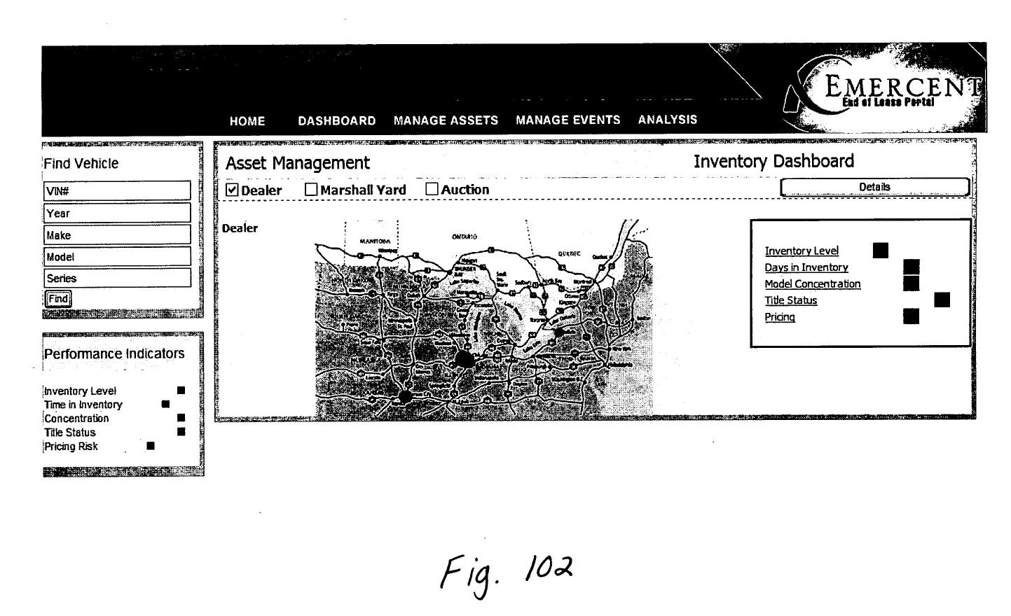

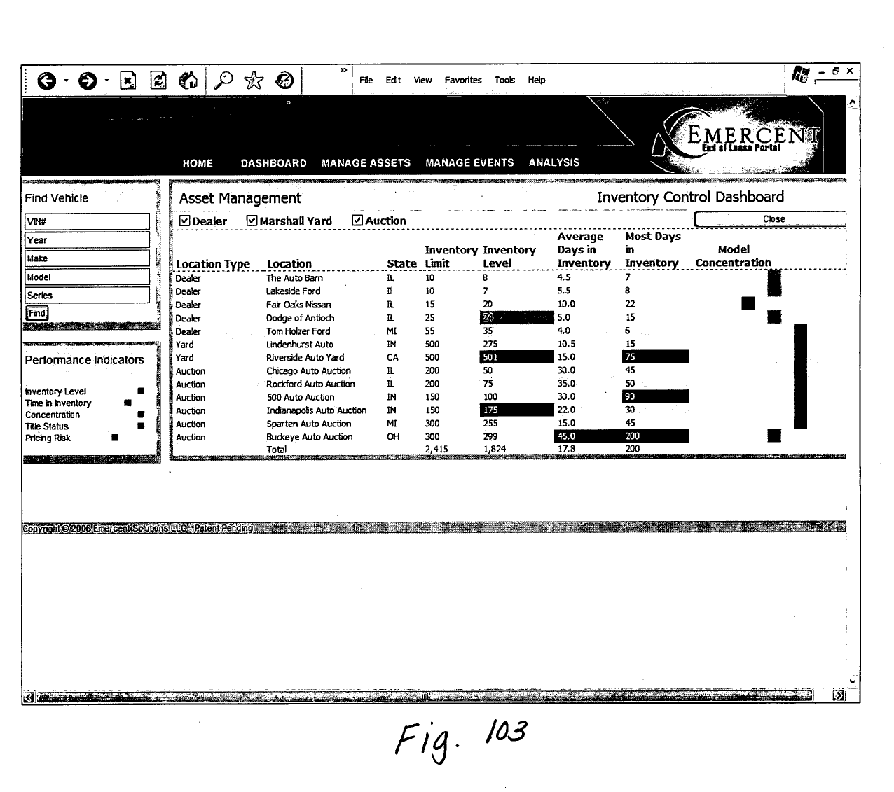

FIG. 103 shows an exemplary illustrative FIG. 112 screen with “Details” selected with details on inventory levels.

FIG. 104 shows an exemplary illustrative non-limiting display screen with “Asset Management—Inventory Level” selected indicating the number, type, and other details of vehicles needing management.

FIG. 105 shows an exemplary illustrative non-limiting display screen with “Asset Management—Concentration Level” selected indicating the number, type, and other details of vehicles being managed.

FIG. 106 shows exemplary illustrative non-limiting display screen with “Transportation Analysis” on FIG. 115 selected indicating the suggested ship to locations, mileage, costs, current status, location, quality, year, make, model, series of vehicles to be shipped.

FIG. 107 shows exemplary illustrative non-limiting display screen with Channel Assignment” on FIG. 115 selected providing a list of vehicles and various suggested channels for assignment to.

FIG. 108 shows exemplary illustrative non-limiting display screen with “Sale Management” on FIG. 115 allowing how assets can be matched with events and buyer groups.

FIGS. 109-112 show illustrative non-limiting exemplary screens to setup and manage sales events for assets, and manage who participates in an event.

FIG. 113 shows an exemplary illustrative non-limiting display screen for the analysis of the results of activity in different channels.

FIG. 114 shows an exemplary illustrative non-limiting display screen for the graph depiction of the performance of portfolio of assets marketed through the various channels.

FIG. 115 shows an exemplary illustrative non-limiting display screen with “Details” selected on FIG. 114.

FIG. 116 shows an exemplary illustrative non-limiting display of the results of sales activity through different channels.

FIG. 117 shows an exemplary illustrative non-limiting graphic display of the sales proceeds during a specified period.

FIG. 118 shows an exemplary illustrative non limiting display of information concerning the number of vehicles available to be managed.

FIG. 119 shows an exemplary illustrative non limiting display screen showing follow-up activity, customer contacts planned and other tasks and information required by the user to effectively manage the assets for sale.

FIG. 120 shows an exemplary illustrative non limiting display screen showing the customers contract information.

FIG. 121 shows an exemplary illustrative non limiting display screen showing the information about the vehicle associated with the customer's contract.

FIG. 122 shows an exemplary illustrative non limiting display screen showing the right extension of the same screen in FIG. 121.

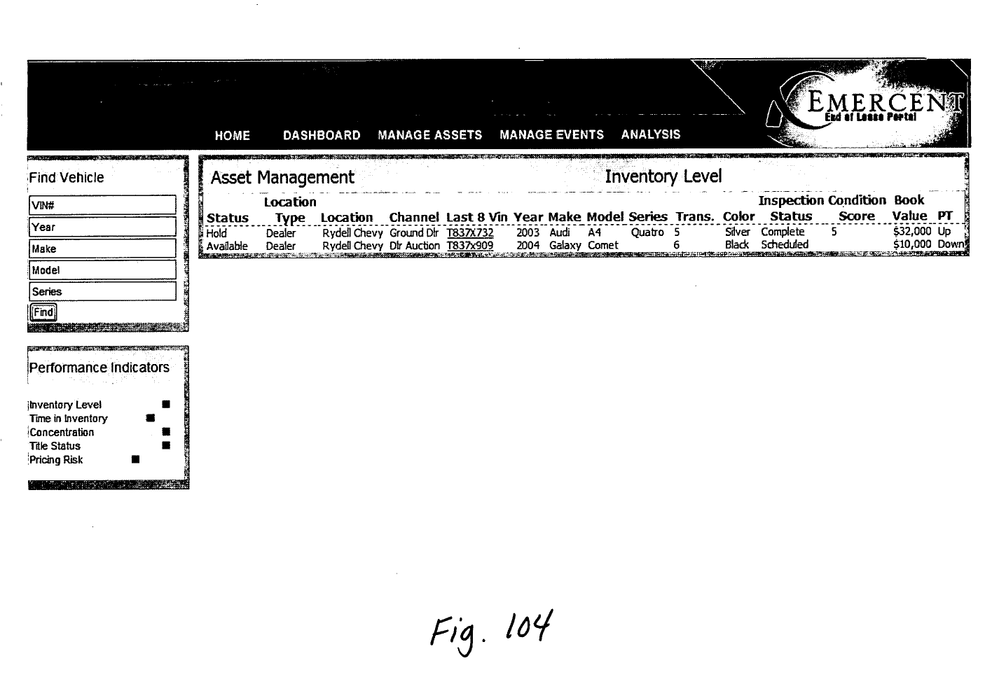

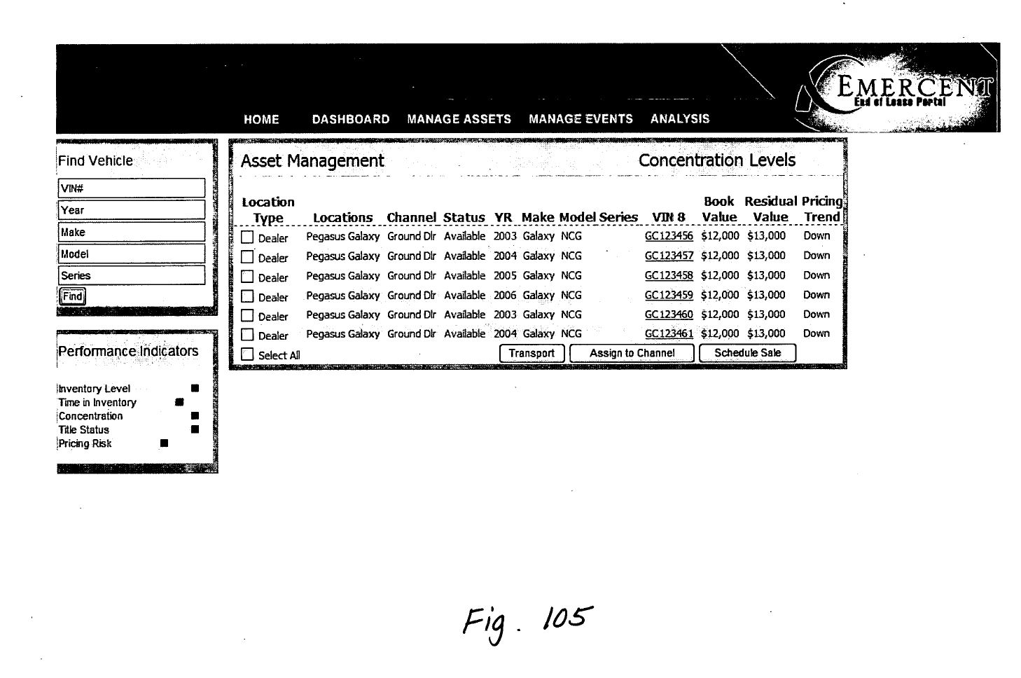

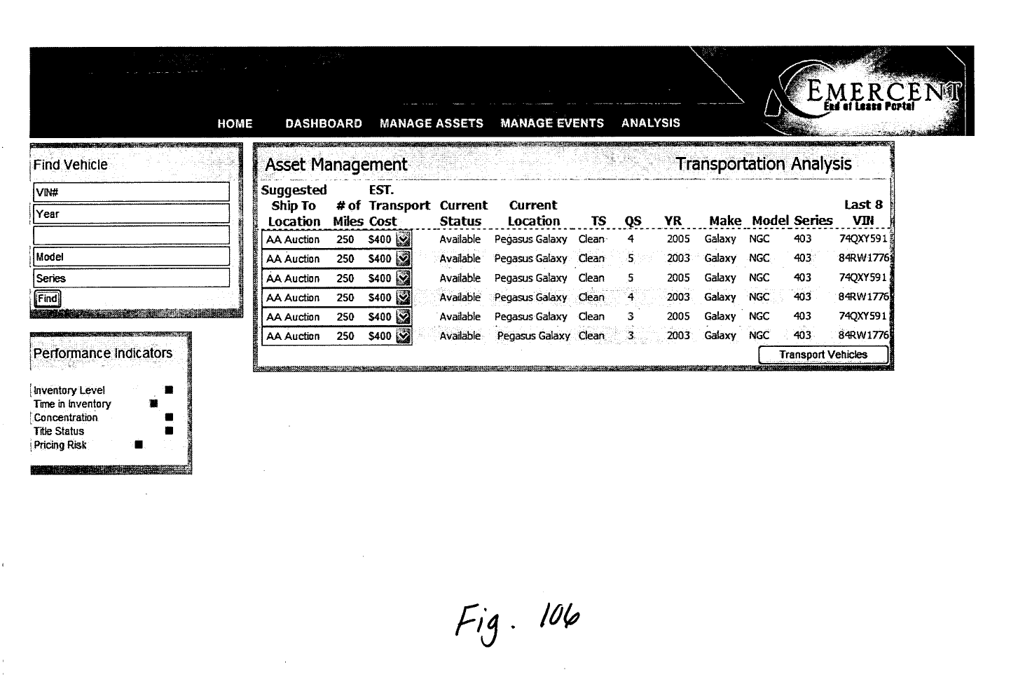

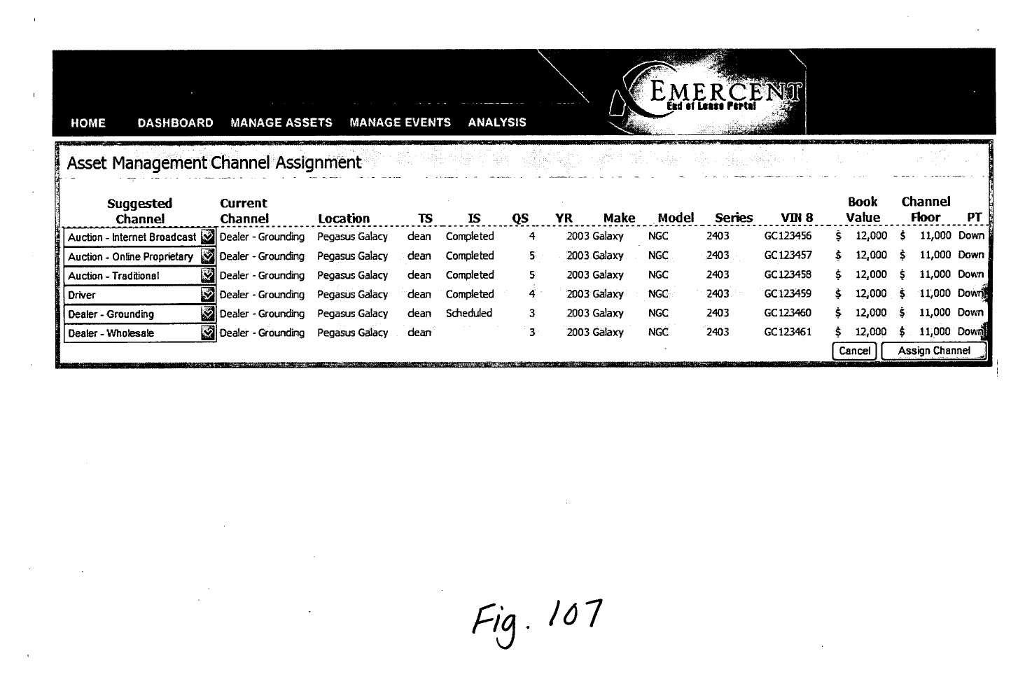

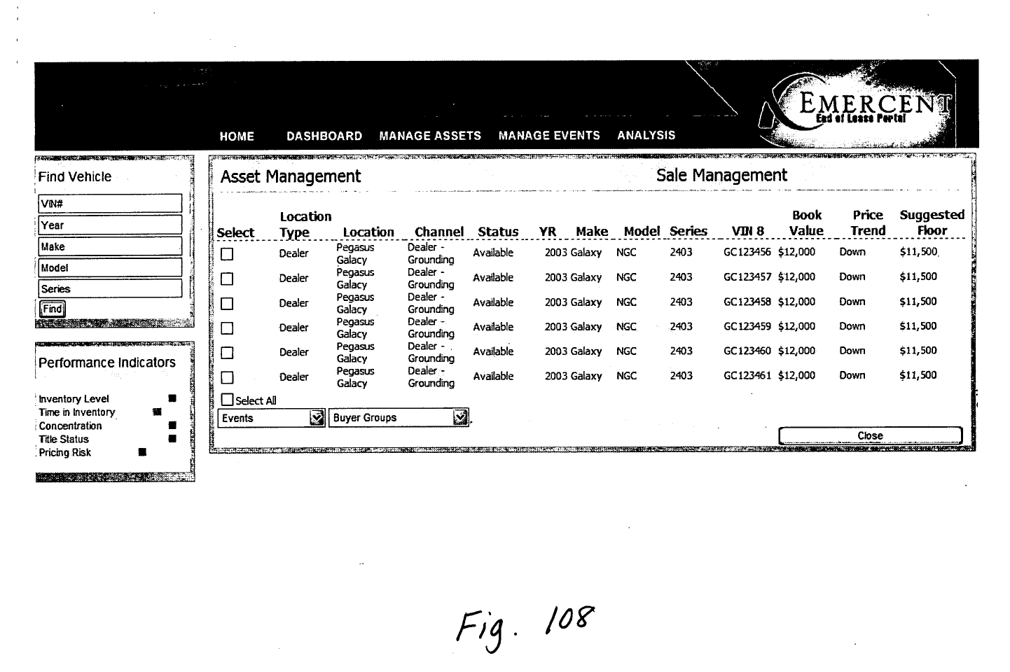

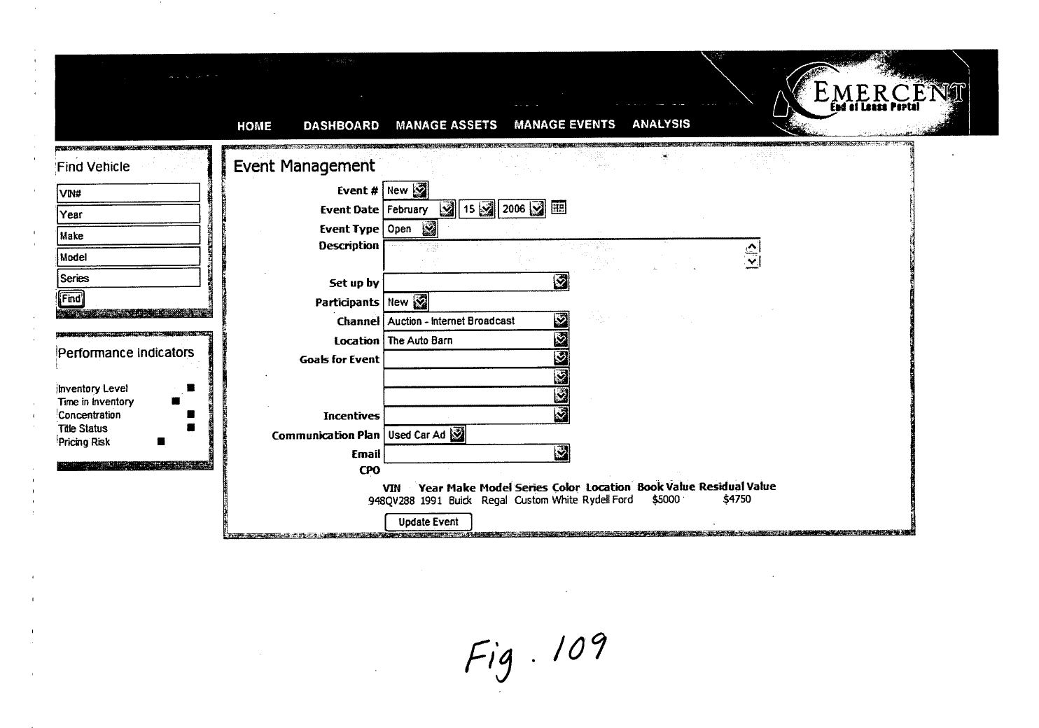

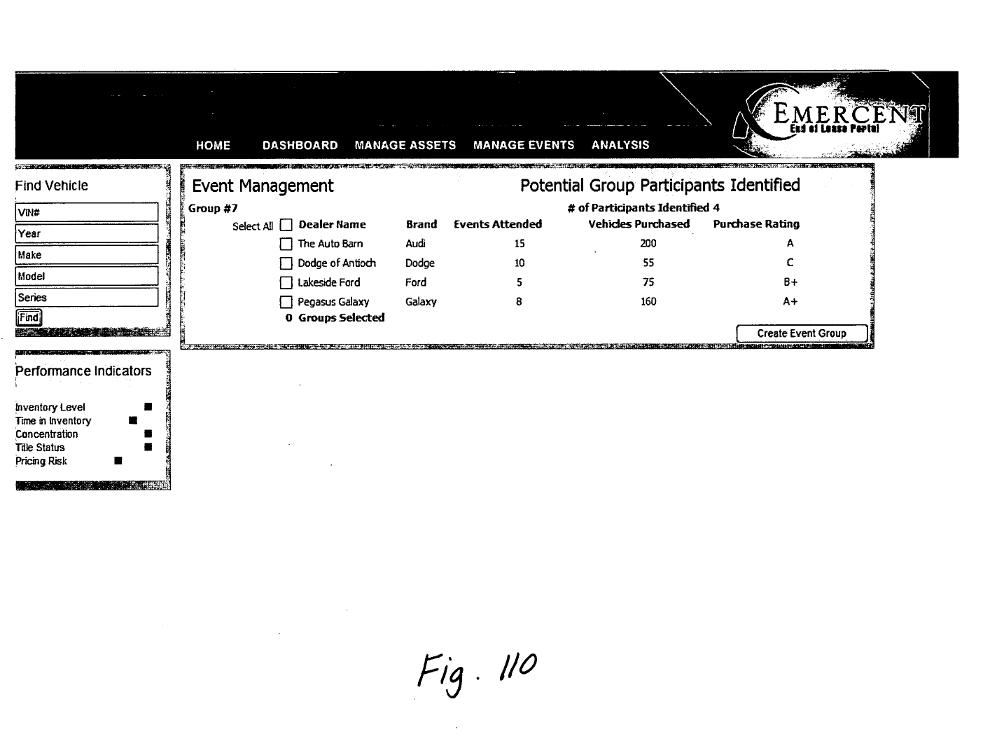

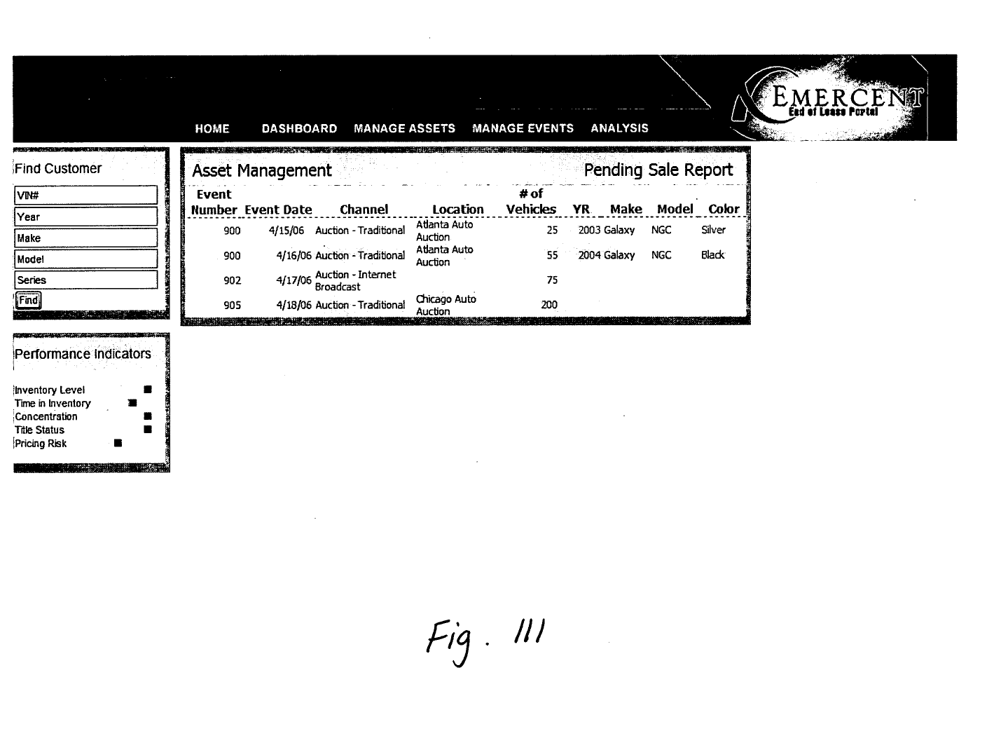

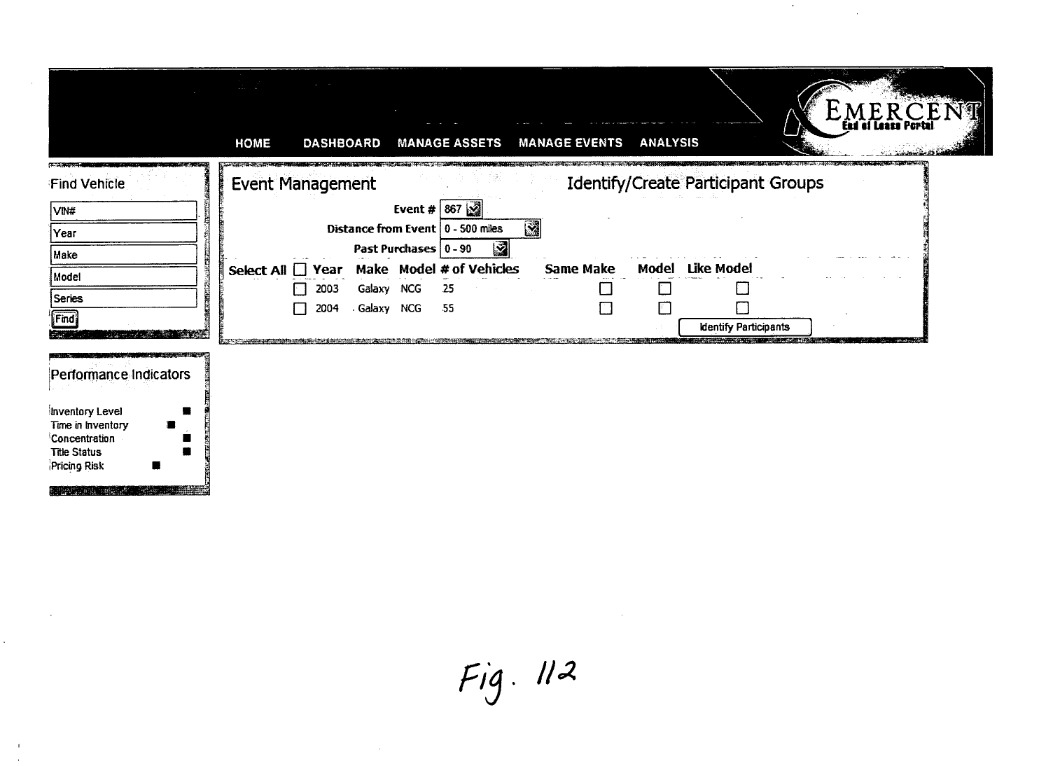

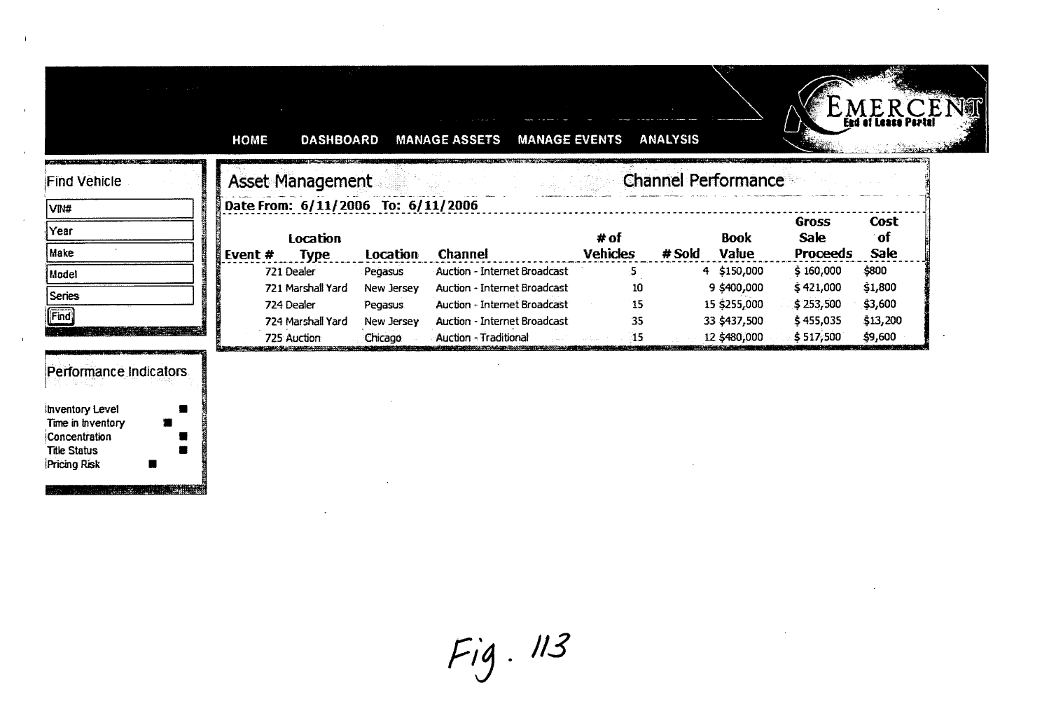

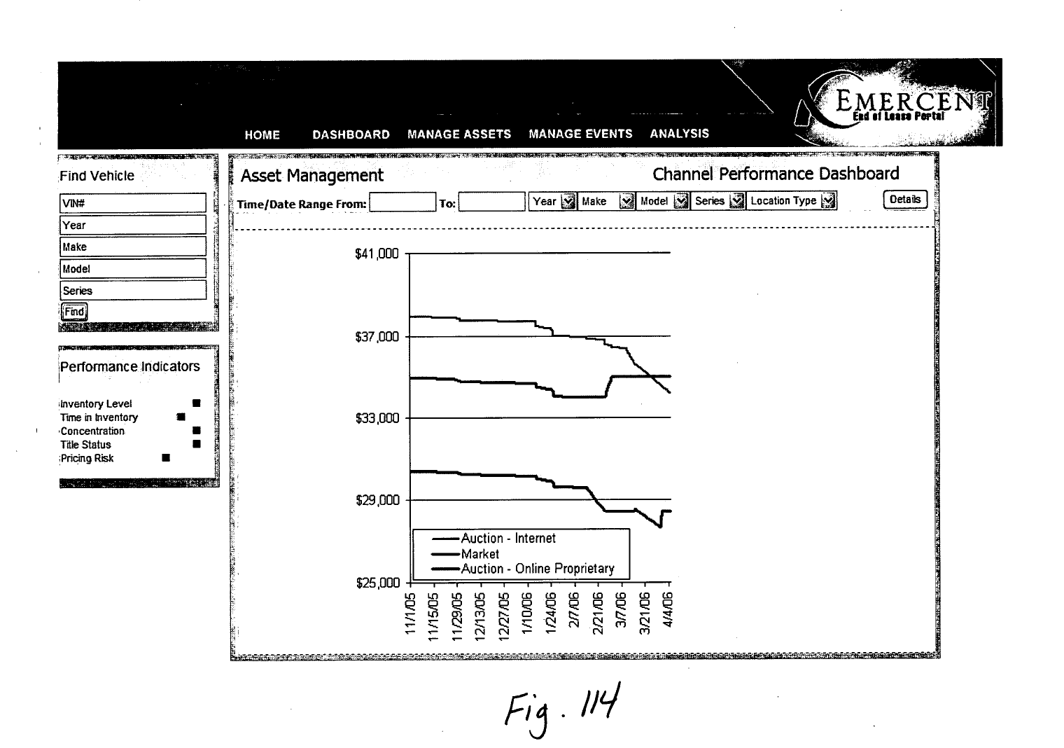

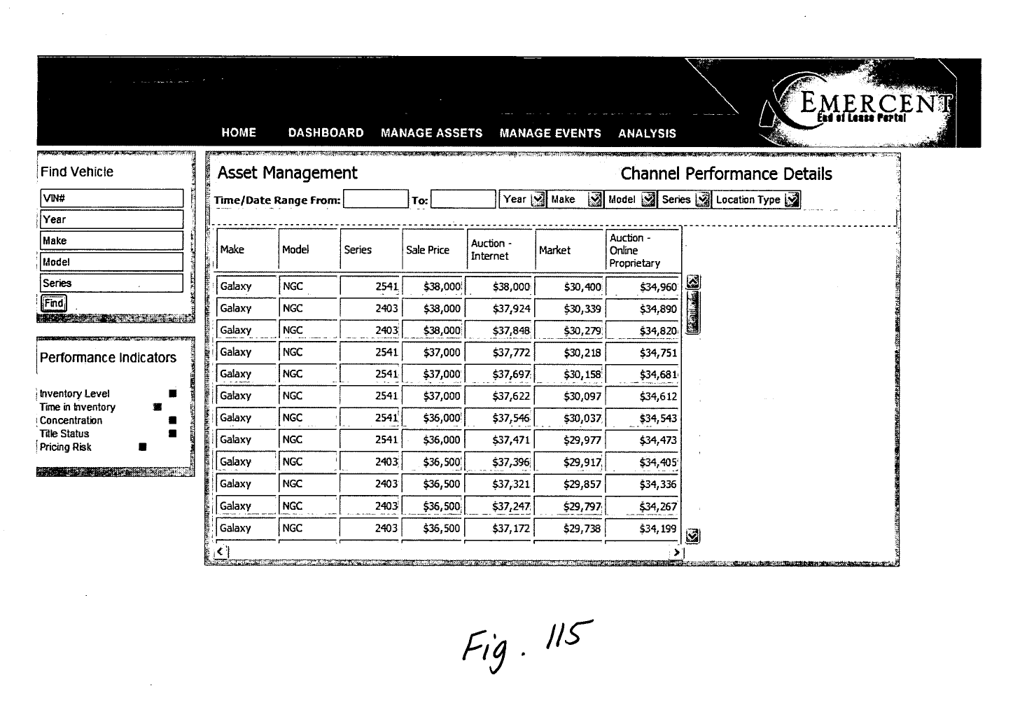

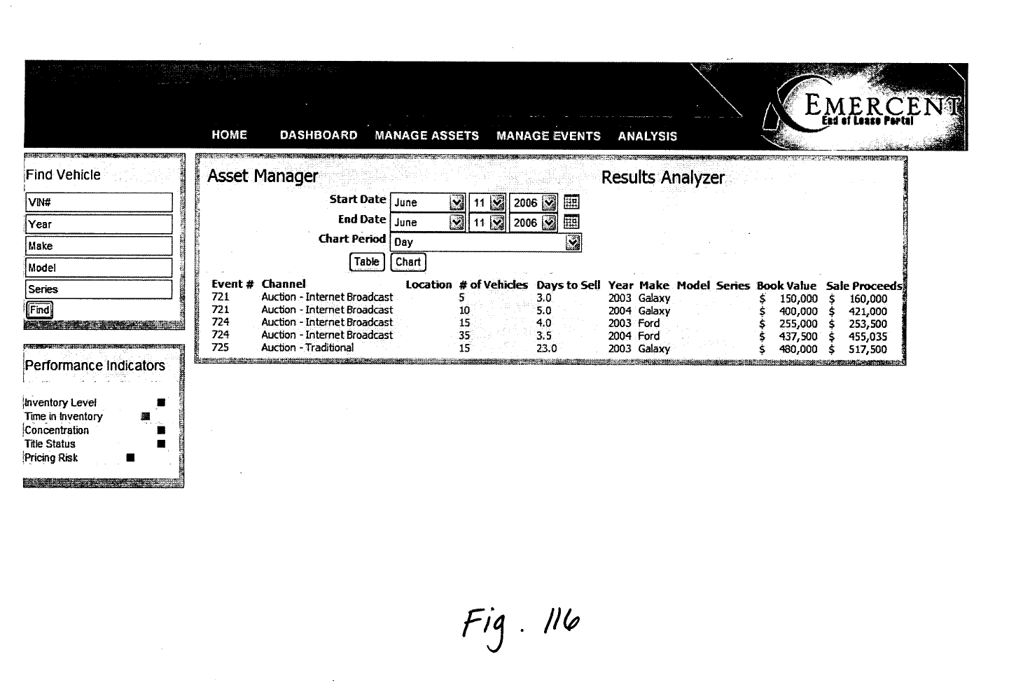

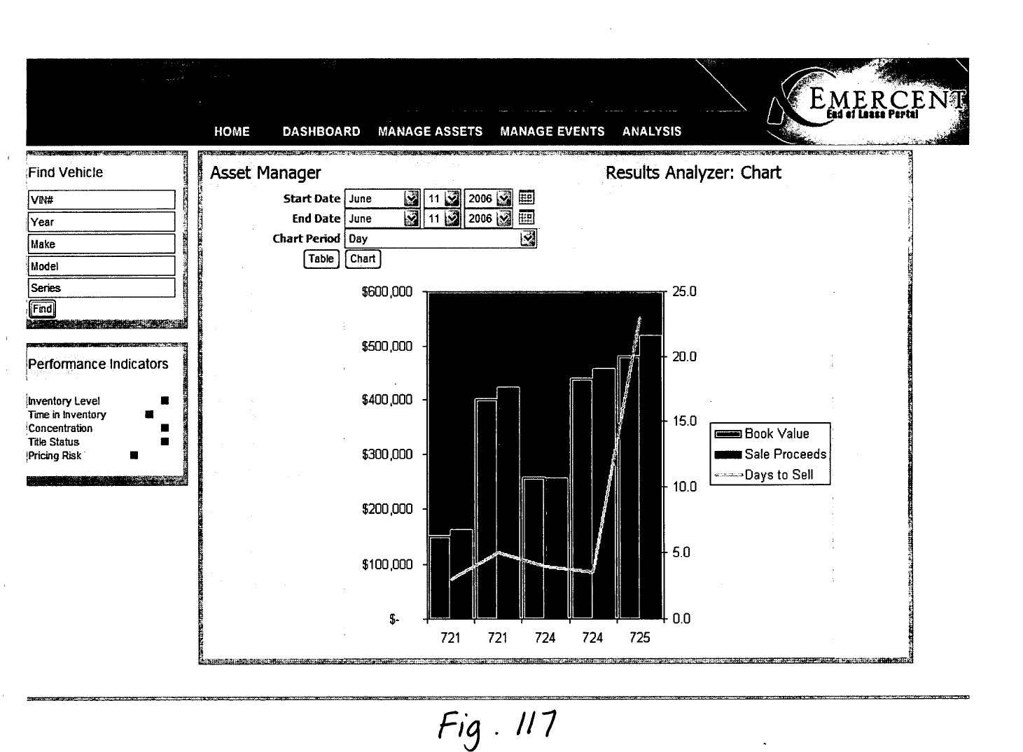

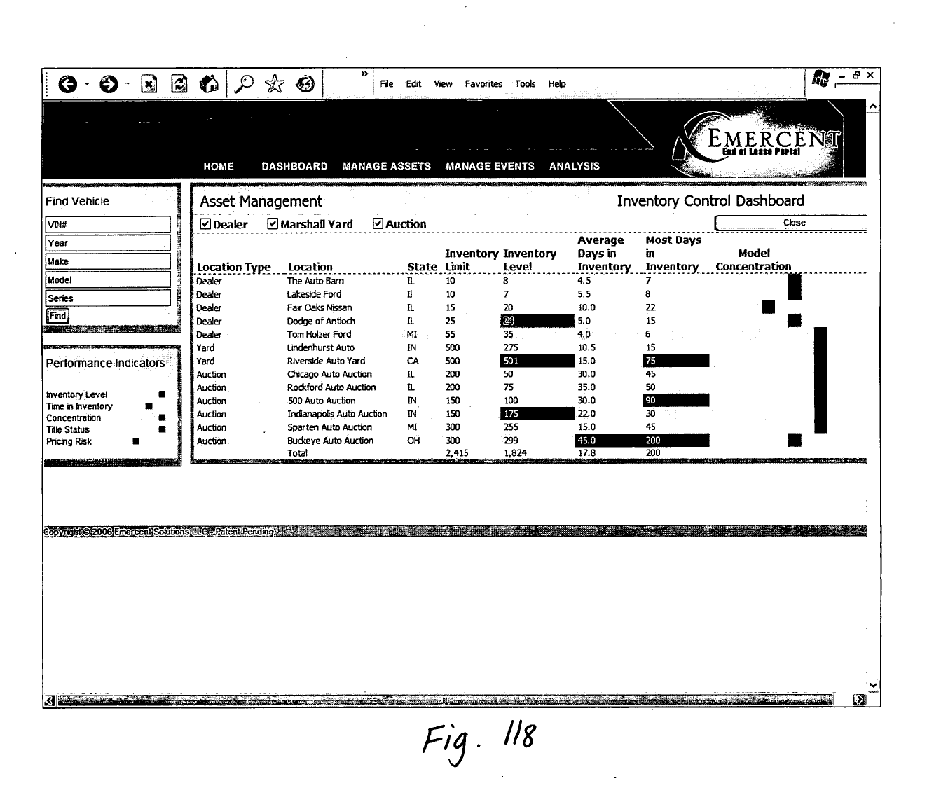

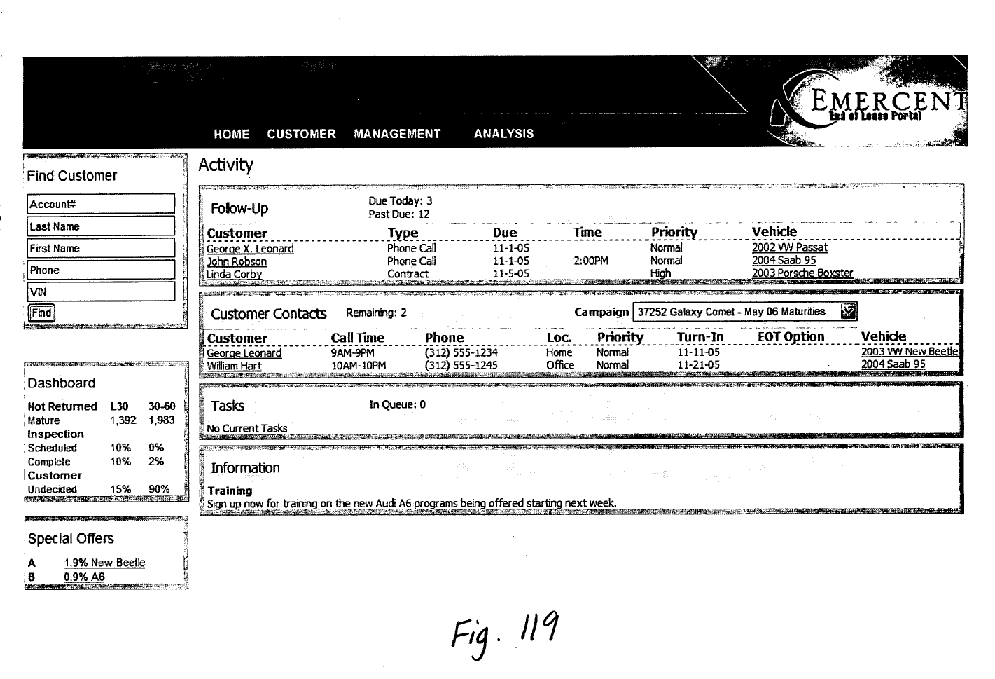

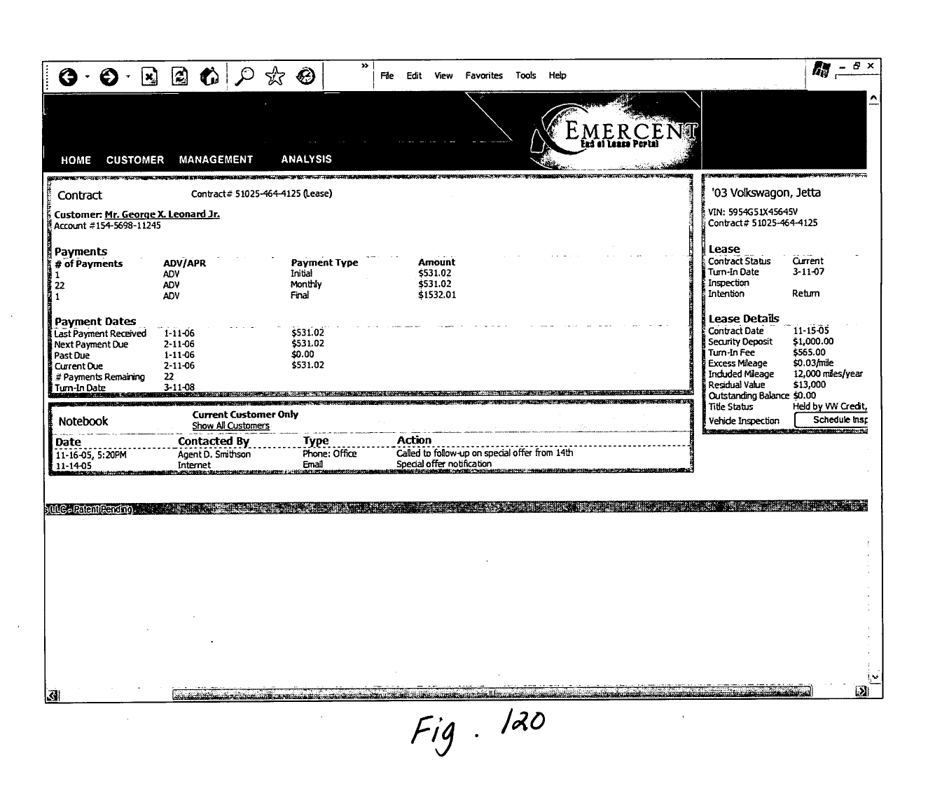

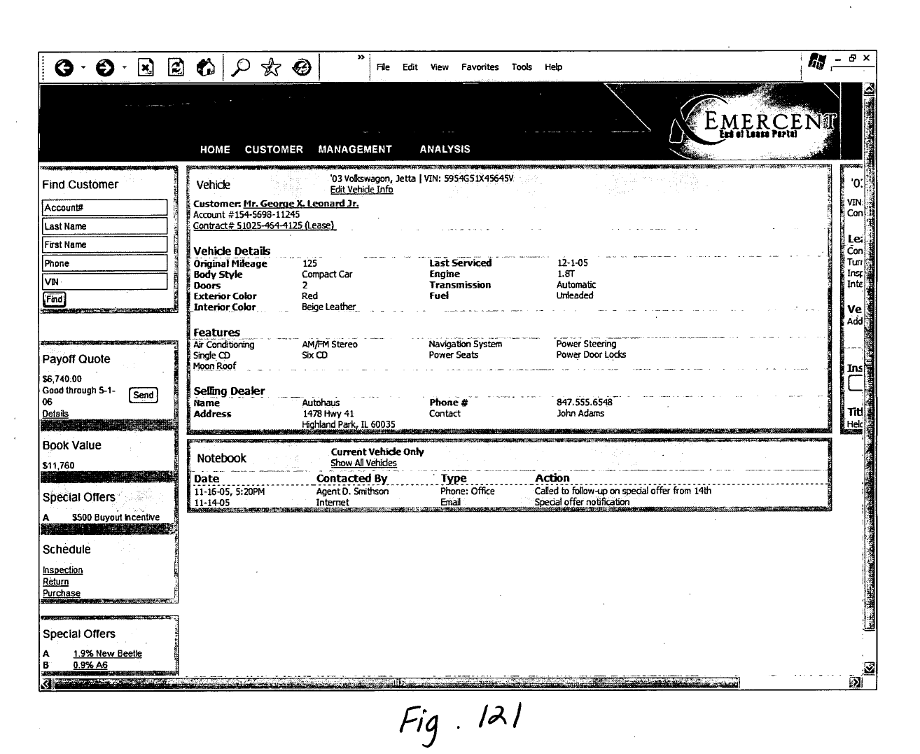

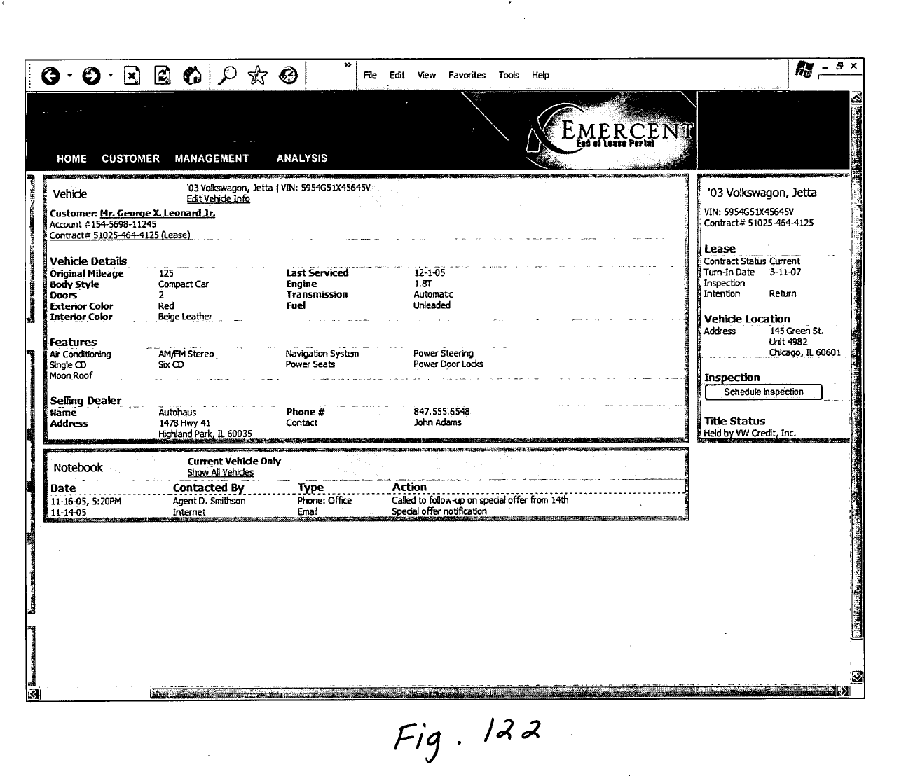

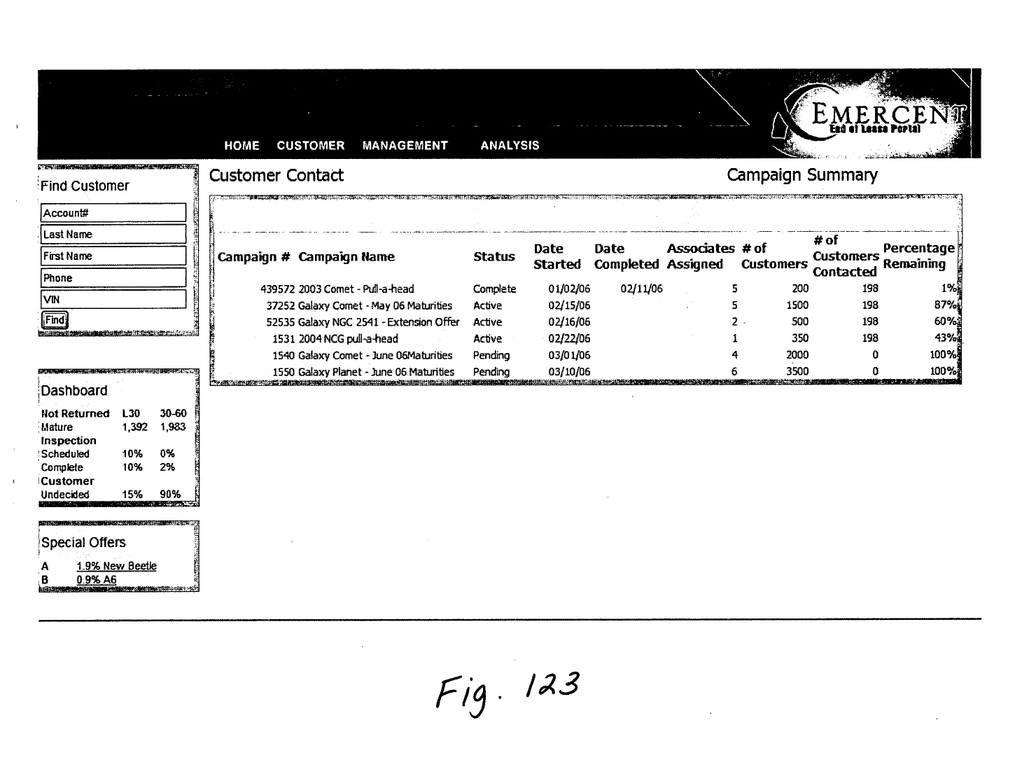

FIG. 123 shows an exemplary illustrative non limiting display screen showing the summary data from call campaigns identified.

FIG. 124 shows an exemplary illustrative non limiting display screen showing the “Campaign Manager” information allowing the establishment of a particular campaign to be completed.

FIG. 125 shows an exemplary illustrative non limiting display screen showing the various end of term programs available to be offered to customers.

FIG. 126 shows an exemplary illustrative non limiting display screen showing the results from activities occurring around the time of the vehicle sale at the end of the lease/loan term.

FIG. 127 shows an exemplary illustrative non limiting display screen showing the graphic results identifying future scheduled maturing leases/loans.

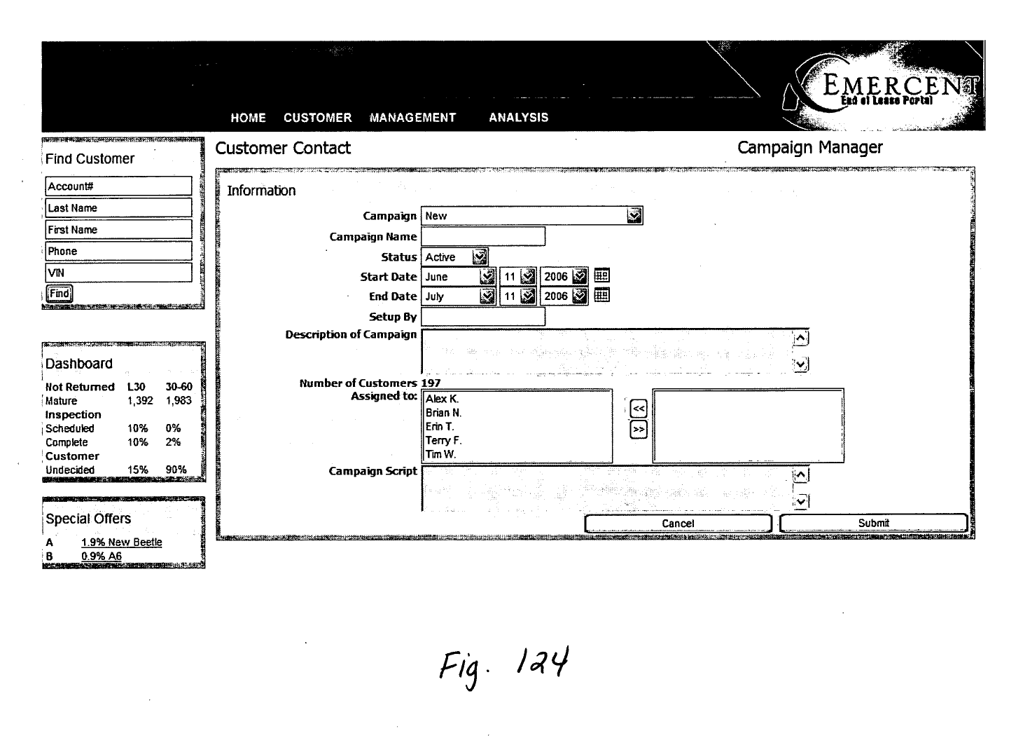

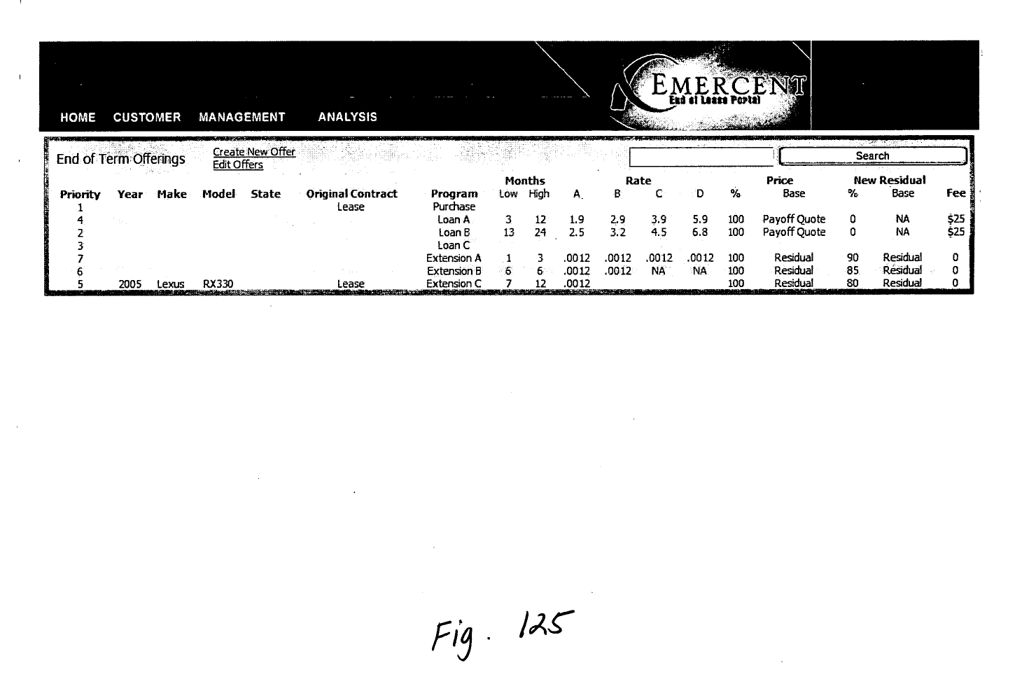

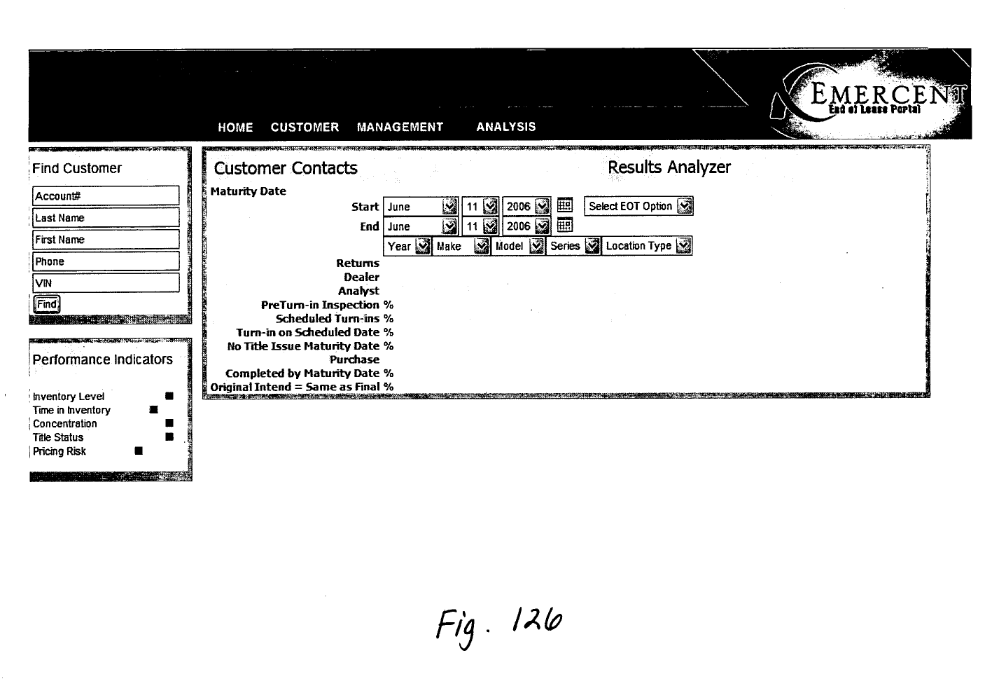

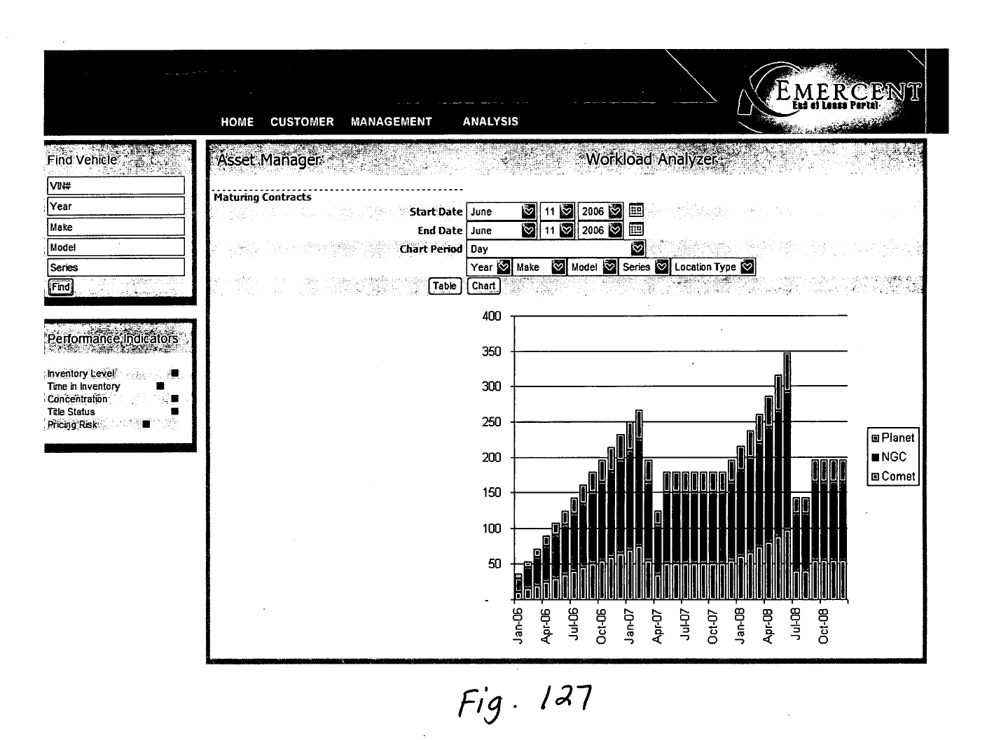

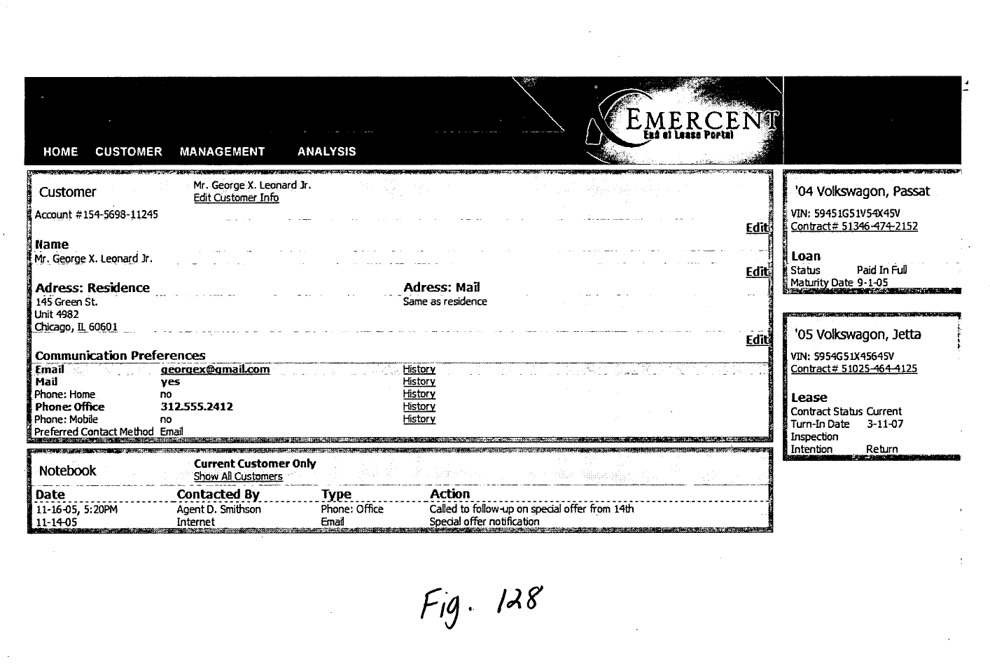

FIG. 128 shows an exemplary illustrative non limiting display screen showing the customer contact information which can be updated.

FIG. 129 shows an exemplary illustrative non limiting display screen showing the information from FIG. 128 in update mode.

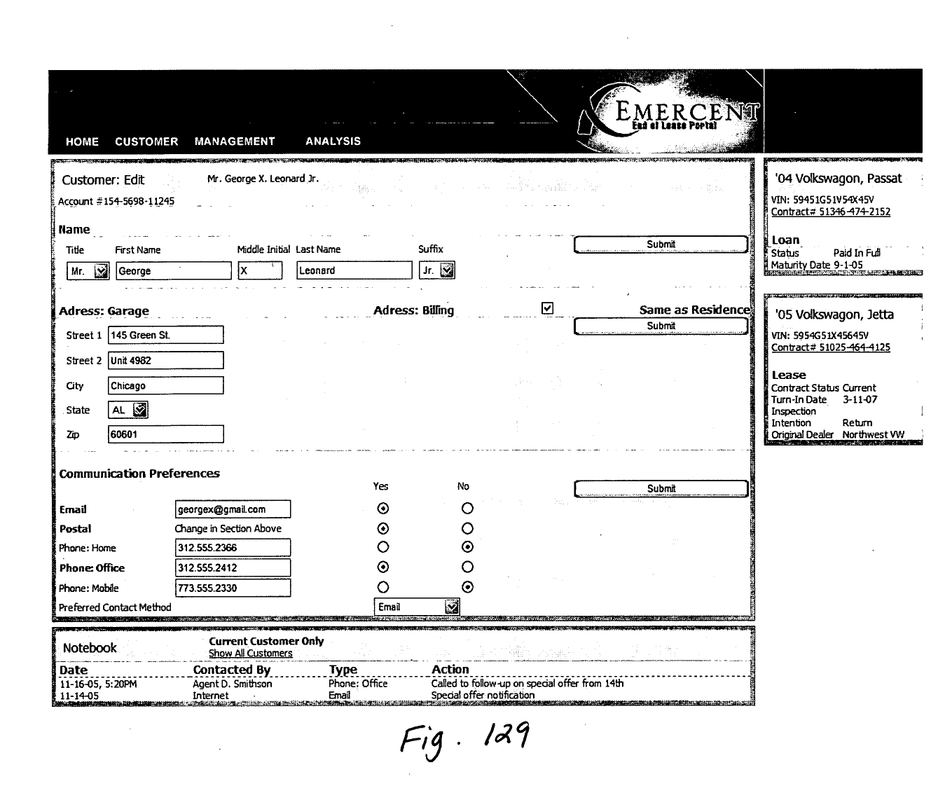

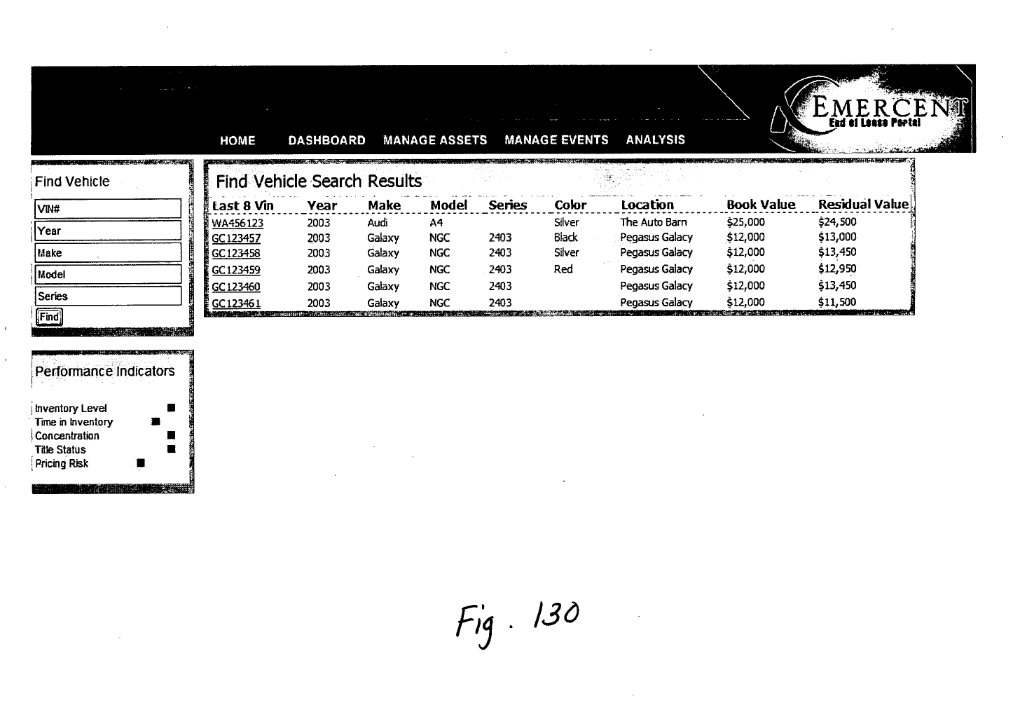

FIG. 130 shows an exemplary illustrative non limiting display screen showing the results from doing an inquiry with the Find Vehicle section of the screen.

FIG. 131 shows an exemplary illustrative non limiting display screen showing the details of an individual vehicle selected in FIG. 130.

FIG. 132 shows an exemplary illustrative non limiting display screen showing the detailed data for a vehicle when selecting the update button on FIG. 131.

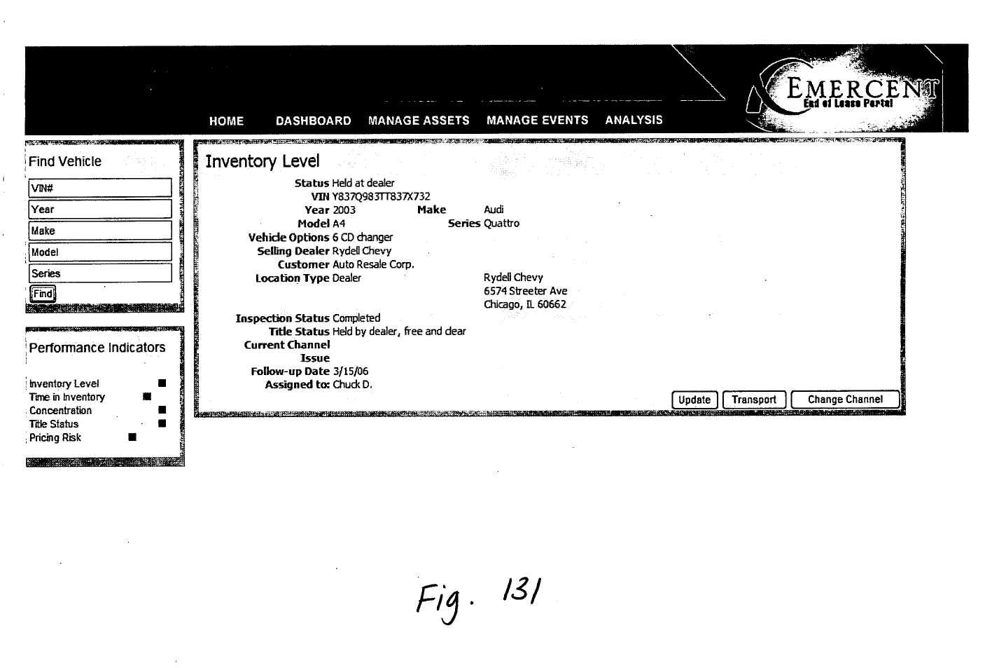

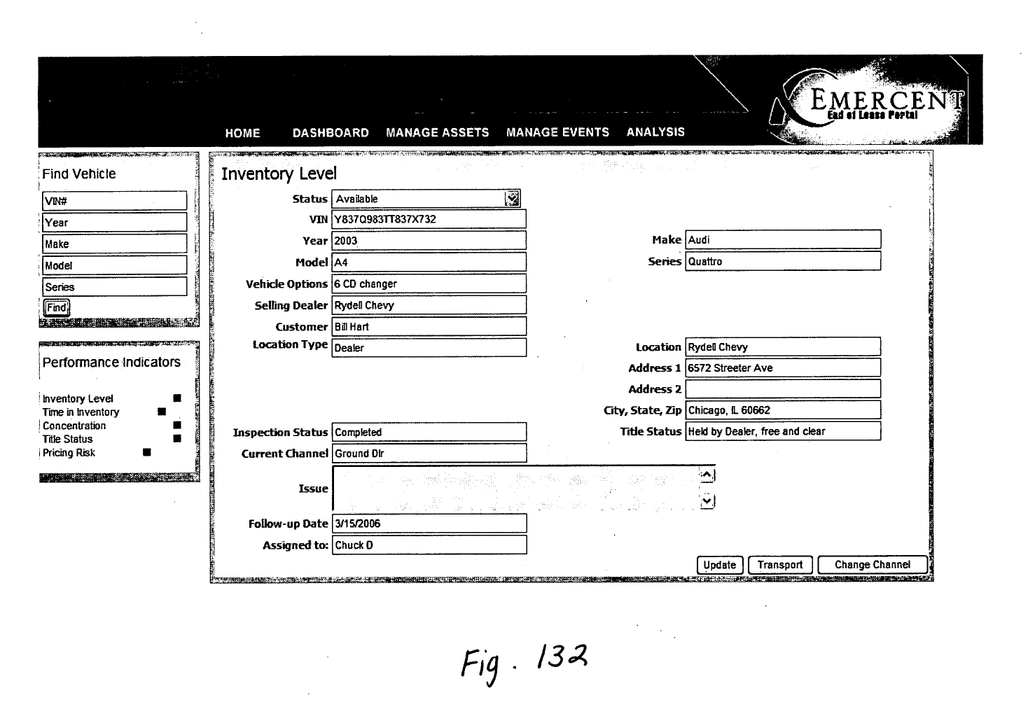

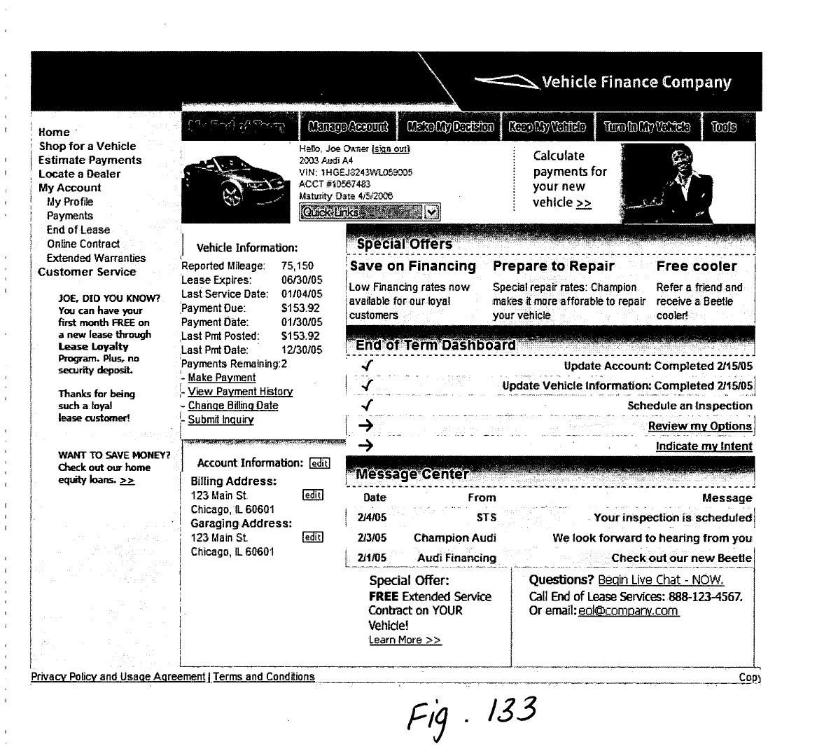

FIG. 133 shows an exemplary illustrative non limiting display screen showing the high-level overview of information provided to a customer concerning the status and options available to them at the end of the current term for their lease or loan.

FIG. 134 shows an exemplary illustrative non limiting display screen showing on a more detailed basis the information available and updatable.

FIG. 135 shows an exemplary illustrative non limiting display screen showing the customers information by selecting the “View Contract” button on FIG. 134.

FIG. 136 shows an exemplary illustrative non limiting display screen showing the activity between the owner and the finance company concerning their account.

FIG. 137 shows an exemplary illustrative non limiting display screen showing the lease-end options available to the customer.

FIG. 138 shows an exemplary illustrative non limiting display screen showing where the customer has the ability to express their intent concerning their end of lease options.

FIG. 139 shows an exemplary illustrative non limiting display screen showing the options available to the customer if they indicated their intent was to turn in the vehicle on FIG. 138.

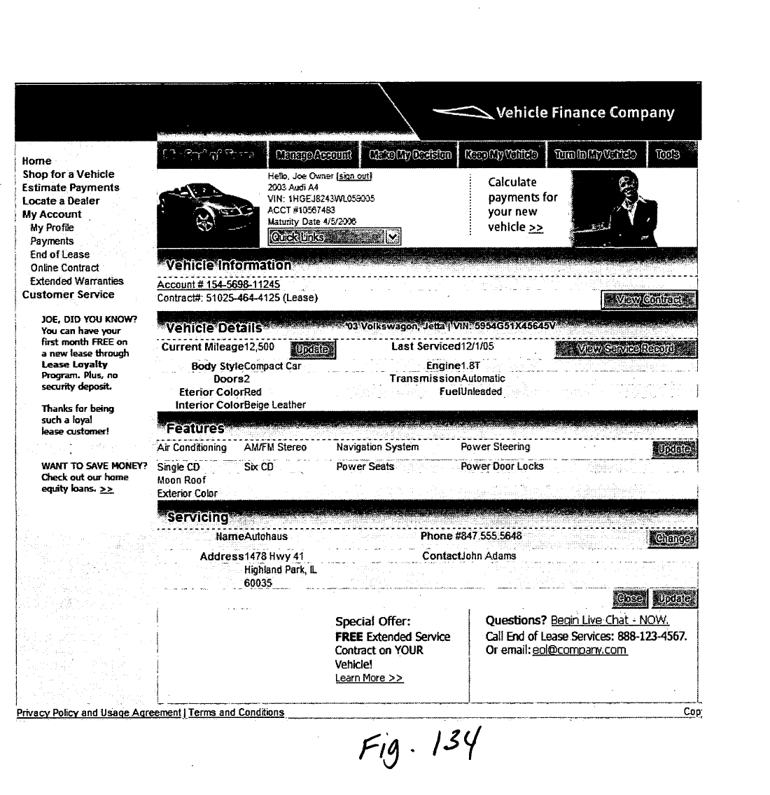

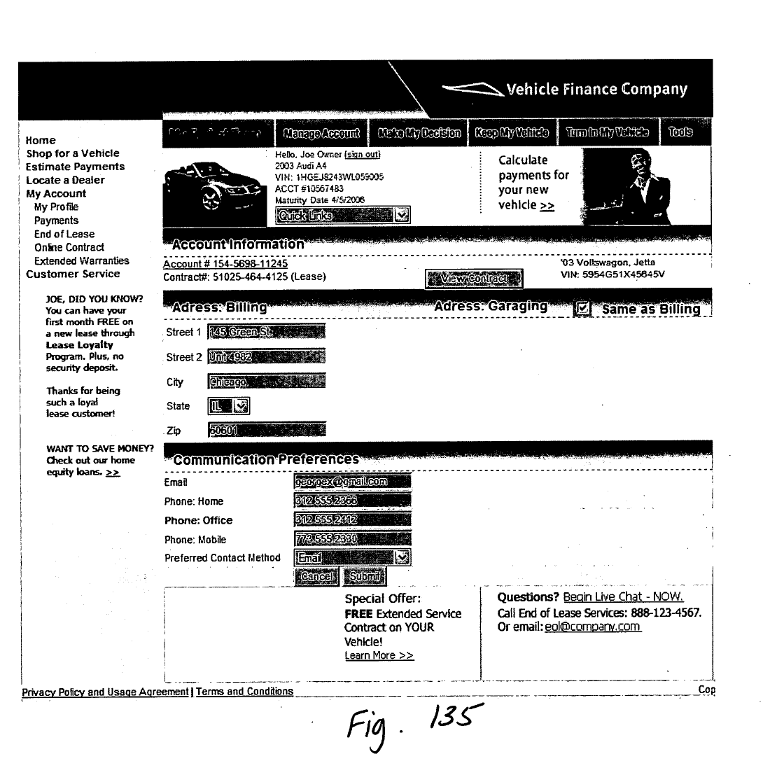

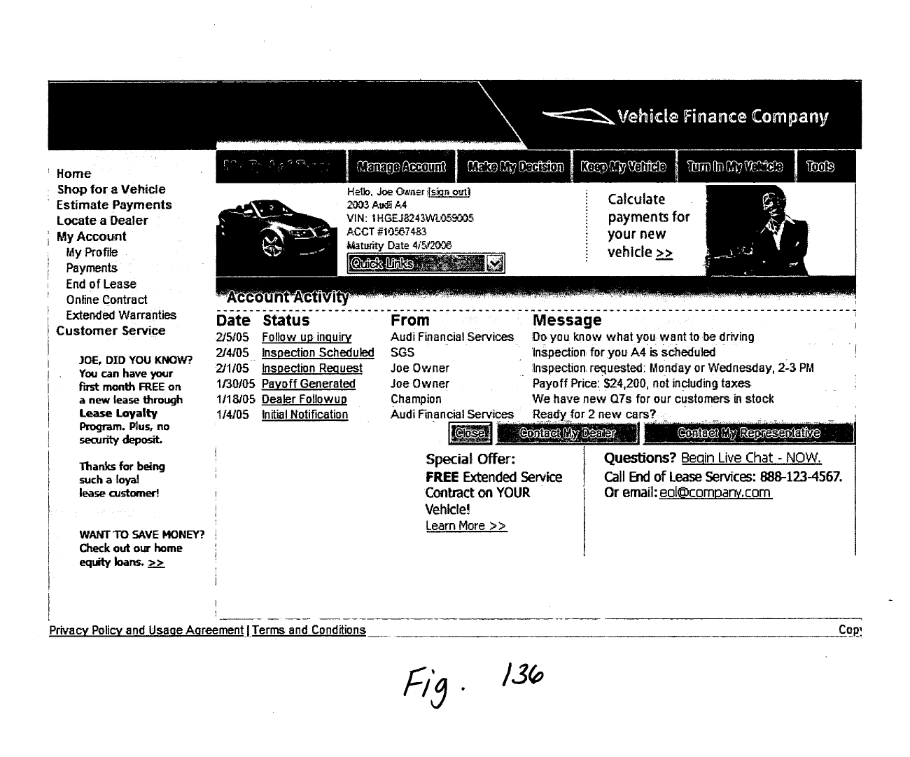

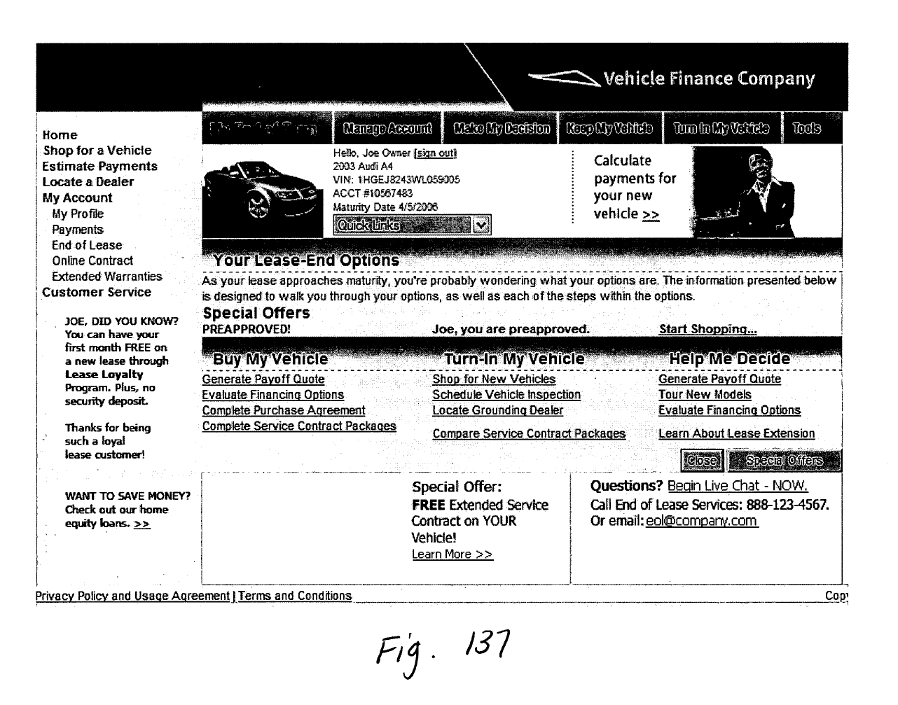

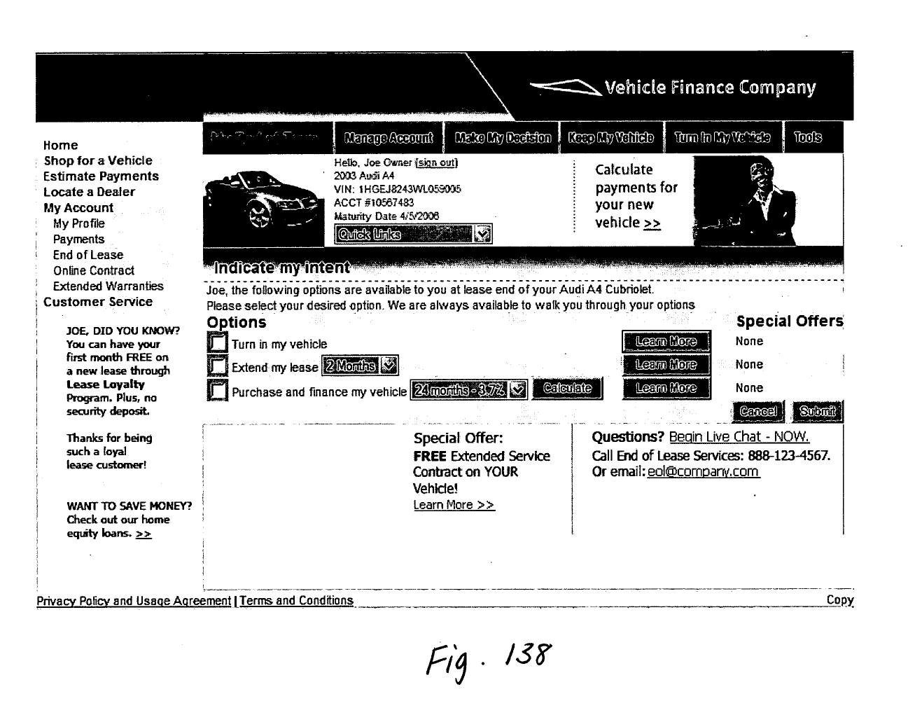

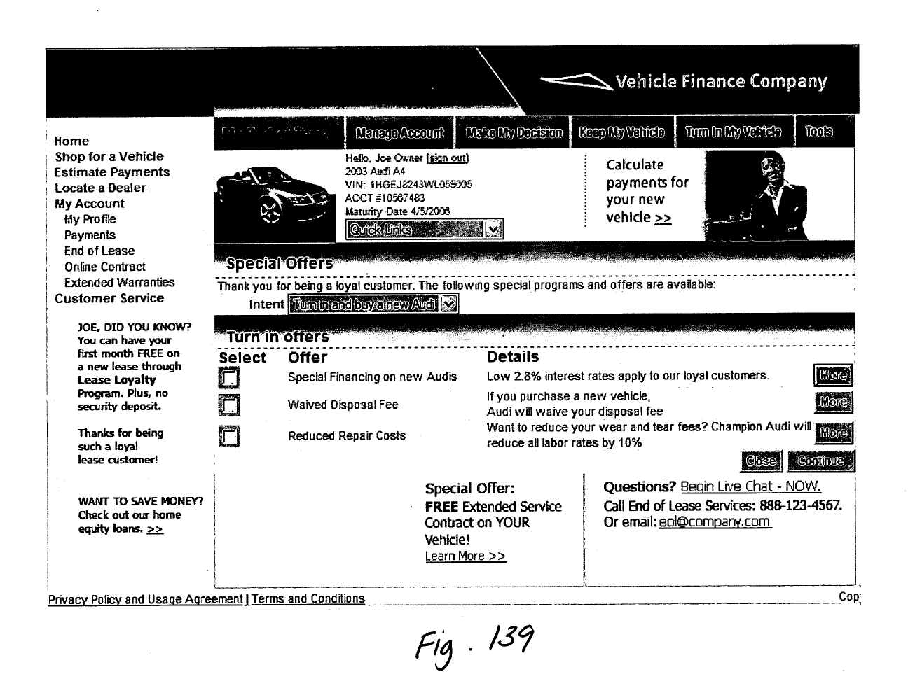

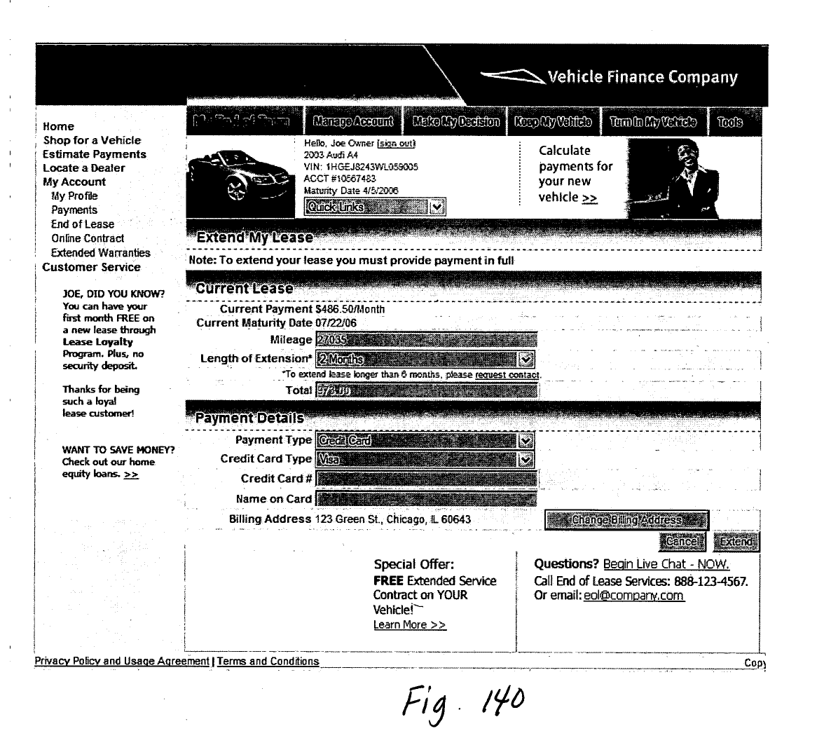

FIG. 140 shows an exemplary illustrative non limiting display screen showing the options available to the customer if they indicated their intent was to extend their lease on FIG. 138.

FIG. 141 shows an exemplary illustrative non limiting display screen showing the options available to the customer if they indicated their intent was to purchase their vehicle on FIG. 138.

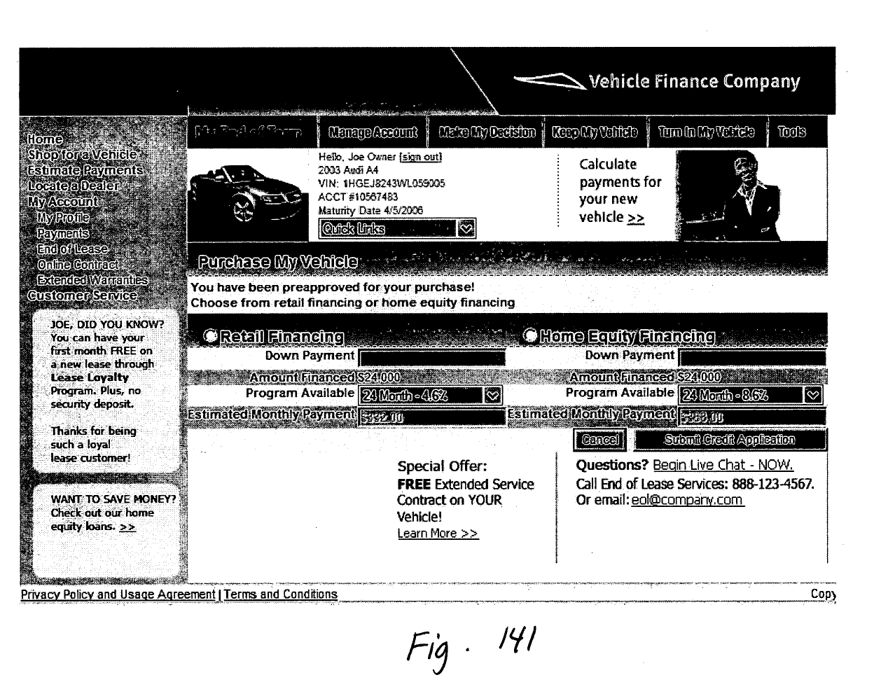

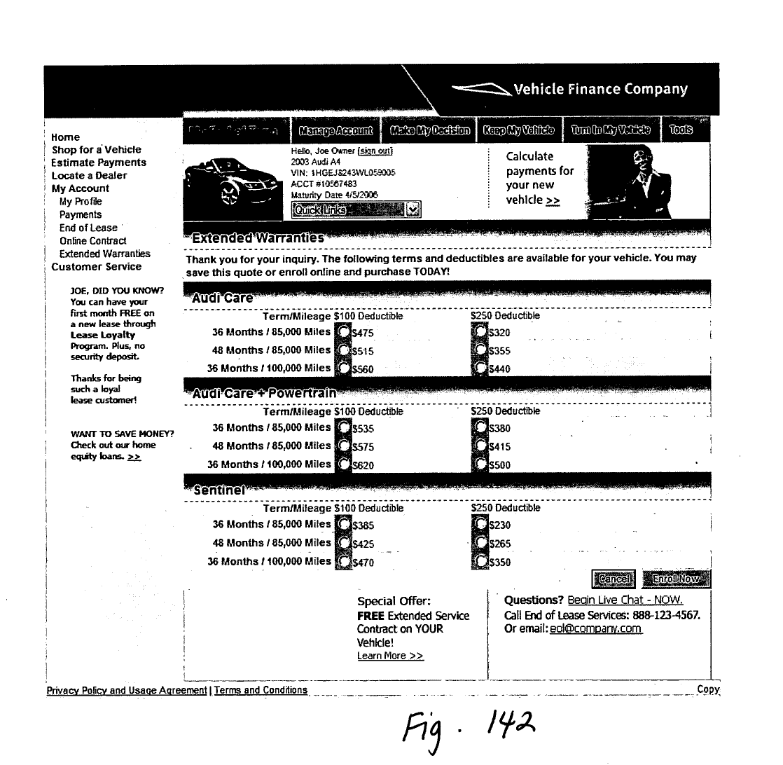

FIG. 142 shows an exemplary illustrative non limiting display screen showing the information available to a customer who expressed an interest in extended warranties for their vehicle.

FIG. 143 shows an exemplary illustrative non limiting display screen showing the refer program available to a customer to identify individuals who may be interested in their vehicle.

FIG. 144 shows an exemplary illustrative non limiting display screen showing the information needed to schedule an inspection of their vehicle prior to the end of the lease term.

FIG. 145 shows an exemplary illustrative non limiting display screen showing the information needed for the customer to schedule the return of their vehicle if that option was selected in FIG. 138.

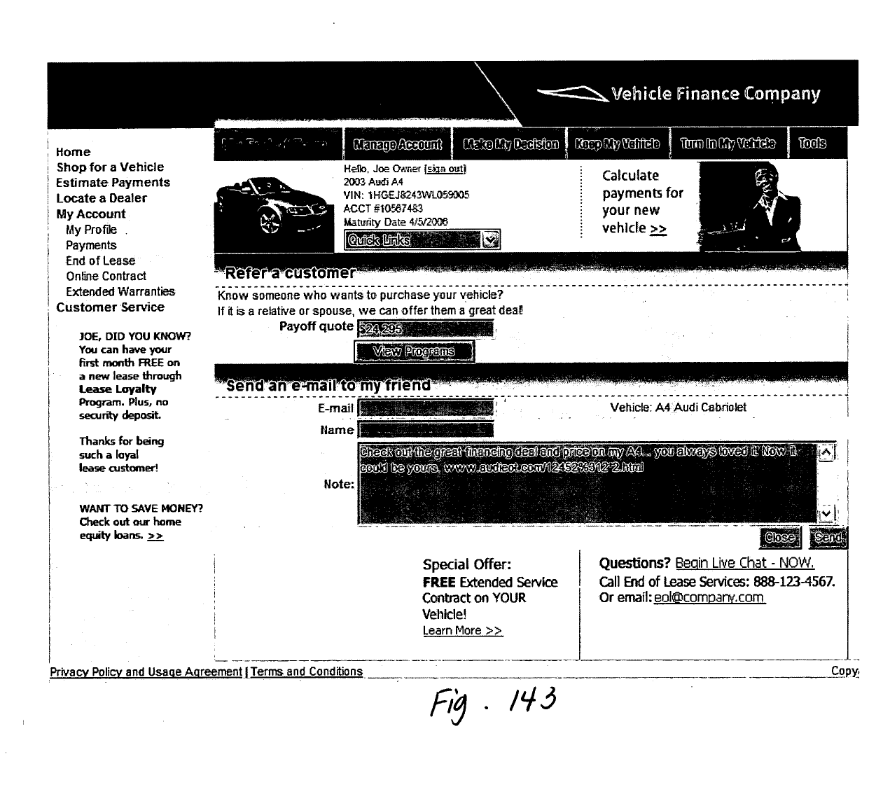

FIG. 146 shows an exemplary illustrative non limiting display screen showing the information required for a customer to self report that their vehicle has been returned to the instructed location.

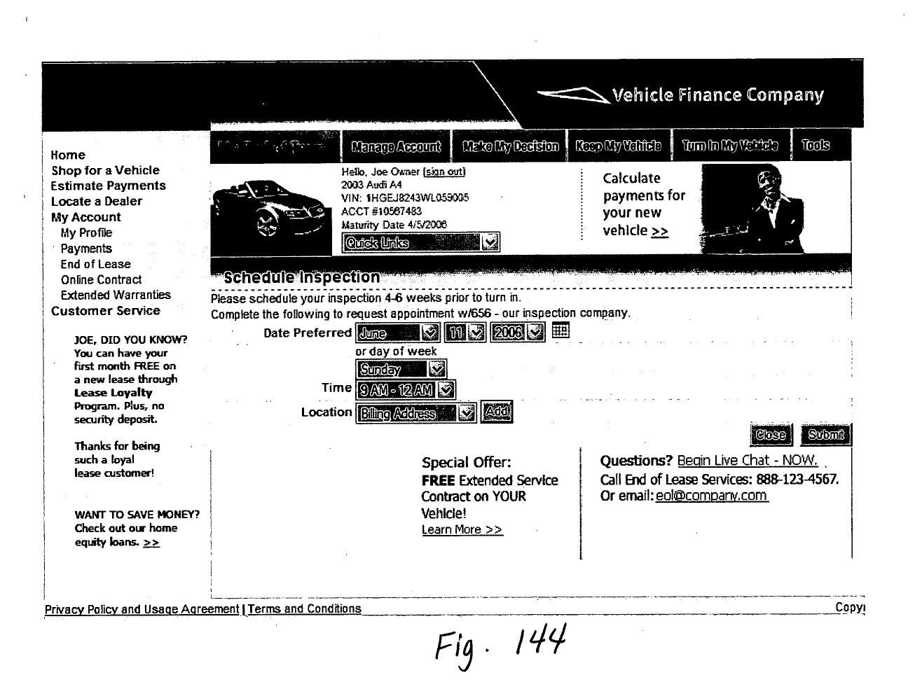

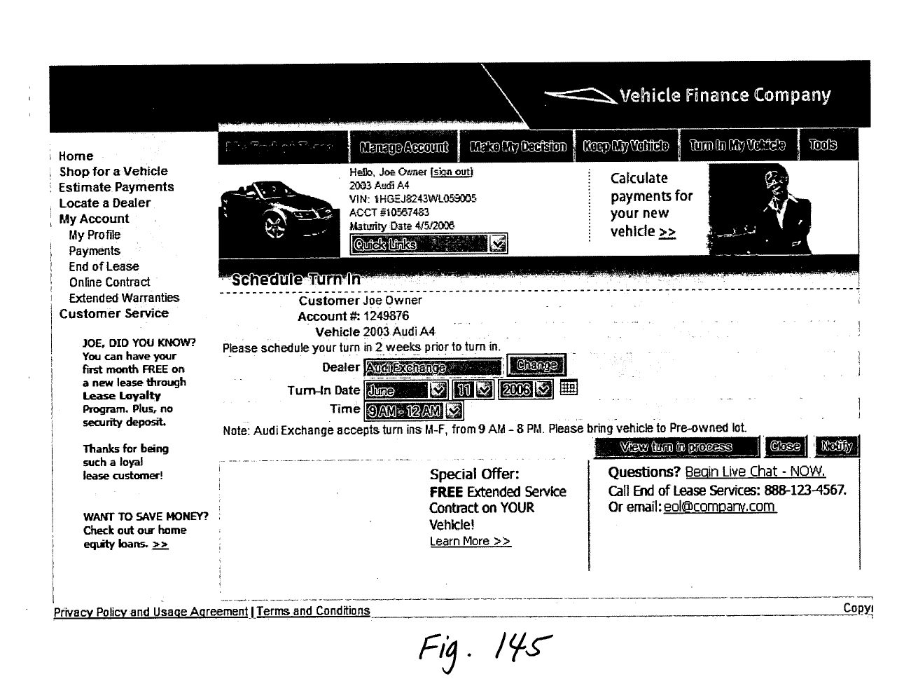

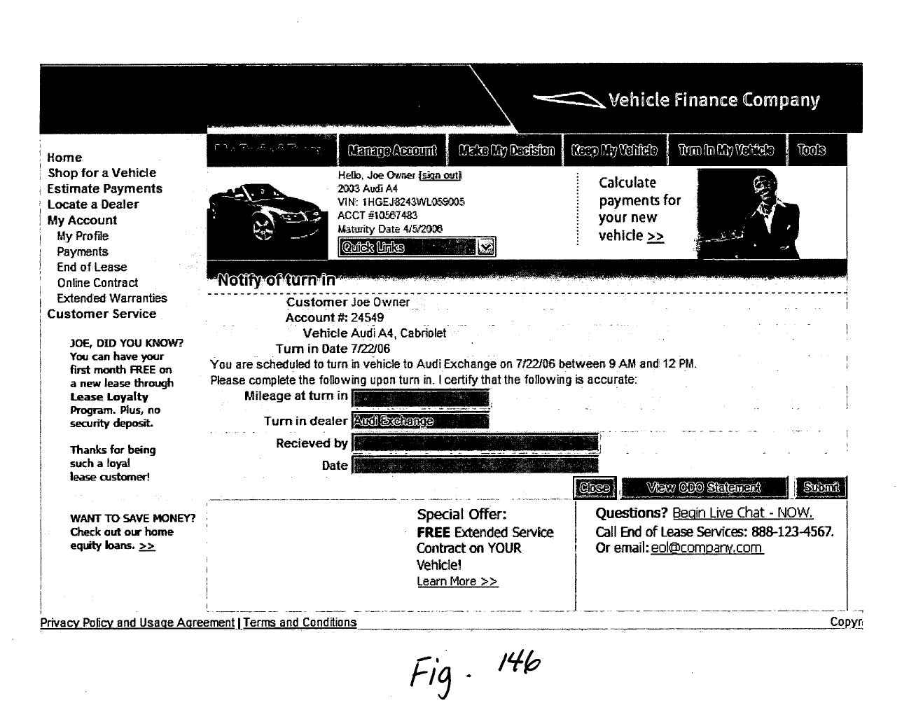

FIG. 147 shows an exemplary illustrative non limiting display screen showing the “Message Center” features to provide interactive communication between the customer and the finance company.

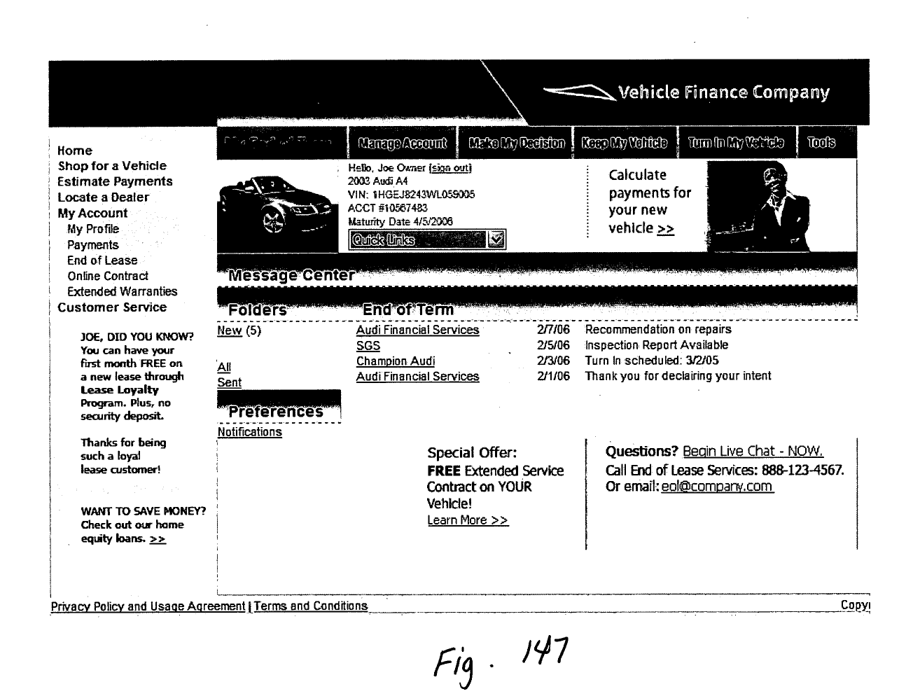

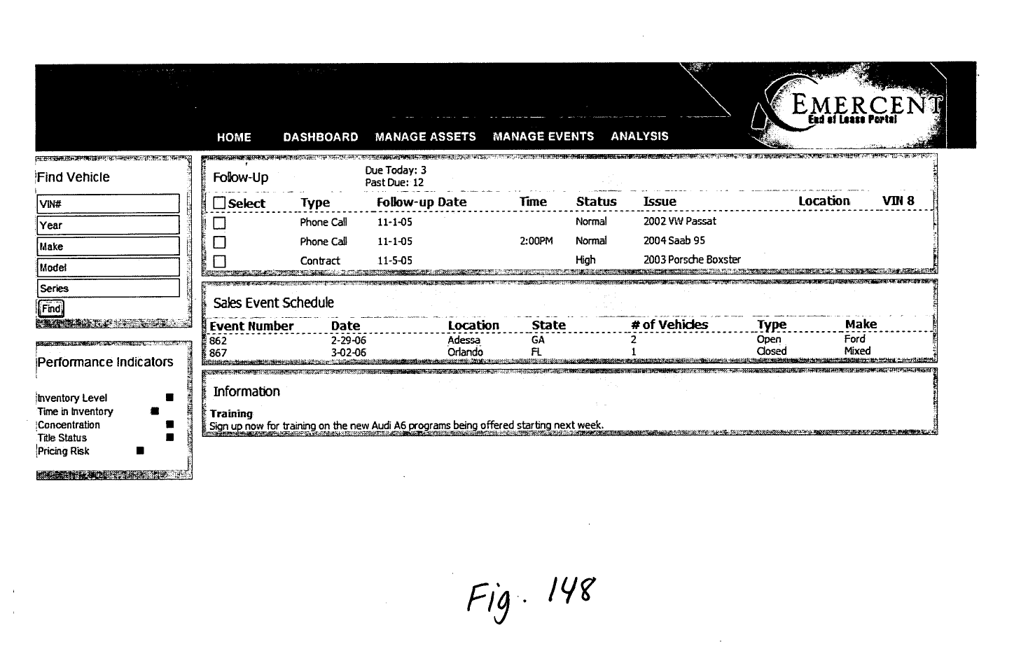

FIG. 148 shows an exemplary illustrative non-limiting asset management screen home page.

The embodiments of the invention, and the invention itself, are now described in such full, clear, concise and exact terms to enable a person of ordinary skill in the art to make and use the invention. To particularly point out and distinctly claim the subject matters regarded as invention, the following claims conclude this specification. To the extent variations from the preferred embodiments fall within the limits of the claims, they are considered to be part of the invention, and claimed.

I/we claim:

1. A transport exchange system for scheduling efficient transport of goods by means other than overnight mail or by plane, comprising:
(a) at least one server to store data, including a predetermined maximum load parameter common to at least two transporters, the server operated by an entity other than a transporter of goods;
(b) an online shipper portal connected to the server at which multiple shippers can enter a shipping request for their respective goods, each good to be shipped from a pick-up location to a delivery location, the online shipper portal electronically connected to the server;
(c) an electronic interface that automatically consolidates multiple shipping requests into a group of multiple shipping requests based on at least the type of the good, pick-up location, delivery location, time for pick-up, and time for delivery in each shipping request, as well as the predetermined maximum load parameter common to at least two transporters stored on the server; and
(d) an online transporter portal at which a transporter can view the group of multiple shipping requests and can accept or provide alternative terms relating to at least one of the multiple shipping requests of the consolidated group of multiple shipping requests in a single electronic transmission.

2. The transport exchange system of claim 1, wherein more than one transporter can view the consolidated group of multiple shipping requests.

3. The transport exchange system of claim 1, wherein the transporter portal allows a transporter to electronically accept at least two shipping requests of the consolidated group of multiple shipping requests in a single electronic transmission.

4. The transport exchange system of claim 3, wherein the transport portal allows a transporter to electronically accept the entire consolidated group of multiple shipping requests in a single electronic transmission when there are more than two shipping requests in the consolidated group.

5. The transport exchange system of claim 1, wherein the transport portal allows a transporter to electronically transmit to at least one shipper alternative terms relating to shipment of a good.

6. The transport exchange system of claim 5, wherein the shipper portal allows a shipper to electronically accept the transporter's alternative terms relating to shipment of the good.

7. The transport exchange system of claim 1, wherein at least one shipper and a transporter can negotiate terms of shipment for a good electronically through their respective portals.

8. The transport exchange system of claim 1, wherein the acceptance by the transporter of the shipping request of the at least one shipper is electronically posted for viewing by the at least one shipper of the accepted shipping request.

9. The transport exchange system of claim 3, wherein the acceptance by the transporter of each shipping request is electronically posted for viewing by the shipper corresponding to each accepted shipping request.

10. The transport exchange system of claim 1, wherein accepted terms between a shipper and a transporter relating to shipment of a good is electronically stored.

11. The transport exchange system of claim 1, wherein the goods to be shipped comprise transportation vehicles.

12. The transport exchange system of claim 1, wherein a shipper can electronically obtain a cost estimate for shipment of their respective good prior to entering a shipping request for viewing by a transporter.

13. The transport exchange system of claim 1, wherein a shipping request for a good to be shipped comprises information selected from the group consisting of the type of the good, pick-up location, delivery location, time for pick-up, time for delivery, amount of money the shipper is willing to pay for shipment of the good, whether the good must shipped in an enclosed container, and whether a transporter must have a predetermined quality rating.

14. The transport exchange system of claim 1, wherein a shipper can check the status of the shipment of a good.

15. The transport exchange system of claim 14, wherein status of the shipment of a good includes global positioning system information relating to the good.

16. The transport exchange system of claim 1, wherein a transporter can check the status of shipment of a good.

17. The transport exchange system of claim 16, wherein status of the shipment of a good includes global positioning system information relating to the good.

18. A method for scheduling efficient transport of goods by means other than overnight mail or by plane comprising the steps of:
(a) inputting to a central server system shipping requests—from multiple shippers for shipment of their respective goods, the central server system operated by an entity other than a transporter of goods;
(b) automatically consolidating multiple shipping requests into a group of multiple shipping requests based on at least the type of the good, pick-up location, delivery location, time for pick-up, and time for delivery in each shipping request, as well as the predetermined maximum load parameter common to at least two transporters stored on the server system;
(c) making available to a transporter the group of multiple shipping requests; and
(d) inputting to the central server system the acceptance or alternative terms of the transporter relating to at least one of the multiple shipping requests of the consolidated group of multiple shipping requests.

19. The method of claim 18, wherein the group of multiple shipping request is made available to more than one transporter.

20. The method claim 18, further comprising the step of accepting by a transporter at least two shipping requests of the consolidated group of shipping requests in a single electronic transmission.

21. The method of claim 20, further comprising the step of accepting by a transporter the entire consolidated group of multiple shipping requests in a single electronic transmission when there are more than two shipping requests in the consolidated group.

22. The method of claim 18, comprising the step of transmitting to at least one shipper alternative terms of a transporter relating to shipment of a good.

23. The method of claim 22, comprising the step of accepting the alternative terms.

24. The method of claim 18, wherein at least one shipper and a transporter negotiate terms of shipment for a good.

25. The method of claim 18, comprising the step of electronically storing accepted terms between a shipper and a transporter relating to shipment of a good.

26. The method of claim 18, wherein the goods to be shipped comprise transportation vehicles.

27. The method of claim 18, comprising the step of obtaining a cost estimate for shipment of a good prior to entering a shipping request for viewing by a transporter.

28. The method of claim 18, wherein a shipping request for a good to be shipped comprises information selected from the group consisting of the type of the good, pick-up location, delivery location, time for pick-up, time for delivery, amount of money the shipper is willing to pay for shipment of the good, whether the good must shipped in an enclosed container, and whether a transporter must have a predetermined quality rating.

29. The method of claim 18, comprising the step of checking the status of the shipment of a good by a shipper.

30. The method of claim 29, wherein the step of checking the status of the shipment of a good includes global positioning system information relating to the good.

31. The method of claim 18, comprising the step of checking the status of the shipment of a good by a transporter.

32. The method of claim 31, wherein the step of checking the status of the shipment of a good includes global positioning system information relating to the good.

33. A method for scheduling efficient transfer of multiple individual units of goods, wherein each of the individual units is collected from a pick-up location for each said unit and delivered to a destination location for each unit, at least some of said pick-up locations being discrete, said method comprising, in combination, the steps of:
inputting information into a central server system for the pick up location of each unit;
inputting information into said central server system for the destination location of each said unit;
inputting information into said central server system of the location of at least a first and a second transporter capable of carrying multiple units between the unit pick-up and destination locations;
programming said central server to analyze the input information to schedule the maximum number of units that may be carried by each transporter in the shortest period of time between the pick-up and destination locations of each of said units to effect transport of more than one unit by each transporter between the pick-up and destination locations thereof during a finite period of time.

34. The method of claim 33, further including the step of publishing a pick-up time and location schedule for each unit.

35. The method of claim 33, wherein custody of each unit is maintained by a transporter from the pick-up location to the destination location and wherein custody of the unit and liability for damage to the unit is that of the transporter only during custody of the unit.

36. The method of claim 33, wherein each transporter uses at least a single transporter element to transport goods.

37. The method of claim 36, wherein each transporter element is a ground transport device.

38. The transport exchange system of claim 1, wherein the server stores historical data relating to the cost of transport of goods, the historical data accessible by an entity managing a portfolio of leased goods.

39. The method of claim 18, comprising the steps of collecting historical data relating to the cost of transport of goods, and allowing for the historical data to be accessible to an entity managing a portfolio of leased goods.

40. The method of claim 33, comprising the steps of collecting historical data relating to the cost of transport of goods, and allowing for the historical data to be accessible to an entity managing a portfolio of leased goods.
